(19) United States
(12) Patent Application Publication
(10) Pub. No.: US 2025/0330869 A1
(43) Pub. Date: Oct. 23, 2025

(54) Data Transmission Method and Device

(71) Applicant: VIVO MOBILE COMMUNICATION CO., LTD., Dongguan (CN)

(72) Inventors: Xuanbing Liu, Dongguan (CN); Xiaodong Yang, Dongguan (CN)

(21) Appl. No.: 19/254,484

(22) Filed: Jun. 30, 2025

Related U.S. Application Data
(63) Continuation of application No. PCT/CN2023/142108, filed on Dec. 26, 2023.

(30) Foreign Application Priority Data
Dec. 29, 2022 (CN) 202211718455.8

(51) Int. Cl. H04W 28/02; H04W 76/20; H04W 92/10

(52) U.S. Cl. CPC H04W 28/0273; H04W 28/0268; H04W 76/20; H04W 92/10

(57) ABSTRACT

A data transmission method includes performing, by UE, at least one of the following in an AIoT protocol stack architecture; receiving, by the UE over a 3GPP air interface or a first AIoT link, AIoT data sent by a network side device, sending, by the UE, the AIoT data to the network side device over the 3GPP air interface or the first AIoT link, sending, by the UE, the AIoT data to an AIoT device over a second AIoT link, and receiving, by the UE over the second AIoT link, the AIoT data sent by the AIoT device. The network side device includes a base station and a core network device, and the AIoT data includes AIoT signaling and service-related data.

### CROSS-REFERENCE TO RELATED APPLICATIONS

This application is a Bypass Continuation application of International Patent Application No. PCT/CN2023/142108 filed Dec. 26, 2023, and claims priority to Chinese Patent Application No. 202211718455.8 filed Dec. 29, 2022, the disclosures of which are hereby incorporated by reference in their entireties.

### BACKGROUND OF THE INVENTION

### Field of the Invention

This application pertains to the field of communication technologies, and in particular, relates to a data transmission method and a device.

### Description of Related Art

Radio frequency identification (RFID) is a technology in which a backscatter communication technology is used, and supports data transmission between an electronic tag (such as a Tag) and a reader. However, an RFID solution currently has a limited coverage area, making it difficult to support large-scale cellular network deployment, a large quantity of AIoT devices, and seamless coverage.

### SUMMARY OF THE INVENTION

According to a first aspect, a data transmission method is provided. The method includes: performing, by user equipment UE, at least one of the following in an ambient Internet of Things AIoT protocol stack architecture: receiving, by the UE over a 3GPP air interface or a first AIoT link, AIoT data sent by a network side device; sending, by the UE, the AIoT data to the network side device over the 3GPP air interface or the first AIoT link; sending, by the UE, the AIoT data to an AIoT device over a second AIoT link; or receiving, by the UE over the second AIoT link, the AIoT data sent by the AIoT device. The network side device includes a base station and a core network device, and the AIoT data includes AIoT signaling and service-related data.

According to a second aspect, a data transmission apparatus is provided, and the apparatus includes a transceiver module. The transceiver module is configured to perform at least one of the following in an ambient Internet of Things AIoT protocol stack architecture: receiving, over a 3GPP air interface or a first AIoT link, AIoT data sent by a network side device; sending the AIoT data to the network side device over the 3GPP air interface or the first AIoT link; sending the AIoT data to an AIoT device over a second AIoT link; or receiving, over the second AIoT link, the AIoT data sent by the AIoT device. The network side device includes a base station and a core network device, and the AIoT data includes AIoT signaling and service-related data.

According to a third aspect, a data transmission method is provided. The method includes: performing, by a network side device, at least one of the following in an ambient Internet of Things AIoT protocol stack architecture: receiving, by the network side device over a 3GPP air interface or a first AIoT link, AIoT data sent by UE; sending, by the network side device, the AIoT data to the UE over the 3GPP air interface or the first AIoT link; sending, by the network side device, the AIoT data to an AIoT device over a third AIoT link; or receiving, by the network side device over the third AIoT link, the AIoT data sent by the AIoT device.

The network side device includes a base station and a core network device, and the AIoT data includes AIoT signaling and service-related data.

According to a fourth aspect, a data transmission apparatus is provided. The apparatus includes a transceiver module, configured to perform at least one of the following in an ambient Internet of Things AIoT protocol stack architecture: receiving, over a 3GPP air interface or a first AIoT link, AIoT data sent by UE; sending the AIoT data to the UE over the 3GPP air interface or the first AIoT link; sending the AIoT data to an AIoT device over a third AIoT link; or receiving, over the third AIoT link, the AIoT data sent by the AIoT device. The network side device includes a base station and a core network device, and the AIoT data includes AIoT signaling and service-related data.

According to a fifth aspect, a data transmission method is provided. The method includes: performing, by an AIoT device, at least one of the following in an ambient Internet of Things AIoT protocol stack architecture: receiving, by the AIoT device over a second AIoT link, AIoT data sent by user equipment UE; sending, by the AIoT device, the AIoT data to the user equipment UE over the second AIoT link; sending, by the AIoT device, the AIoT data to a network side device over a third AIoT link; or receiving, by the AIoT device over the third AIoT link, the AIoT data sent by the network side device. The network side device includes a base station and a core network device, and the AIoT data includes AIoT signaling and service-related data.

According to a sixth aspect, a data transmission apparatus is provided, and the apparatus includes a transceiver module. The transceiver module is configured to perform at least one of the following in an ambient Internet of Things AIoT protocol stack architecture: receiving, over a second AIoT link, AIoT data sent by user equipment UE; sending the AIoT data to the user equipment UE over the second AIoT link; sending the AIoT data to a network side device over a third AIoT link; or receiving, over the third AIoT link, the AIoT data sent by the network side device. The network side device includes a base station and a core network device, and the AIoT data includes AIoT signaling and service-related data.

According to a seventh aspect, a terminal is provided. The terminal includes a processor and a memory. The memory stores a program or instructions exactable on the processor, and when the program or the instructions are executed by the processor, the steps of the method according to the first aspect are implemented.

According to an eighth aspect, a terminal is provided, including a processor and a communication interface. The communication interface is configured to perform at least one of the following in an ambient Internet of Things AIoT protocol stack architecture: receiving, over a 3GPP air interface or a first AIoT link, AIoT data sent by a network side device; sending the AIoT data to the network side device over the 3GPP air interface or the first AIoT link; sending the AIoT data to an AIoT device over a second AIoT link; or receiving, over the second AIoT link, the AIoT data sent by the AIoT device. The network side device includes a base station and a core network device, and the AIoT data includes AIoT signaling and service-related data.

According to a ninth aspect, a network side device is provided. The network side device includes a processor and a memory. The memory stores a program or instructions exectable on the processor, and when the program or the instructions are executed by the processor, the steps of the method according to the third aspect are implemented.

According to a tenth aspect, a network side device is provided, including a processor and a communication interface. The communication interface is configured to perform at least one of the following in an ambient Internet of Things AIoT protocol stack architecture: receiving, over a 3GPP air interface or a first AIoT link, AIoT data sent by UE; sending the AIoT data to the UE over the 3GPP air interface or the first AIoT link; sending the AIoT data to an AIoT device over a third AIoT link; or receiving, over the third AIoT link, the AIoT data sent by the AIoT device. The network side device includes a base station and a core network device, and the AIoT data includes AIoT signaling and service-related data.

According to an eleventh aspect, an AIoT device is provided. The AIoT device includes a processor and a memory. The memory stores a program or instructions exectable on the processor, and when the program or the instructions are executed by the processor, the steps of the method according to the fifth aspect are implemented.

According to a twelfth aspect, an AIoT device is provided, including a processor and a communication interface. The communication interface is configured to perform at least one of the following in an ambient Internet of Things AIoT protocol stack architecture: receiving, over a second AIoT link, AIoT data sent by user equipment UE; sending the AIoT data to the user equipment UE over the second AIoT link; sending the AIoT data to a network side device over a third AIoT link; or receiving, over the third AIoT link, the AIoT data sent by the network side device. The network side device includes a base station and a core network device, and the AIoT data includes AIoT signaling and service-related data.

According to a thirteenth aspect, a communication system is provided, including: a terminal, a network side device, and an AIoT device. The terminal may be configured to perform the steps of the data transmission method according to the first aspect, the network side device may be configured to perform the steps of the data transmission method according to the third aspect, and the AIoT device may be configured to perform the steps of the data transmission method according to the fifth aspect.

According to a fourteenth aspect, a non-transitory readable storage medium is provided. The non-transitory readable storage medium stores a program or instructions, and when the program or the instructions are executed by a processor, the steps of the method according to the first aspect, the steps of the method according to the third aspect, or the steps of the method according to the fifth aspect are implemented.

According to a fifteenth aspect, a chip is provided. The chip includes a processor and a communication interface, and the communication interface is coupled to the processor. The processor is configured to run a program or instructions to implement the method according to the first aspect, the method according to the third aspect, or the method according to the fifth aspect.

According to a sixteenth aspect, a computer program/program product is provided. The computer program/program product is stored in a non-transitory storage medium. When the computer program/program product is executed by at least one processor, the steps of the data transmission method according to the first aspect, the steps of the method according to the third aspect, or the steps of the method according to the fifth aspect are implemented.

### BRIEF DESCRIPTION OF THE DRAWINGS

FIG. 1 is a block diagram of a wireless communication system according to an embodiment of this application;

FIG. 2 is a first schematic diagram of a data transmission method according to an embodiment of this application;

FIG. 3 is a second schematic diagram of a data transmission method according to an embodiment of this application;

FIG. 4 is a third schematic diagram of a data transmission method according to an embodiment of this application;

FIG. 5 is a schematic interaction diagram of a data transmission method according to an embodiment of this application;

FIG. 6A is a first schematic diagram of a protocol stack architecture according to an embodiment of this application;

FIG. 6B is a second schematic diagram of a protocol stack architecture according to an embodiment of this application;

FIG. 6C is a third schematic diagram of a protocol stack architecture according to an embodiment of this application;

FIG. 6D is a fourth schematic diagram of a protocol stack architecture according to an embodiment of this application;

FIG. 6E is a fifth schematic diagram of a protocol stack architecture according to an embodiment of this application;

FIG. 6F is a sixth schematic diagram of a protocol stack architecture according to an embodiment of this application;

FIG. 6G is a seventh schematic diagram of a protocol stack architecture according to an embodiment of this application;

FIG. 6H is a eighth schematic diagram of a protocol stack architecture according to an embodiment of this application;

FIG. 6I is a ninth schematic diagram of a protocol stack architecture according to an embodiment of this application;

FIG. 7A is a tenth schematic diagram of a protocol stack architecture according to an embodiment of this application;

FIG. 7B is a eleventh schematic diagram of a protocol stack architecture according to an embodiment of this application;

FIG. 7C is a twelfth schematic diagram of a protocol stack architecture according to an embodiment of this application;

FIG. 7D is a thirteenth schematic diagram of a protocol stack architecture according to an embodiment of this application;

FIG. 7E is a fourteenth schematic diagram of a protocol stack architecture according to an embodiment of this application;

FIG. 7F is a fifteenth schematic diagram of a protocol stack architecture according to an embodiment of this application;

FIG. 7G is a sixteenth schematic diagram of a protocol stack architecture according to an embodiment of this application;

FIG. 7H is a seventeenth schematic diagram of a protocol stack architecture according to an embodiment of this application;

FIG. 7I is a eighteenth schematic diagram of a protocol stack architecture according to an embodiment of this application;

FIG. 8A is a nineteenth schematic diagram of a protocol stack architecture according to an embodiment of this application;

FIG. 8B is a twentieth schematic diagram of a protocol stack architecture according to an embodiment of this application;

FIG. 8C is a twenty-first schematic diagram of a protocol stack architecture according to an embodiment of this application;

FIG. 8D is a twenty-second schematic diagram of a protocol stack architecture according to an embodiment of this application;

FIG. 8E is a twenty-third schematic diagram of a protocol stack architecture according to an embodiment of this application;

FIG. 8F is a twenty-fourth schematic diagram of a protocol stack architecture according to an embodiment of this application;

FIG. 8G is a twenty-fifth schematic diagram of a protocol stack architecture according to an embodiment of this application;

FIG. 8H is a twenty-sixth schematic diagram of a protocol stack architecture according to an embodiment of this application;

FIG. 8I is a twenty-seventh schematic diagram of a protocol stack architecture according to an embodiment of this application;

FIG. 9A is a twenty-eighth schematic diagram of a protocol stack architecture according to an embodiment of this application;

FIG. 9B is a twenty-ninth schematic diagram of a protocol stack architecture according to an embodiment of this application;

FIG. 9C is a thirtieth schematic diagram of a protocol stack architecture according to an embodiment of this application;

FIG. 9D is a thirty-first schematic diagram of a protocol stack architecture according to an embodiment of this application;

FIG. 9E is a thirty-second schematic diagram of a protocol stack architecture according to an embodiment of this application;

FIG. 9F is a thirty-third schematic diagram of a protocol stack architecture according to an embodiment of this application;

FIG. 10A is a thirty-fourth schematic diagram of a protocol stack architecture according to an embodiment of this application;

FIG. 10B is a thirty-fifth schematic diagram of a protocol stack architecture according to an embodiment of this application;

FIG. 10C is a thirty-sixth schematic diagram of a protocol stack architecture according to an embodiment of this application;

FIG. 10D is a thirty-seventh schematic diagram of a protocol stack architecture according to an embodiment of this application;

FIG. 10E is a thirty-eighth schematic diagram of a protocol stack architecture according to an embodiment of this application;

FIG. 10F is a thirty-ninth schematic diagram of a protocol stack architecture according to an embodiment of this application;

FIG. 10G is a fortieth schematic diagram of a protocol stack architecture according to an embodiment of this application;

FIG. 10H is a forty-first schematic diagram of a protocol stack architecture according to an embodiment of this application;

FIG. 10I is a forty-second schematic diagram of a protocol stack architecture according to an embodiment of this application;

FIG. 11A is a forty-third schematic diagram of a protocol stack architecture according to an embodiment of this application;

FIG. 11B is a forty-fourth schematic diagram of a protocol stack architecture according to an embodiment of this application;

FIG. 11C is a forty-fifth schematic diagram of a protocol stack architecture according to an embodiment of this application;

FIG. 11D is a forty-sixth schematic diagram of a protocol stack architecture according to an embodiment of this application;

FIG. 11E is a forty-seventh schematic diagram of a protocol stack architecture according to an embodiment of this application;

FIG. 11F is a forty-eighth schematic diagram of a protocol stack architecture according to an embodiment of this application;

FIG. 12A is a forty-ninth schematic diagram of a protocol stack architecture according to an embodiment of this application;

FIG. 12B is a fiftieth schematic diagram of a protocol stack architecture according to an embodiment of this application;

FIG. 13 is a first schematic diagram of a structure of a data transmission apparatus according to an embodiment of this application;

FIG. 14 is a second schematic diagram of a structure of a data transmission apparatus according to an embodiment of this application;

FIG. 15 is a third schematic diagram of a structure of a data transmission apparatus according to an embodiment of this application;

FIG. 16 is a schematic diagram of a structure of a communication device according to an embodiment of this application;

FIG. 17 is a schematic diagram of a hardware structure of a terminal according to an embodiment of this application; and

FIG. 18 is a schematic diagram of a hardware structure of a network side device according to an embodiment of this application.

### DESCRIPTION OF THE INVENTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, in the specification and claims, “and/or” represents at least one of connected objects, and the character “/” generally represents an “or” relationship between associated objects.

It should be noted that, a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. The technology described may be used for the systems and radio technologies described above, as well as other systems and radio technologies. A new radio (NR) system is described in the following descriptions for illustrative purposes, and NR terms are used in most of the following descriptions. However, these technologies can also be applied to applications such as a 6th generation (6G) communication system other than NR system applications.

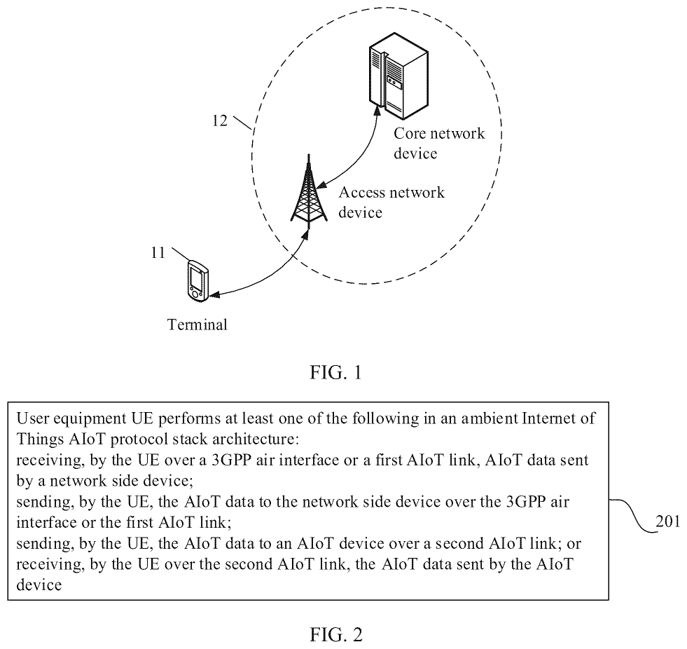

FIG. 1 is a block diagram of a wireless communication system applicable to an embodiment of this application. The wireless communication system includes a terminal 11 and a network side device 12. The terminal 11 may be a mobile phone, a tablet personal computer, a laptop computer that is alternatively referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a type of the terminal 11 is not limited in embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that a same technical effect is achieved, the base station is not limited to a technical vocabulary. It should be noted that in embodiments of this application, only a base station in an NR system is used as an example for description, and a type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that in the embodiments of this application, only a core network device in the NR system is used as an example for description, and a type of the core network device is not limited.

The following provides noun explanations of professional terms in the embodiments of this application:

### 1. Ambient Internet of Things (Ambient IoT, AIoT)

The ambient IoT is a new 3GPP IoT technology to be studied. An Ambient IoT device has ultra-low complexity and ultra-low power consumption.

The ambient IoT, also referred to as an ambient power-enabled Internet of Things Ambient power-enabled Internet of Things (IoT), is an IoT service. An IoT device obtains energy through energy harvesting, and the IoT device has no battery, or has a limited energy storage capability (for example, using a capacitor). Energy sources for energy harvesting include a radio wave, light, motion, heat, or another appropriate energy source.

Energy of the Ambient IoT device comes from energy harvesting. In terms of energy storage, the device may have the following features:
the device has no battery and no energy storage, and is totally dependent on an external energy source; or
the device has a limited energy storage capability and requires no battery replacement or charging.

Typically, the Ambient IoT device does not have a conventional battery. The device itself uses energy harvested from a radio wave, where the radio wave may come from a network device or user equipment, such as mobile phone UE.

The Ambient IoT device may be classified based on an energy source, an energy storage capability, passive or active transmission, or the like. It should be noted that the Ambient IoT may include a Passive IoT.

Referring to TR22.840, passive or active transmission of the Ambient IoT has the following plurality of communication modes:
normal operation, where the Ambient IoT device has power to work continuously or work for a sustained period of time, and energy may come from continuous energy harvesting; or the Ambient IoT device may have a specific energy storage capability, for example, equipped with a capacitor;
active transmission, which supports a device-triggered operation, where the device can support only a short-term active state, and support intermittent communication, the device may decide when to communicate with a network, and the device does not necessarily monitor the network, that is, may not monitor a called service for a long time; and
passive transmission, which supports only a network-initiated on-demand operation, where the device cannot initiate a service by itself.

In an overall architecture of the Ambient IoT, UE or a RAN may serve as a Reader to transmit Ambient IoT data to an Ambient IoT App. Participation of a 5GC is optional.

### 2. Backscatter Communication (BSC)

Backscatter communication means that a backscatter communication device performs signal modulation by using a radio frequency signal in another device or environment to transmit information of the backscatter communication device. A backscatter communication terminal device (a BSC Tag, which may alternatively be referred to as BSC UE) may be a Tag in conventional RFID, an ambient IoT, or a passive IoT device.

A Backscatter technology is a passive or low-power-consumption technology. A technical feature of the backscatter technology is that transmission of a signal of the backscatter communication terminal device can be completed by changing a characteristic such as phase or amplitude information of a received ambient radio frequency signal, to implement information transmission with extremely low power consumption or zero power consumption.

Energy supply manners of the backscatter communication terminal device (BSC Tag) may be divided into three manners: a passive manner, a semi-passive manner, and an active manner.
For passive backscatter communication, the BSC TAG first obtains energy (Energy harvesting) from an external electromagnetic wave and supplies the energy to internal circuit modules such as a channel coding and modulation module to work, and then backscatters a radio frequency signal to perform communication to implement zero-power-consumption communication.
For a half-passive BSC TAG, an internal circuit module is powered by a battery of the BSC TAG, and the BSC TAG backscatters a radio frequency signal to perform communication. The internal battery is only used for simple internal circuit modules such as a channel coding and modulation module to work, and power consumption is very low. Therefore, a battery life of the BSC TAG can reach more than ten years. All external radio frequency signals can be used for back communication without storing some energy for power supply.
For an active BSC TAG, a built-in battery is not only used for simple internal circuits such as a channel coding and modulation module to work, but also for circuits such as a power amplifier (PA) and a low noise amplifier (LNA) to work. Therefore, signal modulation and demodulation in more complex backscatter communication can be implemented.

### 3. Monostatic Backscatter Communication System (MBCSs)

A conventional RFID system is a typical MBCS. The system includes a BSC transmit end (such as a Tag) and a reader. The reader includes an RF radio frequency source and a BSC receive end. The RF radio frequency source is used to generate an RF radio frequency signal to supply power to the BSC transmit end/Tag. The BSC transmit end backscatters a modulated RF radio frequency signal. The BSC receive end in the Reader receives the backscattered signal and then performs signal demodulation. The RF radio frequency source and the BSC receive end are in a same device, such as the Reader herein, and therefore this is referred to as the monostatic backscatter communication system. In the MBCSs system, the RF radio frequency signal sent from the BSC transmit end undergoes double near-far effects caused by signal attenuation of a round-trip signal, and therefore energy attenuation of the signal is large. Therefore, the MBCS system is usually used for short-distance backscatter communication, such as a conventional RFID application.

Backscatter communication architectures can be further divided into the following:
a monostatic backscatter communication system (MBCSs);
a bistatic backscatter communication system (BBCSs); and
an ambient backscatter communication system (ABCSs).

### 4. Bistatic Backscatter Communication System (BBCSs)

Unlike the MBCS system, an RF radio frequency source, a BSC transmitting device, and a BSC receiving device in the BBCS system are separated. Therefore, the BBCS avoids a problem of large attenuation of a round-trip signal. In addition, performance of the BBCS communication system can be improved by reasonably placing the RF radio frequency source. It should be noted that the ambient backscatter communication ABCSs is also a type of bistatic backscatter communication. However, the radio frequency source in the BBCS system is a dedicated signal radio frequency source, and a radio frequency source in the ABCS system may be an available ambient radio frequency source, such as a television tower, a cellular base station, a WiFi signal, or a Bluetooth signal. A backscatter communication cellular networking architecture is as follows:

In a possible implementation, an Ambient IoT may use a backscatter communication cellular networking architecture.

A backscatter communication device may be any one of the following:
a passive IoT device (Passive-IoT), such as tag in conventional RFID;
a semi-passive tag, where such a tag has a specific amplification capability in downlink reception or uplink reflection; and
a tag (active tag) with an active sending capability, where such a terminal may send information to a reader without relying on reflection of an incident signal.

### 5. Radio Frequency Identification (RFID)

RFID is a conventional backscatter communication system. A main design objective of RFID is to perform ID identification and data reading on a BSC device (that is, a Tag) in a coverage area range of a reader. Because RFID is originally applied to automated inventory of a large quantity of goods, a process of identifying the Tag and reading data from the Tag is also referred to as inventory.

With reference to the accompanying drawings, the following describes in detail the data transmission method provided in embodiments of this application by using some embodiments and application scenarios thereof.

A 3GPP Ambient IoT is intended to provide large-scale cellular network deployment and seamless coverage. SA1 has defined some deployment scenarios and use cases (TR22.840). A RAN studies design of an access network to meet expected performance indicators such as power consumption, complexity, coverage, a data rate, and positioning accuracy.

UE-assisted 3GPP Ambient IoT network deployment can help resolve an energy supply problem of network coverage or energy harvesting of an IoT device. How UE assists a base station and a core network to support control and data transmission in an Ambient IoT is a problem to be resolved.

Currently, in an ambient Internet of Things (Ambient IoT, AIoT) architecture, identifying an Ambient IoT device and reading data from the Ambient IoT device by using the backscatter communication technology is a potential technical direction. A 3GPP Ambient IT is intended to provide large-scale cellular network deployment and seamless coverage, and therefore, designing a corresponding transmission manner to support control and data transmission in a 3GPP Ambient IoT system architecture becomes an urgent problem to be resolved.

The data transmission method provided in the embodiments of this application provides a plurality of UE-assisted Ambient IoT protocol stack architectures and function division, which are used for a plane control protocol stack and/or a user plane protocol stack, to implement a necessary Ambient IoT data transmission function, and support backscatter communication. A simplified protocol stack can greatly reduce protocol stack complexity and reduce IoT costs.

With reference to the accompanying drawings, the following describes in detail the data transmission method provided in the embodiments of this application by using embodiments and application scenarios.

An embodiment of this application provides an AIoT protocol stack architecture. The AIoT protocol stack architecture may include a control plane protocol stack; or the AIoT protocol stack architecture may include the control plane protocol stack and a user plane protocol stack.

In this embodiment of this application, the AIoT protocol stack architecture includes a network side device (including a base station and a core network device), UE, and an AIoT device.

In this embodiment of this application, the UE may include a PHY protocol layer and a MAC protocol layer; the PHY protocol layer, the MAC protocol layer, and a NAS protocol layer; an AIoT PHY protocol layer and an AIoT MAC protocol layer; the AIoT PHY protocol layer, the AIoT MAC protocol layer, and an AIoT NAS protocol layer; or the PHY protocol layer, the MAC protocol layer, the NAS protocol layer, the AIoT PHY protocol layer, the AIoT MAC protocol layer, and the AIoT NAS protocol layer.

In this embodiment of this application, the base station may include a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer.

In this embodiment of this application, the core network device may include a NAS protocol layer; an AIoT NAS protocol layer; or the NAS protocol layer and the AIoT NAS protocol layer.

In this embodiment of this application, the AIoT device may include a PHY protocol layer and a MAC protocol layer; an AIoT PHY protocol layer and an AIoT MAC protocol layer; or the AIoT PHY protocol layer, the AIoT MAC protocol layer, and an AIoT NAS protocol layer.

Optionally, in this embodiment of this application, the base station may further include at least one of an RLC protocol layer, a PDCP protocol layer, an RRC protocol layer, or an SDAP protocol layer; or at least one of an AIoT RLC protocol layer, an AIoT PDCP protocol layer, an AIoT RRC protocol layer, or an AIoT SDAP protocol layer.

Optionally, in this embodiment of this application, the UE may further include at least one of an RLC protocol layer, a PDCP protocol layer, an RRC protocol layer, and an SDAP protocol layer; or at least one of an AIoT RLC protocol layer, an AIoT PDCP protocol layer, an AIoT RRC protocol layer, or an AIoT SDAP protocol layer.

Optionally, in this embodiment of this application, the AIoT device may further include at least one of an AIoT RLC protocol layer, an AIoT PDCP protocol layer, an AIoT RRC protocol layer, or an AIoT SDAP protocol layer.

In a first possible embodiment, the base station may include the PHY protocol layer and the MAC protocol layer; the core network device may include the NAS protocol layer; the UE may include the PHY protocol layer, the MAC protocol layer, the NAS protocol layer, the AIoT PHY protocol layer, the AIoT MAC protocol layer, and the AIoT NAS protocol layer; and the AIoT device may include the AIoT PHY protocol layer, the AIoT MAC protocol layer, and the AIoT NAS protocol layer.

In a second possible embodiment, the base station may include the PHY protocol layer, the MAC protocol layer, the RLC protocol layer, the PDCP protocol layer, and the RRC protocol layer; the UE may include the PHY protocol layer, the MAC protocol layer, the RLC protocol layer, the PDCP protocol layer, the RRC protocol layer, the NAS protocol layer, the AIoT PHY protocol layer, the AIoT MAC protocol layer, and the AIoT NAS protocol layer; and the AIoT device may include the AIoT PHY protocol layer, the AIoT MAC protocol layer, and the AIoT NAS protocol layer.

In a third possible embodiment, the base station may include the PHY protocol layer, the MAC protocol layer, the RLC protocol layer, the PDCP protocol layer, and the RRC protocol layer; the UE may include the PHY protocol layer, the MAC protocol layer, the RLC protocol layer, the PDCP protocol layer, the RRC protocol layer, the NAS protocol layer, the AIoT PHY protocol layer, the AIoT MAC protocol layer, the AIoT RLC protocol layer, the AIoT PDCP protocol layer, the AIoT RRC protocol layer, and the AIoT NAS protocol layer; and the AIoT device may include the AIoT PHY protocol layer, the AIoT MAC protocol layer, the AIoT RLC protocol layer, the AIoT PDCP protocol layer, the AIoT RRC protocol layer, and the AIoT NAS protocol layer.

In a fourth possible embodiment, the base station may include the AIoT PHY protocol layer and the AIoT MAC protocol layer; the core network device may include the AIoT NAS protocol layer; the UE may include the AIoT PHY protocol layer, the AIoT MAC protocol layer, and the AIoT NAS protocol layer; and the AIoT device may include the AIoT PHY protocol layer, the AIoT MAC protocol layer, and the AIoT NAS protocol layer.

In a fifth possible embodiment, the base station may include the AIoT PHY protocol layer, the AIoT MAC protocol layer, the AIoT RLC protocol layer, the AIoT PDCP protocol layer, and the AIoT RRC protocol layer; the UE may include the AIoT PHY protocol layer, the AIoT MAC protocol layer, the AIoT RLC protocol layer, the AIoT PDCP protocol layer, the AIoT RRC protocol layer, and the AIoT NAS protocol layer; and the AIoT device may include the AIoT PHY protocol layer, the AIoT MAC protocol layer, and the AIoT NAS protocol layer.

In a sixth possible embodiment, the base station may include the AIoT PHY protocol layer, the AIoT MAC protocol layer, the AIoT RLC protocol layer, the AIoT PDCP protocol layer, and the AIoT RRC protocol layer; the UE may include the AIoT PHY protocol layer, the AIoT MAC protocol layer, the AIoT RLC protocol layer, the AIoT PDCP protocol layer, the AIoT RRC protocol layer, and the AIoT NAS protocol layer; and the AIoT device may include the AIoT PHY protocol layer, the AIoT MAC protocol layer, the AIoT RLC protocol layer, the AIoT PDCP protocol layer, the AIoT RRC protocol layer, and the AIoT NAS protocol layer.

In a seventh possible embodiment, the base station may include the PHY protocol layer, the MAC protocol layer, the AIoT PHY protocol layer, and the AIoT MAC protocol layer; the core network device may include the NAS protocol layer; the UE may include the PHY protocol layer, the MAC protocol layer, the NAS protocol layer, the AIoT PHY protocol layer, the AIoT MAC protocol layer, and the AIoT NAS protocol layer; and the AIoT device may include the AIoT PHY protocol layer, the AIoT MAC protocol layer, and the AIoT NAS protocol layer.

In an eighth possible embodiment, the base station may include the PHY protocol layer, the MAC protocol layer, the RLC protocol layer, the PDCP protocol layer, the RRC protocol layer, the AIoT PHY protocol layer, and the AIoT MAC protocol layer; the core network device may include the NAS protocol layer; the UE may include the PHY protocol layer, the MAC protocol layer, the RLC protocol layer, the PDCP protocol layer, the RRC protocol layer, the NAS protocol layer, the AIoT PHY protocol layer, the AIoT MAC protocol layer, and the AIoT NAS protocol layer; and the AIoT device may include the AIoT PHY protocol layer, the AIoT MAC protocol layer, and the AIoT NAS protocol layer.

In a ninth possible embodiment, the base station may include the PHY protocol layer, the MAC protocol layer, the RLC protocol layer, the PDCP protocol layer, the RRC protocol layer, the AIoT PHY protocol layer, the AIoT MAC protocol layer, the AIoT RLC protocol layer, the AIoT PDCP protocol layer, and the AIoT RRC protocol layer; the core network device may include the NAS protocol layer; the UE may include the PHY protocol layer, the MAC protocol layer, the RLC protocol layer, the PDCP protocol layer, the RRC protocol layer, the NAS protocol layer, the AIoT PHY protocol layer, the AIoT MAC protocol layer, the AIoT RLC protocol layer, the AIoT PDCP protocol layer, the AIoT RRC protocol layer, and the AIoT NAS protocol layer; and the AIoT device may include the AIoT PHY protocol layer, the AIoT MAC protocol layer, the AIoT RLC protocol layer, the AIoT PDCP protocol layer, the AIoT RRC protocol layer, and the AIoT NAS protocol layer.

Optionally, in this embodiment of this application, the NAS protocol layer of the core network device and the NAS protocol layer of the UE are peer layers, and the protocol layers of the UE and the protocol layers of the AIoT device are peer layers.

It should be noted that the foregoing is merely some listed possible combinations of the protocol layers included in the devices, and another unlisted combination still falls within the protection scope of this application.

It should be noted that the foregoing is the control plane protocol stack.

For the user plane protocol stack, the RRC protocol layer is replaced with the SDAP, the AIoT RRC protocol layer is replaced with the AIoT SDAP, and the NAS protocol layer or the AIoT NAS protocol layer is removed.

In this way, because the AIoT device can transmit the AIoT data by using the control plane protocol stack without using the user plane protocol stack, the AIoT protocol stack architecture can be simplified to reduce costs and complexity of an Ambient IoT.

FIG. 2 is a schematic diagram of a data transmission method according to an embodiment of this application. As shown in FIG. 2, the data transmission method provided in this embodiment of this application may include the following step 201:

Step 201: User equipment UE performs at least one of the following in an ambient Internet of Things AIoT protocol stack architecture:
receiving, by the UE over a 3GPP air interface or a first AIoT link, AIoT data sent by a network side device;
sending, by the UE, the AIoT data to the network side device over the 3GPP air interface or the first AIoT link;
sending, by the UE, the AIoT data to an AIoT device over a second AIoT link; or
receiving, by the UE over the second AIoT link, the AIoT data sent by the AIoT device.

A first device includes the network side device and the AIoT device, the network side device includes a base station and a core network device, and the AIoT data includes AIoT signaling and service-related data.

Optionally, in this embodiment of this application, the AIoT data includes the AIoT signaling and the service-related data.

Optionally, the service-related data may be service-related data of an AIoT service.

Optionally, in this embodiment of this application, the AIoT data may include a MAC message, an RLC message, a PDU or an SDU of a PDCP message, an RRC message, a NAS message, and the like.

Optionally, in this embodiment of this application, the first AIoT link may be a backscatter BSC link. For example, the UE receives a downlink AIoT signal sent by the network side device, and the UE sends an uplink AIoT signal to the network side device by reflecting the received signal.

Optionally, in this embodiment of this application, 3GPP air interface transmission or backscatter communication may be performed between the UE and the network side device.

Optionally, in this embodiment of this application, the second AIoT link may be a backscatter BSC link. For example, the UE sends a downlink AIoT signal to the AIoT device, and the UE receives an uplink AIoT signal sent by the AIoT device by reflecting the received signal.

It should be noted that the Ambient IoT link may use backscattering or a sending or receiving method different from that is in 3GPP and that is applicable to an Ambient IoT.

Optionally, in this embodiment of this application, the UE may assist in downlink data transmission. For example, the UE receives the AIoT data sent by the network side device, and sends the AIoT data to the AIoT device.

Optionally, in this embodiment of this application, the UE may assist in uplink data transmission. For example, the UE receives the AIoT data sent by the AIoT device, and sends the AIoT data to the network side device.

In a possible embodiment, the UE may only assist in downlink transmission. For example, the UE receives the AIoT data sent by the base station, and sends the AIoT data to the AIoT device. The uplink AIoT data may be sent by the AIoT device to the base station.

In a possible embodiment, the UE may only assist in uplink transmission. For example, the UE receives the AIoT data sent by the AIoT device, and sends the AIoT data to the base station. The downlink AIoT data may be sent by the base station to the AIoT device.

In a possible embodiment, the UE may assist in uplink transmission and downlink transmission. For example, for assisting in downlink transmission, the UE receives the AIoT data sent by the base station, and sends the AIoT data to the AIoT device; and for assisting in uplink transmission, the UE receives the AIoT data sent by the AIoT device, and sends the AIoT data to the base station.

In this way, the UE may assist in at least one of downlink transmission or uplink transmission, so that a coverage area of a network in the AIoT architecture can be enlarged.

The following describes the data transmission method provided in this embodiment of this application by using an example in which the network side device is the base station and the UE assists in downlink data transmission.

For example, in a case that 3GPP air interface transmission is performed between the UE and the base station, the UE may receive, over the 3GPP air interface, the AIoT data sent by the base station, and send the AIoT data to the AIoT device over the second AIoT link.

For example, in a case that backscatter communication is performed between the UE and the base station, the UE may receive, over the first BSC link, the AIoT data sent by the base station, and send the AIoT data to the AIoT device over the second BSC link.

It should be noted that, in a case that the UE only assists in downlink data transmission, the AIoT device may send the AIoT data to the base station over a BSC link, and the base station may receive, over the BSC link, the AIoT data sent by the AIoT device.

The following describes the data transmission method provided in this embodiment of this application by using an example in which the network side device includes the core network device and the base station and the UE assists in downlink data transmission.

For example, in a case that 3GPP air interface transmission is performed between the UE and the base station perform transmission, the UE may receive, over the 3GPP air interface, the AIoT data sent by a core network and transparently transmitted by the base station, and send the AIoT data to the AIoT device over the second AIoT link.

For example, in a case that backscatter communication is performed between the UE and the base station, the UE may receive, over the first BSC link, the AIoT data sent by the core network and transparently transmitted by the base station, and send the AIoT data to the AIoT device over the second BSC link.

The following describes the data transmission method provided in this embodiment of this application by using an example in which the network side device is the base station and the UE assists in uplink data transmission.

For example, in a case that the UE and the base station perform transmission over the 3GPP air interface, the UE may receive, over the second AIoT link, the AIoT data sent by the AIoT device, and send the AIoT data to the base station over the 3GPP air interface.

It should be noted that, in a case that the UE only assists in uplink data transmission, for downlink data transmission, the base station may send the AIoT data to the AIoT device over a BSC link, and the AIoT device may receive, over the BSC link, the AIoT data sent by the base station.

The following describes the data transmission method provided in this embodiment of this application by using an example in which the network side device includes the base station and the core network device and the UE assists in uplink data transmission.

For example, in a case that 3GPP air interface transmission is performed between the UE and the base station perform transmission, the UE may receive, over the second AIoT link, the AIoT data sent by the AIoT device, and send the AIoT data to the base station over the 3GPP air interface, and then the base station sends the AIoT data to the core network device.

In this way, the UE may assist, through the 3GPP air interface or the BSC link, uplink and downlink data transmission of the AIoT data, thereby enlarging a coverage area of network deployment of a 3GPP Ambient IoT.

According to the data transmission method provided in this embodiment of this application, the UE may assist in transmission of AIoT signaling and service-related data to implement a necessary AIoT data transmission function, thereby enlarge a coverage area of the AIoT architecture, and supporting large-scale cellular network deployment, a large quantity of AIoT devices, and seamless coverage.

Optionally, in the data transmission method provided in this embodiment of this application, the UE may assist in uplink data transmission, or may assist in downlink data transmission, or may assist in uplink data transmission and downlink data transmission.

Optionally, in this embodiment of this application, the AIoT protocol stack architecture includes a control plane protocol stack, or includes the control plane protocol stack and a user plane protocol stack.

The UE includes a PHY protocol layer and a MAC protocol layer; the PHY protocol layer, the MAC protocol layer, and a NAS protocol layer; an AIoT PHY protocol layer and an AIoT MAC protocol layer; the AIoT PHY protocol layer, the AIoT MAC protocol layer, and an AIoT NAS protocol layer; or the PHY protocol layer, the MAC protocol layer, the NAS protocol layer, the AIoT PHY protocol layer, the AIoT MAC protocol layer, and the AIoT NAS protocol layer.

Optionally, in this embodiment of this application, a protocol stack of the UE further includes at least one of an RLC protocol layer, a PDCP protocol layer, an RRC protocol layer, or an SDAP protocol layer; or at least one of an AIoT RLC protocol layer, an AIoT PDCP protocol layer, an AIoT RRC protocol layer, or an AIoT SDAP protocol layer.

Optionally, in this embodiment of this application, the sending, by the UE, the AIoT data to the network side device over the 3GPP air interface may include the following 201a1:

Step 201a1: The UE sends the AIoT data to the base station over the 3GPP air interface at the MAC protocol layer, the RLC protocol layer, the PDCP protocol layer, the RRC protocol layer, or the SDAP protocol layer.

Optionally, the receiving, over the second AIoT link, the AIoT data sent by the AIoT device may include the following step 201a2:

Step 201a2: The UE receives, over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

Optionally, in this embodiment of this application, the receiving, over a 3GPP air interface, AIoT data sent by a network side device may include the following step 201b1:

Step 201b1: The UE receives, over the 3GPP air interface at the MAC protocol layer, the RLC protocol layer, the PDCP protocol layer, the RRC protocol layer, or the SDAP protocol layer, the AIoT data sent by the base station.

Optionally, the sending, by the UE, the AIoT data to an AIoT device over a second AIoT link may include the following step 201b2:

Step 201b2: The UE sends the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

The following provides an example description of transmission of the AIoT data performed when both the AIoT device and the UE include the NAS protocol layer and/or the AIoT NAS protocol layer.

For example, in a case that the UE receives, over the 3GPP air interface at the NAS protocol layer, NAS data sent by the base station, the UE sends the NAS data to the AIoT device over an AIoT link at the AIoT MAC protocol layer. In a case that the UE receives NAS data of the AIoT device over the AIoT link at the AIoT MAC protocol layer, the UE sends the NAS data to the base station over the 3GPP air interface at the NAS layer.

For example, in a case that the UE receives NAS data of the AIoT device at the AIoT MAC protocol layer, the UE sends the NAS data to the core network device over the 3GPP air interface at the NAS protocol layer. In a case that the UE receives NAS data sent by the core network device, the UE sends the NAS data to the AIoT device by using the AIoT MAC protocol layer.

It should be noted that there is no interface for directly performing data transmission between the UE and the core network device, and data is transparently transmitted between the UE and the core network device by using the base station, to perform data transmission between the UE and the core network.

The following describes transmission of the AIoT data performed when the AIoT device includes the AIoT NAS protocol layer and the UE does not include the NAS protocol layer and/or the AIoT NAS protocol layer.

For example, in a case that the UE receives, over the 3GPP air interface at the RRC protocol layer, NAS data sent by the base station, the UE sends the NAS data to the AIoT device over an AIoT link at the AIoT RRC protocol layer. In a case that the UE receives, at the AIoT RRC protocol layer, the AIoT data sent by the AIoT device, the UE sends the AIoT data to the base station over the 3GPP air interface at the RRC protocol layer.

The following describes transmission of the AIoT data performed when the AIoT device does not include the AIoT NAS protocol layer and the UE includes the NAS protocol layer and/or the AIoT NAS protocol layer.

For example, after receiving NAS data sent by the base station to the AIoT device at the RRC protocol layer, the UE sends the NAS data to the AIoT device at the AIoT MAC protocol layer; or after receiving the AIoT data sent by the base station to the AIoT device at the SDAP layer, the UE sends the AIoT data to the AIoT device at the AIoT MAC protocol layer. In a case that the UE receives the AIoT data of the AIoT device by using the AIoT MAC protocol layer, the UE sends the AIoT data to the base station over the 3GPP air interface at the RRC protocol layer, where the AIoT data includes NAS data sent to the core network device.

In this way, the UE may assist, at different protocol layers through 3GPP air interface transmission and BSC backscatter communication, transmission of the AIoT data, thereby improving data transmission efficiency.

Optionally, in this embodiment of this application, the sending, by the UE, the AIoT data to the network side device over the first AIoT link may include the following step 201c1:

Step 201c1: The UE sends the AIoT data to the base station over the first AIoT link at the AIoT RRC protocol layer, the AIoT SDAP protocol layer, the AIoT RLC protocol layer, the AIoT PDCP protocol layer, or the AIoT MAC protocol layer.

Optionally, the receiving, by the UE over the second AIoT link, the AIoT data sent by the AIoT device may include the following step 201c2:

Step 201c2: The UE transmits the AIoT data with the AIoT device over the second AIoT link at the AIoT MAC protocol layer, the AIoT RLC protocol layer, the AIoT PDCP protocol layer, the AIoT RRC protocol layer, or the AIoT SDAP protocol layer.

The following describes transmission of the AIoT data performed in a case that the AIoT device includes the AIoT NAS protocol layer and the UE does not include the NAS protocol layer and/or the AIoT NAS protocol layer.

For example, in a case that the UE receives, over a BSC link at the AIoT RRC protocol layer, NAS data sent by the base station, the UE sends the NAS data to the AIoT device over the BSC link at the AIoT RRC protocol layer. In a case that the UE receives, over a BSC link at the AIoT RRC protocol layer, an RRC message that includes NAS data and that is sent by the AIoT device, the UE sends the RRC message to the base station at the AIoT RRC protocol layer.

For example, in a case that the UE receives NAS data that is sent by the base station to the AIoT device by using the RRC protocol layer or the SDAP protocol layer, the UE sends the NAS data to the AIoT device over a BSC link at the AIoT MAC protocol layer. After receiving NAS data of the AIoT device, the UE sends the NAS data to the base station over a BSC link at the AIoT RRC protocol layer.

For example, after receiving NAS data of the AIoT device over an AIoT link at the AIoT MAC protocol layer, the UE sends the NAS data to the base station over the AIoT link at the AIoT MAC protocol layer. In a case that the UE receives, at the AIoT MAC protocol layer, NAS data sent by the base station, the UE sends the NAS data to the AIoT device over an AIoT link at the AIoT MAC protocol layer.

In this way, the UE may assist, through backscatter communication, in transmission of the AIoT data between the network side device and the AIoT device, thereby improving data transmission efficiency.

Optionally, in this embodiment of this application, the receiving, by the UE over a first AIoT link, AIoT data sent by a network side device may include the following step 201d1:

Step 201d1: The UE receives, over the first AIoT link at the AIoT RRC protocol layer, the AIoT SDAP protocol layer, the AIoT RLC protocol layer, the AIoT PDCP protocol layer, or the AIoT MAC protocol layer, the AIoT data sent by the base station.

Optionally, the sending, by the UE, the AIoT data to an AIoT device over a second AIoT link may include the following step 201d2:

Step 201d2: The UE sends the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the sending, by the UE, the AIoT data to the network side device over the 3GPP air interface may include the following step 20e1:

Step 201e1: The UE sends the AIoT data to the core network device over the 3GPP air interface at the NAS protocol layer.

Optionally, the receiving, by the UE over the second AIoT link, the AIoT data sent by the AIoT device may include the following step 201e2:

Step 201e2: The UE receives, over the second AIoT NAS link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

The following describes transmission of the AIoT data performed in a case that the AIoT device includes the AIoT NAS protocol layer and the UE includes the NAS protocol layer and/or the AIoT NAS protocol layer.

For example, in a case that the UE receives, at the NAS protocol layer, NAS data sent by the core network device, the UE sends the NAS data to the AIoT device over an AIoT link at the AIoT RRC protocol layer. In a case that the UE receives, at the AIoT RRC protocol layer, an RRC message sent by the AIoT device, the UE sends the RRC message to the base station over the 3GPP air interface at the NAS protocol layer, and the base station sends the RRC message to the core network device.

The following describes transmission of the AIoT data performed in a case that the AIoT device does not include the AIoT NAS protocol layer and the UE includes the AIoT NAS protocol layer and/or the NAS protocol layer.

For example, after receiving NAS data sent by the base station to the AIoT device at the RRC protocol layer, the UE sends the NAS data to the AIoT device at the AIoT MAC protocol layer. In a case that the UE receives the AIoT data of the AIoT device by using the AIoT MAC protocol layer, the UE sends the AIoT data to the base station by using the RRC protocol layer, and the base station forwards the AIoT data to the core network device.

For example, in a case that the UE receives the AIoT data of the AIoT device at the AIoT MAC protocol layer, the UE sends the AIoT data to the core network device at the NAS protocol layer. In a case that the UE receives, at the MAC protocol layer, NAS data sent by the core network device to the AIoT device, the UE sends the NAS data to the AIoT device at the AIoT MAC protocol layer.

In this way, the UE may assist, at different protocol layers through 3GPP air interface transmission and backscatter communication, in transmission of the AIoT data between the network side device and the AIoT device, thereby improving data transmission efficiency.

Optionally, in this embodiment of this application, the sending the AIoT data to the network side device over the first AIoT link may include the following step 201f1:

Step 201f1: The UE sends the AIoT data to the network side device over the first AIoT link at the AIoT NAS layer.

Optionally, the receiving, by the UE over the second AIoT link, the AIoT data sent by the AIoT device may include the following step 201f2:

Step 201f2: The UE receives, over the second AIoT link at the AIoT MAC protocol layer, the AIoT RLC protocol layer, the AIoT PDCP protocol layer, the AIoT SDAP protocol layer, or the AIoT RRC protocol layer, the AIoT data sent by the AIoT device.

For example, in a case that the UE receives, at the AIoT NAS protocol layer, NAS data sent by the core network device, the UE sends the NAS data to the AIoT device by using the AIoT RRC protocol layer. In a case that the UE receives, over an AIoT link at the AIoT RRC protocol layer, an RRC message sent by the AIoT device, the UE sends the RRC message to the base station over the 3GPP air interface at the RRC protocol layer, and the base station sends, to the core network device, the AIoT data included in the RRC message.

Optionally, in this embodiment of this application, the AIoT PHY is configured to perform a first function.

The AIoT MAC is configured to perform at least one of a second function, a third function, a fourth function, a fifth function, a sixth function, or a seventh function.

The AIoT RLC is configured to perform the third function.

The AIoT PDCP is configured to perform the fourth function.

The AIoT RRC is configured to perform at least one of the fifth function or the sixth function.

The AIoT SDAP is configured to perform the seventh function.

The AIoT NAS is configured to perform the sixth function.

The first function includes at least one of the following: determining a time domain resource or a frequency domain resource for AIoT communication, performing uplink AIoT transmission, or performing downlink AIoT transmission.

The second function includes at least one of the following: transmitting AIoT service data, managing an AIoT status, or mapping an AIoT transmission channel.

The third function includes at least one of the following: transmitting higher-layer AIoT service data, assigning a sequence number to a data packet, or defining an AIoT transmission mode.

The fourth function includes at least one of the following: transmitting AIoT control plane data, transmitting AIoT user plane data, or maintaining a sequence number of an AIoT service data packet.

The fifth function includes at least one of the following: transmitting higher-layer AIoT service data, managing an AIoT status, or broadcasting an AIoT system message.

The sixth function includes at least one of the following: transmitting higher-layer AIoT service data, performing AIoT registration and registration update, managing a location, or managing an AIoT status.

The seventh function includes at least one of the following: performing mapping between an AIoT QoS flow and an AIoT data radio bearer, or assigning QoS flow identifiers to uplink and downlink AIoT data packets.

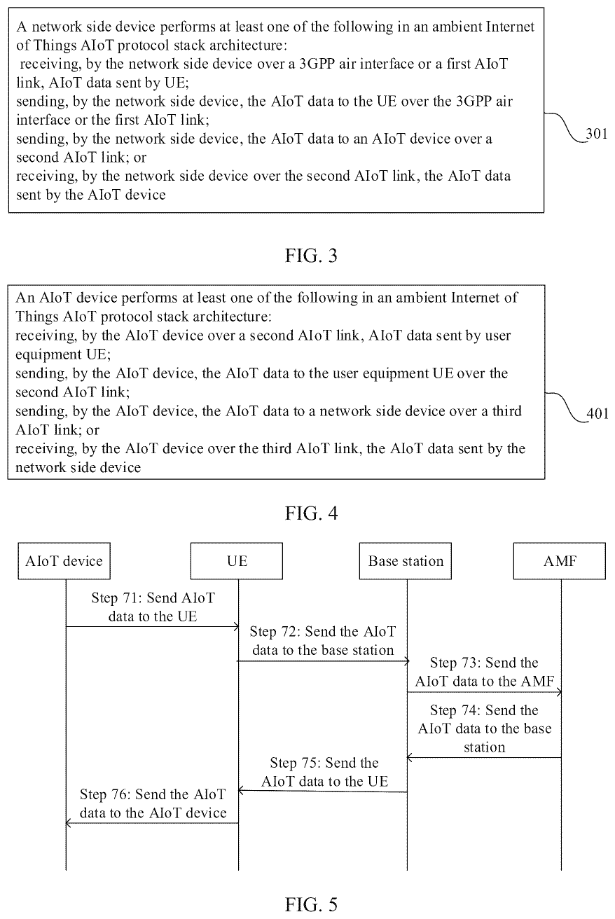

FIG. 3 is a schematic diagram of a data transmission method according to an embodiment of this application. As shown in FIG. 3, the data transmission method provided in this embodiment of this application may include the following step 301:

Step 301: A network side device performs at least one of the following in an ambient Internet of Things AIoT protocol stack architecture:
receiving, by the network side device over a 3GPP air interface or a first AIoT link, AIoT data sent by UE;
sending, by the network side device, the AIoT data to the UE over the 3GPP air interface or the first AIoT link;
sending, by the network side device, the AIoT data to an AIoT device over a third AIoT link; or
receiving, by the network side device over the third AIoT link, the AIoT data sent by the AIoT device.

The network side device includes a base station and a core network device, and the AIoT data includes AIoT signaling and service-related data.

Optionally, in this embodiment of this application, in a case that the AIoT data includes downlink data, the network side device sends the AIoT data to the UE, and the UE sends the AIoT data to the AIoT device.

Optionally, in this embodiment of this application, in a case that the AIoT data includes uplink data, the network side device receives the AIoT data sent by the UE.

In some possible embodiments, in a case that the UE assists in uplink data transmission, for uplink transmission, the network side device may receive, from the UE, the AIoT data received by the UE from the AIoT device; and for downlink transmission, the network side device may directly send the AIoT data to the AIoT device over the third AIoT link. In a case that the UE assists in downlink data transmission, for uplink transmission, the network side device may receive, over the third AIoT link, the AIoT data sent by the AIoT device; and for downlink transmission, the network side device may send the AIoT data to the UE, and the UE sends the AIoT data to the AIoT device.

Optionally, in this embodiment of this application, the third AIoT link may be a backscatter BSC link.

In a case that the UE assists in uplink data transmission, the network side device sends a downlink AIoT signal to the AIoT device; the AIoT device sends an uplink AIoT signal by reflecting the received signal; and the UE receives the uplink AIoT signal sent by the AIoT device through reflection, and then the UE sends the received AIoT data to the network side device.

In a case that the UE assists in downlink data transmission, the network side device sends the AIoT data to the UE; the UE sends a downlink AIoT signal to the AIoT device; the AIoT device sends an uplink AIoT signal by reflecting the received signal; and the network side device receives the uplink AIoT signal sent by the AIoT device through reflection.

It should be noted that for related explanation of this embodiment, reference may be made to the foregoing description. Details are not described herein again.

Optionally, in this embodiment of this application, the AIoT protocol stack architecture includes a control plane protocol stack, or includes the control plane protocol stack and a user plane protocol stack.

The base station includes a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer.

The core network device includes a NAS protocol layer; an AIoT NAS protocol layer; or the NAS protocol layer and the AIoT NAS protocol layer.

Optionally, in this embodiment of this application, the base station further includes at least one of an RLC protocol layer, a PDCP protocol layer, an SDAP protocol layer, or an RRC protocol layer; or at least one of an AIoT RLC protocol layer, an AIoT PDCP protocol layer, an AIoT SDAP protocol layer, or an AIoT RRC protocol layer.

Optionally, in this embodiment of this application, the sending, by the network side device, the AIoT data to the UE over the 3GPP air interface may include the following step 301a1:

Step 301a1: The network side device sends the AIoT data to the UE over the 3GPP air interface at the MAC protocol layer, the RLC protocol layer, the PDCP protocol layer, the RRC protocol layer, or the SDAP protocol layer.

Optionally, in this embodiment of this application, the sending, by the network side device, the AIoT data to the UE over the first AIoT link may include the following step 301b1:

Step 301b1: The network side device sends the AIoT data to the UE over the first AIoT link at the AIoT RRC protocol layer, the AIoT SDAP protocol layer, the AIoT MAC protocol layer, the AIoT RLC protocol layer, or the AIoT PDCP protocol layer.

Optionally, in this embodiment of this application, the receiving, by the network side device over a 3GPP air interface, AIoT data sent by UE may include the following step 301c1:

Step 301c1: The network side device receives, over the 3GPP air interface at the MAC protocol layer, the RLC protocol layer, the PDCP protocol layer, the RRC protocol layer, or the SDAP protocol layer, the AIoT data sent by the UE.

Optionally, in this embodiment of this application, the receiving, by the network side device over a first AIoT link, AIoT data sent by UE may include the following step 301d1:

Step 301d1: The network side device receives, over the first AIoT link at the AIoT RRC protocol layer, the AIoT SDAP protocol layer, the AIoT MAC protocol layer, the AIoT RLC protocol layer, or the AIoT PDCP protocol layer, the AIoT data sent by the UE.

Optionally, in this embodiment of this application, the sending, by the network side device, the AIoT data to the UE over the 3GPP air interface may include the following step 301e1:

Step 301e1: The core network device sends the AIoT data to the UE over the 3GPP air interface at the NAS protocol layer.

Optionally, in this embodiment of this application, the sending, by the network side device, the AIoT data to the UE over the first AIoT link may include the following step 301f1:

Step 301f1: The core network device sends the AIoT data to the UE over the first AIoT link at the AIoT NAS layer.

Optionally, in this embodiment of this application, the receiving, by the network side device over a 3GPP air interface, AIoT data sent by UE includes the following step 301g1 and step 301g2:

Step 301g1: The base station receives, over the 3GPP air interface at the MAC protocol layer, the RRC protocol layer, the RLC protocol layer, the PDCP protocol layer, or the SDAP protocol layer, the AIoT data sent by the UE.

Step 302g2: The base station sends the AIoT data to the core network device.

Optionally, in this embodiment of this application, the sending, by the network side device, the AIoT data to an AIoT device over a third AIoT link may include the following step 301h1 and step 30h2:

Step 301h1: The base station sends the AIoT data to the AIoT device over the third AIoT link at the AIoT MAC protocol layer, the AIoT RRC protocol layer, the AIoT RLC protocol layer, the AIoT PDCP protocol layer, or the AIoT SDAP protocol layer.

Step 302h2: The base station receives, over the third AIoT link at the AIoT MAC protocol layer, the AIoT RRC protocol layer, the AIoT RLC protocol layer, the AIoT PDCP protocol layer, or the AIoT SDAP protocol layer, the AIoT data sent by the AIoT device.

It should be noted that for related explanation and description of this embodiment, reference may be made to the foregoing embodiment. Details are not described herein again.

In the data transmission method provided in this embodiment of this application, the network side device receives, over the 3GPP air interface or the first AIoT link, the AIoT data sent by the UE, and/or the network side device sends the AIoT data to the UE over the 3GPP air interface or the first AIoT link. According to the method, in the solution, because the AIoT device and the network side device may be assisted by the UE to transmit AIoT signaling and service-related data, a coverage area of the AIoT device can be enlarged, and interference to an AIoT link system can be reduced, so that a 3GPP AIoT can provide large-scale cellular network deployment and seamless coverage to meet expected performance indicators such as power consumption, complexity, a coverage rate, a data rate, and positioning precision.

FIG. 4 is a schematic diagram of a data transmission method according to an embodiment of this application. As shown in FIG. 4, the data transmission method provided in this embodiment of this application may include the following step 401:

Step 401: An AIoT device performs at least one of the following in an ambient Internet of Things AIoT protocol stack architecture:
receiving, by the AIoT device over a second AIoT link, AIoT data sent by user equipment UE;
sending, by the AIoT device, the AIoT data to the user equipment UE over the second AIoT link;
sending, by the AIoT device, the AIoT data to a network side device over a third AIoT link; or
receiving, by the AIoT device over the third AIoT link, the AIoT data sent by the network side device.

The network side device includes a base station and a core network device, and the AIoT data includes AIoT signaling and service-related data.

Optionally, in this embodiment of this application, in a case that the UE assists in downlink transmission, for downlink transmission, the AIoT device receives the AIoT data received by the UE from the network side device; and for uplink transmission, the AIoT device may directly send the AIoT data to the network side device.

Optionally, in this embodiment of this application, in a case that the UE assists in uplink transmission, for uplink transmission, the AIoT device sends the AIoT data to the UE, and the UE sends the AIoT data to the network side device; and for downlink transmission, the AIoT device may receive the AIoT data sent by the network side device.

Optionally, at an AIoT MAC protocol layer, an AIoT RLC protocol layer, an AIoT PDCP protocol layer, an AIoT RRC protocol layer, an AIoT SDAP protocol layer, or an AIoT PHY protocol layer, the AIoT device may receive, over the third AIoT link, the AIoT data sent by the network side device, or send the AIoT data to the network side device over the third AIoT link.

Optionally, in this embodiment of this application, the AIoT protocol stack architecture includes a control plane protocol stack, or includes the control plane protocol stack and a user plane protocol stack.

The AIoT device includes a PHY protocol layer and a MAC protocol layer; an AIoT PHY protocol layer and an AIoT MAC protocol layer; or the AIoT PHY protocol layer, the AIoT MAC protocol layer, and an AIoT NAS protocol layer.

Optionally, in this embodiment of this application, a protocol stack of the AIoT device further includes at least one of an AIoT RLC protocol layer, an AIoT PDCP protocol layer, an AIoT RRC protocol layer, or an AIoT SDAP protocol layer.

Optionally, in this embodiment of this application, the receiving, by the AIoT device over a second AIoT link, AIoT data sent by UE may include the following step 401a1:

Step 401a1: The AIoT device receives, over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the UE.

Optionally, in this embodiment of this application, the sending, by the AIoT device, the AIoT data to the UE over the second AIoT link may include the following step 401a2:

Step 401a2: The AIoT device sends the AIoT data to the UE over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the sending, by the AIoT device, the AIoT data to a network side device over a third AIoT link may include the following step 401b1:

Step 401b1: The AIoT device sends the AIoT data to the UE over the third AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the receiving, by the AIoT device over the third AIoT link, the AIoT data sent by the network side device may include the following step 401b2:

Step 401b2: The AIoT device receives, over the third AIoT link at the AIoT MAC protocol layer, the AIoT RLC protocol layer, the AIoT PDCP protocol layer, the AIoT RRC protocol layer, or the AIoT SDAP protocol layer, the AIoT data sent by the network side device.

It should be noted that for related explanation and description of this embodiment, reference may be made to the foregoing embodiment. Details are not described herein again.

According to the data transmission method provided in this embodiment of this application, the AIoT device receives, over the second AIoT link, the AIoT data sent by the UE, or sends the AIoT data to the UE over the second AIoT link. According to the method, in the solution, because the AIoT device and the network side device may be assisted by the UE to transmit AIoT signaling and service-related data, a coverage area of the AIoT device can be enlarged, and interference to an AIoT link system can be reduced, so that a 3GPP AIoT can provide large-scale cellular network deployment and seamless coverage to meet expected performance indicators such as power consumption, complexity, a coverage rate, a data rate, and positioning precision.

The following provides example description of the data transmission method provided in the embodiments of this application by using a plurality of embodiments.

### Embodiment 1

In this embodiment, UE assists in uplink and downlink transmission of AIoT data, where the AIoT data is transmitted between the UE and a base station over a 3GPP air interface, and the data is transmitted between the UE and an AIoT device over an AIoT link.

The AIoT link can use a BSC access technology for communication.

In this embodiment, for a control plane protocol stack:

For a downlink direction of the AIoT data, the downlink direction is the base station→the UE→the Tag. In this case, the base station may send the AIoT data to the UE over the 3GPP air interface, and the UE may send the AIoT data to the AIoT device over the AIoT link. For example, the UE and the AIoT device each may include an AIoT PHY protocol layer and a MAC protocol layer. Optionally, the UE and the AIoT device each may include at least one of an AIoT RLC protocol layer, a PDCP protocol layer, an RRC protocol layer, or an IoT Layer protocol layer.

For an uplink direction of the AIoT data, the uplink direction is the Tag→the UE→the base station. In this case, the AIoT device may backscatter the AIoT data to the UE over a first AIoT link (which may be referred to as a BSC link), and the UE may forward uplink data of the AIoT device to the base station over a second AIoT link. For example, the UE and the AIoT device each may include an AIoT PHY protocol layer and a MAC protocol layer. Optionally, the UE and the Tag each may include at least one of an AIoT RLC protocol layer, a PDCP protocol layer, or an RRC protocol layer.

In this embodiment, for a user plane protocol stack:

For a downlink direction of the AIoT data, the downlink direction is the base station→the UE→the Tag. In this case, the base station may send the AIoT data to the UE over the 3GPP air interface, and the UE sends the AIoT data to the AIoT device over a first AIoT link. For example, the UE and the AIoT device each may include an AIoT PHY protocol layer and a MAC protocol layer. Optionally, the UE and the AIoT device each may include an AIoT RLC protocol layer, a PDCP protocol layer, and an SDAP protocol layer.

For an uplink direction of the AIoT data, the uplink direction is the Tag→the UE→the base station. In this case, the AIoT device may backscatter data to the UE over a second AIoT link, and the UE may forward uplink data of the AIoT device to a base station or a core network device. For example, the UE and the AIoT device each may include an AIoT PHY protocol layer and a MAC protocol layer. Optionally, the UE and the AIoT device each may include an AIoT RLC protocol layer, a PDCP protocol layer, and an SDAP protocol layer.

The control plane protocol stack and/or the user plane protocol stack may include at least one of the following:
protocol layers of the UE and the AIoT device are peer layers;
3GPP air interface transmission is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

Optionally, in this embodiment, that the UE assists in downlink transmission of the Ambient IoT data may include at least one of the following:
the UE receives the AIoT data sent by the gNB; or
the UE sends the AIoT data to the AIoT device over a second AIoT link. That the UE sends the AIoT data to the AIoT device over the second AIoT link may include any one of the following:
after receiving downlink data of the gNB, the UE may directly forward the received downlink data to the AIoT device, that is, once receiving a data packet sent by the gNB, the UE sends the data packet to the AIoT device; and
the UE sends, based on one or more data packets sent by the gNB, a command and/or the data packet to the AIoT device based on the second AIoT link, where the data packet may be MAC, RLC, a PDU or an SDU of a PDCP, an RRC message, a NAS message, Ambient IoT service data, or the like.

Optionally, in this embodiment, that the UE assists in uplink transmission of the Ambient IoT data may include at least one of the following:
the UE monitors, through a first AIoT link (for example, a BSC uplink), data sent by the AIoT device, and then forwards the data to the gNB by using a 3GPP access technology (for example, NR); or
after receiving the uplink data of the AIoT device, the UE may directly forward the received data to the gNB, where there are a plurality of methods:

Method 1: Once a data packet reflected by the AIoT device is received, the data packet is sent.

Method 2: One or more data packets reflected by the AIoT device are sent to the gNB after undergoing operations such as buffering, segmentation, and reassembly, where the data packet may be MAC, RLC, a PDU or an SDU of a PDCP, an RRC message, a NAS message, Ambient IoT service data, or the like.

Optionally, in this embodiment, that the UE assists in transmission of the AIoT data includes at least one of the following:
acting as a proxy of an AIoT NAS function, where the AIoT NAS function may include registration, mobility management, positioning, a security function, authentication, authorization, integrity protection, encryption, decryption, and the like; or
transmitting AIoT service data, where for example, the AIoT service data is included in a NAS message, and is transmitted by using a control plane RRC protocol layer or a control plane MAC protocol layer.

FIG. 5 is a schematic interaction diagram of a data transmission method according to an embodiment of this application. The following provides an example description by using an example in which a network side device includes a base station and a core network device and the core network device includes an AMF.

As shown in FIG. 5, the data transmission method may include the following step 71 to step 76:

Step 71: The AIoT device sends the AIoT data to the UE.

Step 72: The UE sends the AIoT data to the base station.

Step 73: The base station sends the AIoT data to the AMF.

Optionally, after step 73, the following step 74 to step 76 may be further included:

Step 74: The AMF sends the AIoT data to the base station.

Step 75: The base station sends the AIoT data to the UE.

Step 76: The UE sends the AIoT data to the AIoT device.

The following uses three examples to provide an example description of the technical solution provided in Embodiment 1.

### Example I

In this example, both the UE and the AIoT device include a NAS layer, and the UE NAS assists the AIoT NAS in transmission with an AMF.

The following uses three examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3/NAS)+gNB (L1/L2/L3)+CN.

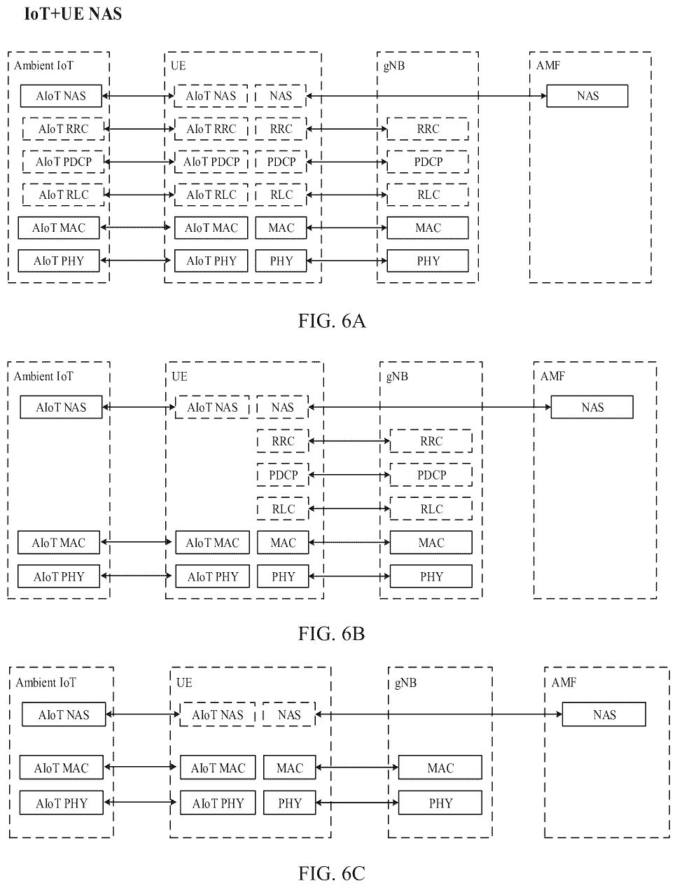

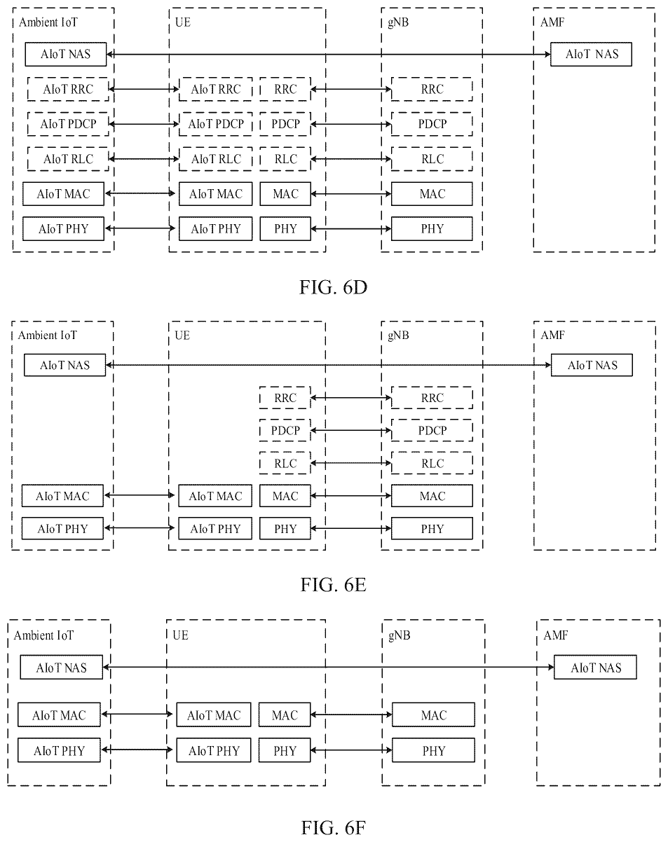

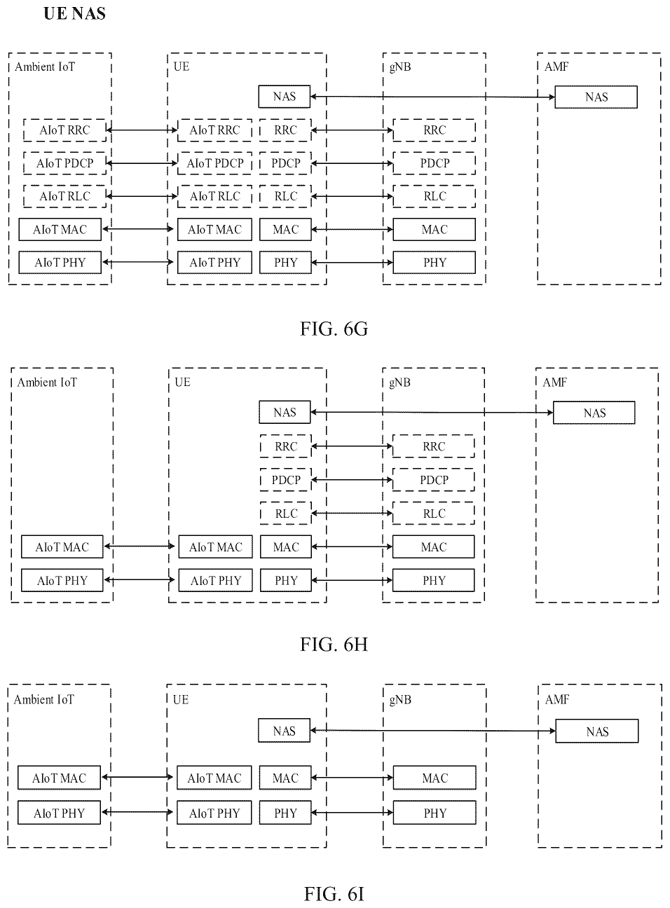

In this example, the control plane protocol stack is shown in FIG. 6A. For example, the UE may include an AIoT PHY, an AIoT MAC, an AIoT RLC, an AIoT PDCP, an AIoT RRC, an AIoT NAS, a PHY, a MAC, an RLC, a PDCP, an RRC, and a NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include a PHY, a MAC, an RLC, a PDCP, and an RRC.

In this example, data transmission between the UE and the gNB is performed by using the PHY, the MAC, the RLC, the PDCP, the RRC, or the NAS, and optionally, may be performed by using the SDAP.

In this example, data transmission of the AIoT device may include at least one of the following:
AIoT service-related data is transmitted by using the NAS and/or the SDAP; or
AIoT NAS data is transmitted by using a control plane (such as the RRC), including sending and receiving.

In this example, in a case that the UE receives uplink data of the AIoT device, the UE forwards the uplink data to the network side device. Alternatively, in a case that the UE receives downlink data sent by the network side device to the AIoT device, the UE forwards the data to the AIoT device. This helps reduce a delay of AIoT data transmission.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 2 may be represented as: AIoT device (PHY/MAC/NAS)+UE (L1/L2/L3/NAS)+gNB (L1/L2/L3)+CN.

In this example, the control plane protocol stack is shown in FIG. 6B. For example, the UE may include an AIoT PHY, an AIoT MAC, an AIoT NAS, a PHY, a MAC, an RLC, a PDCP, an RRC, and a NAS. Optionally, the UE may include an AIoT SDAP and an SDAP. The AIoT device may include an AIoT PHY, an AIoT MAC, and an AIoT NAS. The base station may include a PHY, a MAC, an RLC, a PDCP, and an RRC. The core network device may include a NAS.

In this example, data transmission of the AIoT device may include at least one of the following:
AIoT service-related data is transmitted by using the AIoT NAS and/or the NAS; or
AIoT NAS data is transmitted by using the AIoT MAC and/or the MAC, including sending and receiving.

In this example, the UE assists in Ambient IoT data transmission, which includes at least one of the following:
after receiving NAS data sent by the network side device to the AIoT device, the UE sends the NAS data to the AIoT device by using the AIoT MAC protocol layer; or
after the UE receives the NAS data of the AIoT device at the MAC protocol layer, the UE sends the NAS data to the network side device by using the NAS layer, where there are a plurality of methods:

Method 1: After receiving uplink data of the Tag, the UE may forward the uplink data to the gNB by using the MAC protocol layer, or by using sublayers such as the RLC, the PDCP, the SDAP, or the RRC.

Method 2: The UE performs buffer processing, segmentation and reassembly, retransmission, and other processing by using the MAC, the RLC, the PDCP, the SDAP, and/or the RRC, and then sends processed uplink data to the gNB by using a control plane or a user plane.

After receiving the uplink data of the AIoT device, the UE performs buffer processing, segmentation and reassembly, retransmission, and/or other processing by using the MAC, the RLC, the PDCP, the SDAP, and/or the RRC, and then sends the processed uplink data to the gNB by using the control plane or the user plane. In this way, an error rate of data transmission can be reduced, and robustness can be improved.

### Example 3

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 3 may be represented as: AIoT device (PHY/MAC/NAS)+UE (PHY/MAC/NAS)+gNB (PHY/MAC)+CN.

In this example, the control plane protocol stack is shown in FIG. 6C. For example, the UE may include an AIoT PHY, an AIoT MAC, an AIoT NAS, a PHY, a MAC, and a NAS. Optionally, the UE may include an AIoT SDAP and an SDAP. The AIoT device may include an AIoT PHY, an AIoT MAC, and an AIoT NAS. The base station may include a PHY and a MAC. The core network device may include a NAS.

In this example, data transmission between the UE and the gNB is transmitted by using the PHY, the MAC, and the NAS, and optionally, may be performed by using the SDAP.

In this example, Ambient IoT data transmission of the AIoT device may include the following:
NAS data of the AIoT device is transmitted by using the AIoT MAC, including sending and receiving.

In this example, the UE assists in AIoT data transmission, which includes at least one of the following:
after receiving NAS data of the AIoT device at the AIoT MAC protocol layer, the UE sends the NAS data to the core network device by using the NAS layer; or
after receiving the NAS data sent by the base station or the core network device to the AIoT device, the UE sends the NAS data to the AIoT device by using the AIoT MAC protocol layer.

In this example, Ambient IoT data transmission of the base station includes the following:
After receiving, at the MAC, the AIoT data sent by the UE at the MAC, the gNB sends the AIoT data to the AMF of the core network device.

### Example II

In this example, the AIoT device includes a NAS layer, the UE does not include a NAS layer, and the UE assists in transmission at an L1/L2/L3.

The following uses three examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 6D. For example, the UE may include an AIoT PHY, an AIoT MAC, an AIoT RLC, an AIoT PDCP, an AIoT RRC, an AIoT NAS, a PHY, a MAC, an RLC, a PDCP, an RRC, and a NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include a PHY, a MAC, an RLC, a PDCP, and an RRC.

In this example, data transmission between the UE and the gNB is performed by using the PHY, the MAC, the RLC, the PDCP, the RRC, or the NAS, and optionally, may be performed by using the SDAP.

In this example, data transmission of the AIoT device may include at least one of the following:
AIoT service-related data is transmitted by using the NAS and/or the SDAP; or
AIoT NAS data is transmitted by using a control plane (such as the AIoT RRC), including sending and receiving.

In this example, the UE assists in Ambient IoT data transmission, which includes at least one of the following:
after the UE receives, at the RRC, NAS data sent by the network side device to the AIoT device, the UE sends the NAS data to the AIoT device by using the AIoT RRC protocol layer; or
after the UE receives, at the RRC, an AIoT RRC message that is sent by the AIoT device and that includes AIoT NAS data, the UE the AIoT RRC message to the network side device by using the RRC protocol layer, where there are a plurality of methods:

Method 1: After receiving uplink data of the AIoT device, the UE may forward the uplink data to the gNB by using the MAC protocol layer and/or sublayers such as the RLC, the PDCP, the SDAP, and/or the RRC.

Method 2: The UE performs buffer processing, segmentation and reassembly, retransmission, and/or other processing by using the MAC, the RLC, the PDCP, the SDAP, and/or the RRC, and then sends processed uplink data to the gNB.

In a case that the UE receives the uplink data of the AIoT device, the UE forwards the uplink data to the network side device. Alternatively, once the UE receives downlink data sent by the network side device to the AIoT device, the UE forwards the downlink data to the AIoT device. This helps reduce a delay of Ambient IoT data transmission.

In this example, Ambient IoT data transmission of the base station includes the following:
After receiving, at the RRC, the Ambient IoT data sent by the UE at the RRC, the gNB sends the Ambient IoT data to the AMF of the core network device.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC/NAS)+UE (L1/L2/L3)+gNB (L1/L2/L3)+CN.

In this example, the control plane protocol stack is shown in FIG. 6E. For example, the UE may include an AIoT PHY, an AIoT MAC, a PHY, a MAC, an RLC, a PDCP, and an RRC. Optionally, the UE may include an AIoT SDAP and an SDAP. The AIoT device may include an AIoT PHY, an AIoT MAC, and an AIoT NAS. The base station may include a PHY, a MAC, an RLC, a PDCP, and an RRC.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

In this example, data transmission of the AIoT device includes at least one of the following:
AIoT service-related data of the AIoT device is transmitted by using the AIoT NAS; or
AIoT NAS data of the AIoT device is transmitted by using the AIoT MAC, including sending and receiving.

In this example, the UE assists in Ambient IoT data transmission, which includes at least one of the following:
after receiving NAS data sent by a network to the AIoT device by using the RRC protocol layer or the SDAP layer, the UE sends the NAS data to the AIoT device by using the AIoT MAC protocol layer; or
after the UE receives AIoT NAS data of the AIoT device at the AIoT MAC, the UE sends the AIoT NAS data to the network side device by using the RRC protocol layer, where there are a plurality of methods:

Method 1: After receiving uplink data of the AIoT device, the UE may forward the uplink data to the gNB by using the RRC protocol layer, that is, send the uplink data by using a control plane.

Method 2: After receiving uplink data of the AIoT device, the UE forwards the uplink data to the gNB by using sublayers such as the RLC, the PDCP, and the SDAP, that is, sends the uplink data by using a user plane.

Method 3: After receiving uplink data of the AIoT device, the UE performs buffer processing, segmentation and reassembly, retransmission, and/or another processing action by using the MAC, the RLC, the PDCP, the SDAP, and/or the RRC.

After receiving the uplink data of the Tag, the UE performs buffer processing, segmentation and reassembly, and/or retransmission, and then sends processed uplink data to the gNB by using a control plane or a user plane. In this way, an error rate of data transmission can be reduced, and robustness can be improved.

### Example 3

In this example, the UE and the AIoT device perform Ambient IoT data transmission by using a PHY/MAC/NAS protocol layer, the UE and the base station perform Ambient IoT data transmission by using the PHY/MAC protocol layer, and the UE and the core network perform data transmission by using the NAS layer.

It should be noted that a protocol stack architecture applied to Example 3 may be represented as: AIoT device (PHY/MAC/NAS)+UE (PHY/MAC)+gNB (PHY/MAC)+CN.

In this example, the control plane protocol stack is shown in FIG. 6F. For example, the UE may include an AIoT PHY, an AIoT MAC, a PHY, and a MAC. Optionally, the UE may include an AIoT SDAP and an SDAP. The AIoT device may include an AIoT PHY, an AIoT MAC, and an AIoT NAS. The base station may include a PHY and a MAC.

In this example, sublayers (such as the AIoT PHY and the MAC) of the UE and the AIoT device are peer layers, and NAS sublayers of the core network device, the AIoT device, and the UE are peer layers.

In this example, Ambient IoT data transmission of the AIoT device includes the following:
AIoT NAS data of the AIoT device is transmitted by using the AIoT MAC, including sending and receiving.

In this example, the UE assists in Ambient IoT data transmission, which includes at least one of the following:
after receiving AIoT NAS data of the AIoT device, the UE MAC sends the AIoT NAS data to a network by using the MAC protocol layer; or
after receiving, at the MAC, NAS data sent by the network side device to the AIoT device, the UE sends the NAS data to the AIoT device by using the AIoT MAC protocol layer.

In this example, Ambient IoT data of the base station includes the following:
After receiving, at the MAC, the Ambient IoT data sent by the UE at the MAC, the gNB sends the Ambient IoT data to the AMF of the core network device.

### Example III

In this example, the AIoT device does not include a NAS layer, the UE includes a NAS layer, and the UE assists in transmission at an L1/L2/L3/NAS.

The following uses three examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and the core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in in FIG. 6G. For example, the UE may include an AIoT PHY, an AIoT MAC, an AIoT RLC, an AIoT PDCP, an AIoT RRC, an AIoT NAS, a PHY, a MAC, an RLC, a PDCP, an RRC, and a NAS. Optionally, the UE may include an AIoT SDAP and an SDAP. The AIoT device may include an AIoT PHY, an AIoT MAC, an AIoT RLC, an AIoT PDCP, and an AIoT RRC. The base station may include a PHY, a MAC, an RLC, a PDCP, and an RRC.

In this example, sublayers (the AIoT PHY, the MAC, the RLC, the PDCP, the RRC, and/or the SDAP) of the UE and the AIoT device are peer layers.

In this example, NAS sublayers of the core network device and the UE are peer layers.

In this example, Ambient IoT data transmission of the AIoT device includes the following:
Service-related data of the AIoT device is transmitted by using the AIoT RRC and/or the SDAP, including sending and receiving.

In this example, the UE assists in Ambient IoT data transmission, which includes at least one of the following:
after receiving, at the NAS, data sent by the network side device to the AIoT device, the UE sends the data to the AIoT device by using the AIoT RRC protocol layer; or
after receiving, at the RRC, an AIoT RRC message that is sent by the AIoT device and that includes the AIoT data, the UE sends the AIoT RRC message to the network side device by using the NAS layer. There are a plurality of methods:

Method 1: After receiving uplink data of the AIoT device, the UE may forward the uplink data to the gNB by using sublayers such as the MAC protocol layer, the RLC, the PDCP, the SDAP, and/or the RRC.

Method 2: The UE performs buffer processing, segmentation and reassembly, and/or retransmission by using the MAC, the RLC, the PDCP, the SDAP, and/or the RRC, and then sends processed uplink data to the gNB.

In this example, Ambient IoT data transmission of the base station includes at least one of the following:
after receiving, at the RRC, a NAS message that is sent by the UE at the RRC and that includes the Ambient IoT data, the gNB sends the NAS message to the AMF of the core network device; or
after receiving, at the RRC, the Ambient IoT data sent by the UE at the RRC, the gNB sends the Ambient IoT data to the AMF of the core network device.

In a case that the UE receives uplink data of the AIoT device, the network side device of the UE forwards the data. Alternatively, in a case that the UE receives downlink data sent by the network side device to the AIoT device, the UE forwards the downlink data to the AIoT device. This helps reduce a delay of Ambient IoT data transmission.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in in FIG. 6H. For example, the UE may include an AIoT PHY, an AIoT MAC, a PHY, a MAC, an RLC, a PDCP, and an RRC. Optionally, the UE may include an AIoT SDAP and an SDAP. The AIoT device may include an AIoT PHY and an AIoT MAC. The base station may include a PHY, a MAC, an RLC, a PDCP, and an RRC.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

In this example, data transmission of the AIoT device includes the following:
AIoT data is transmitted by using the AIoT MAC, including sending and receiving.

In this example, the UE assists in Ambient IoT data transmission, which includes at least one of the following:
after receiving NAS data sent by the network side device to the AIoT device by using the RRC protocol layer or the SDAP layer, the UE sends the NAS data to the AIoT device by using the AIoT MAC protocol layer; or
after receiving data of the AIoT device at the AIoT MAC, the UE sends the data to the network side device by using the RRC protocol layer. There are a plurality of sending methods:

Method 1: After receiving uplink data of the AIoT device, the UE may forward the uplink data to the gNB by using the RRC protocol layer, that is, send the uplink data by using a control plane.

Method 2: After receiving uplink data of the AIoT device, the UE forwards the uplink data to the gNB by using sublayers such as the RLC, the PDCP, and the SDAP, that is, sends the uplink data by using a user plane.

Method 3: After receiving uplink data of the AIoT device, the UE performs buffer processing, segmentation and reassembly, and/or retransmission processing by using the MAC, the RLC, the PDCP, the SDAP, and/or the RRC, and then sends processed uplink data to the gNB.

After receiving the uplink data of the Tag, the UE performs buffer processing, segmentation and reassembly, and/or retransmission, and then sends processed uplink data to the gNB by using a control plane or a user plane. In this way, an error rate of data transmission can be reduced, and robustness can be improved.

### Example 3

In this example, the UE and the AIoT device perform Ambient IoT data transmission by using a PHY/MAC protocol layer, the UE and the base station perform Ambient IoT data transmission by using the PHY/MAC protocol layer, and the UE and the core network perform data transmission by using a NAS layer.

It should be noted that a protocol stack architecture applied to Example 3 may be represented as: AIoT device (PHY/MAC)+UE (PHY/MAC/NAS)+gNB (PHY/MAC)+CN.

In this example, the control plane protocol stack is shown in FIG. 6I. For example, the UE may include an AIoT PHY, an AIoT MAC, a PHY, a MAC, and a NAS. Optionally, the UE may include an AIoT SDAP and an SDAP. The AIoT device may include an AIoT PHY and an AIoT MAC. The base station may include a PHY and a MAC.

In this example, sublayers (such as the AIoT PHY and the MAC) of the UE and the AIoT device are peer layers, and NAS sublayers of the core network device, the AIoT device, and the UE are peer layers.

In this example, Ambient IoT data transmission of the AIoT device includes the following:
NAS data of the AIoT device is transmitted by using the AIoT MAC, including sending and receiving.

In this example, the UE assists in Ambient IoT data transmission, which includes at least one of the following:
after the UE receives the AIoT NAS data of the AIoT device at the MAC, the UE sends the AIoT NAS data to the network side device by using the NAS layer; or
after receiving, at the MAC, NAS data sent by the network side device to the AIoT device, the UE sends the NAS data to the AIoT device by using the AIoT MAC protocol layer.

In this example, Ambient IoT data of the base station includes the following:
After receiving, at the MAC, the Ambient IoT data sent by the UE at the MAC, the gNB sends the Ambient IoT data to the AMF of the core network device.

### Embodiment 2

In this embodiment, UE assists in uplink and downlink transmission of AIoT data, where the AIoT data is transmitted between the UE and a base station over a first AIoT link, and the data is transmitted between the UE and an AIoT device over a second AIoT link.

The AIoT link can use a BSC access technology for communication.

For example, the UE sends data to the AIoT device by transmitting a radio wave, and the AIoT device sends the data to the UE through backscattering. For example, the UE serves as a Reader.

For example, the UE sends, to the base station through backscattering, received AIoT data sent by the AIoT device. For example, the UE serves as a relay, a forwarder (repeater), or another auxiliary device (helper) to transmit data by reflecting a signal sent by a gNB.

In this embodiment, for a control plane protocol stack:

For a downlink direction of the AIoT data, the downlink direction is the base station→the UE→the Tag. In this case, the base station may send the AIoT data to the UE over the AIoT link, and the UE may send the AIoT data to the AIoT device over the AIoT link. For example, the UE and the AIoT device each may include an AIoT PHY protocol layer and a MAC protocol layer. Optionally, the UE and the AIoT device each may include at least one of an AIoT RLC protocol layer, a PDCP protocol layer, or an RRC protocol layer.

For an uplink direction of the AIoT data, the uplink direction is the Tag→the UE→the base station. In this case, the AIoT device may backscatter the AIoT data to the UE over the first AIoT link (which may be referred to as a BSC link), and the UE may forward uplink data of the AIoT device to the base station over the second AIoT link. For example, the UE and the AIoT device each may include an AIoT PHY protocol layer and a MAC protocol layer. Optionally, the UE and the Tag each may include at least one of an AIoT RLC protocol layer, a PDCP protocol layer, or an RRC protocol layer.

In this embodiment, for a user plane protocol stack:

For a downlink direction of the AIoT data, the downlink direction is the base station→the UE→the Tag. In this case, the base station may send the AIoT data to the UE over the first AIoT link, and the UE sends the AIoT data to the AIoT device over the second AIoT link. For example, the UE and the AIoT device each may include an AIoT PHY protocol layer and a MAC protocol layer. Optionally, the UE and the AIoT device each may include an AIoT RLC protocol layer, a PDCP protocol layer, and an SDAP protocol layer.

For an uplink direction of the AIoT data, the uplink direction is the Tag→the UE→the base station. In this case, the AIoT device may backscatter data to the UE over the second AIoT link, and the UE may forward uplink data of the AIoT device to a base station or a core network device. For example, the UE and the AIoT device each may include an AIoT PHY protocol layer and a MAC protocol layer. Optionally, the UE and the AIoT device each may include an AIoT RLC protocol layer, a PDCP protocol layer, and an SDAP protocol layer.

The control plane protocol stack and/or the user plane protocol stack may include at least one of the following:
protocol layers of the UE and the AIoT device are peer layers;
3GPP air interface transmission is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

Optionally, in this embodiment, that the UE assists in downlink transmission of the Ambient IoT data may include at least one of the following:
the UE receives the AIoT data sent by the gNB; or
the UE sends the AIoT data to the AIoT device over the second AIoT link. That the UE sends the AIoT data to the AIoT device over the second AIoT link may include any one of the following:
after receiving downlink data of the gNB, the UE may directly forward the received downlink data to the AIoT device, that is, once receiving a data packet sent by the gNB, the UE sends the data packet to the AIoT device; and
the UE sends, based on one or more data packets sent by the gNB, a command and/or the data packet to the AIoT device based on the second AIoT link, where the data packet may be MAC, RLC, a PDU or an SDU of a PDCP, an RRC message, a NAS message, Ambient IoT service data, or the like.

Optionally, in this embodiment, that the UE assists in uplink transmission of the Ambient IoT data may include at least one of the following:
the UE monitors, through the first AIoT link (for example, a BSC uplink), data sent by the AIoT device, and then forwards the data to the gNB by using a 3GPP access technology (for example, NR); or
after receiving the uplink data of the AIoT device, the UE may directly forward the received data to the gNB, where there are a plurality of methods:

Method 1: Once a data packet reflected by the AIoT device is received, the data packet is sent.

Method 2: One or more data packets reflected by the AIoT device are sent to the gNB after undergoing operations such as buffering, segmentation, and reassembly, where the data packet may be MAC, RLC, a PDU or an SDU of a PDCP, an RRC message, a NAS message, Ambient IoT service data, or the like.

Optionally, in this embodiment, that the UE assists in transmission of the AIoT data includes at least one of the following:
acting as a proxy of an AIoT NAS function, where the AIoT NAS function may include registration, mobility management, positioning, a security function, authentication, authorization, integrity protection, encryption, decryption, and the like; or
transmitting AIoT service data, where for example, the AIoT service data is included in a NAS message, and is transmitted by using a control plane RRC protocol layer or a control plane MAC protocol layer.

The following uses three examples to provide an example description of the technical solution provided in Embodiment 2.

### Example I

In this example, both the UE and the AIoT device include a NAS layer, and the UE NAS assists the AIoT NAS in transmission with an AMF.

The following uses three examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3/NAS)+gNB (L1/L2/L3)+CN.

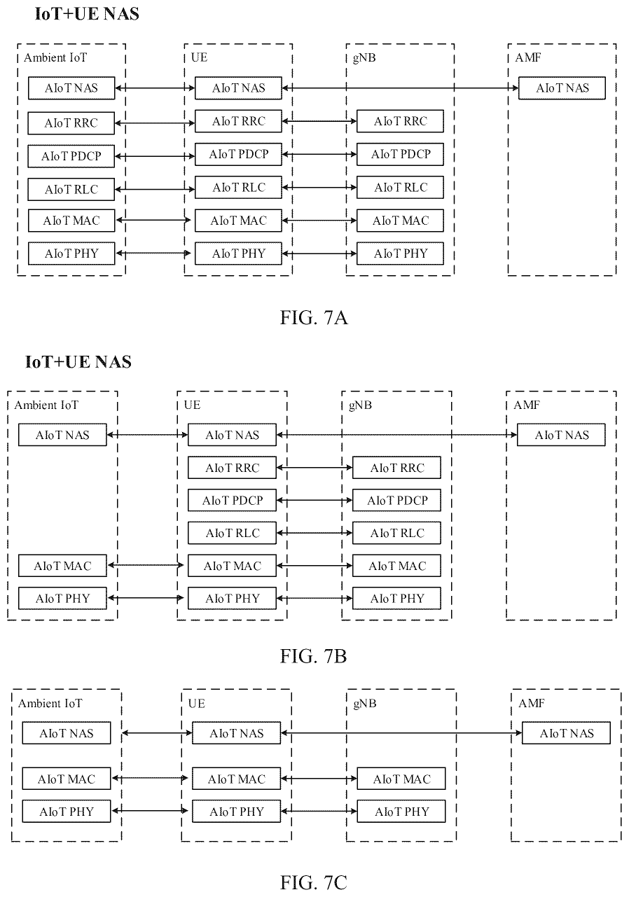

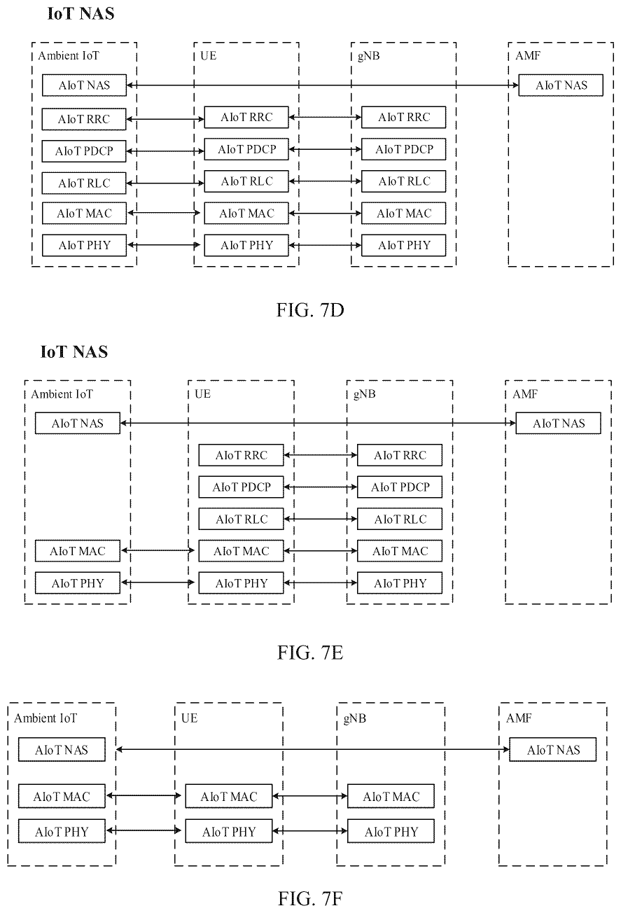

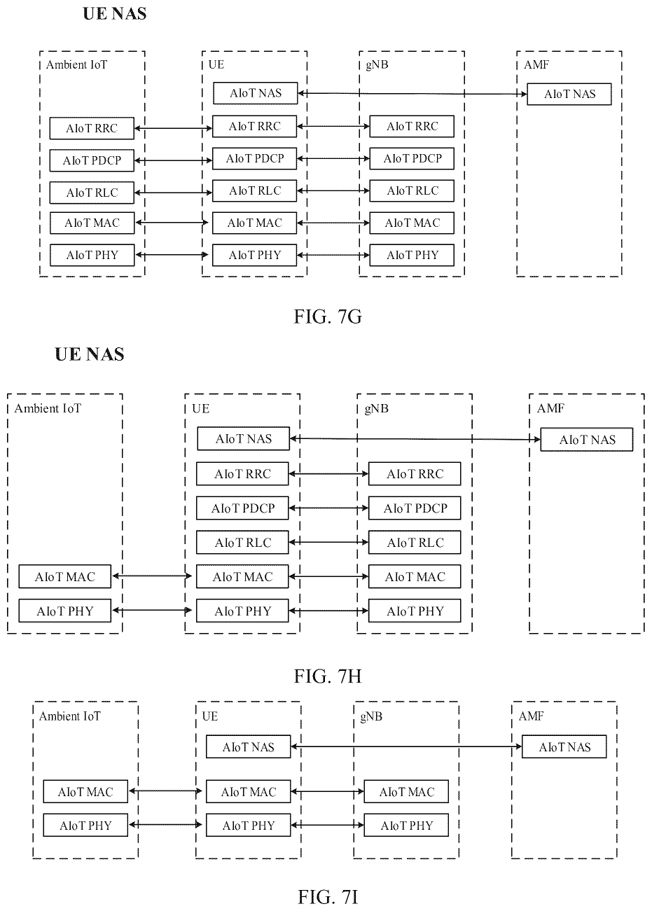

In this example, the control plane protocol stack is shown in FIG. 7A. For example, the UE may include an AIoT PHY, an AIoT MAC, an AIoT RLC, an AIoT PDCP, an AIoT RRC, and an AIoT NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, and an AIoT RRC.

In this example, sublayers (the AIoT PHY, the AIoT MAC, the AIoT RLC, the AIoT PDCP, the AIoT RRC, and/or the AIoT SDAP) of the base station, the UE, and the AIoT device are peer layers.

In this example, AIoT NAS sublayers of the core network, the AIoT device, and the UE are layers.

In this example, data transmission of the AIoT device may include at least one of the following:
AIoT service-related data is transmitted by using the AIoT NAS and/or the AIoT SDAP; or
AIoT NAS data is transmitted by using a control plane (such as the AIoT RRC), including sending and receiving.

In this example, in a case that the UE receives uplink data of the AIoT device, the UE can forward the uplink data to the network side device. Alternatively, in a case that the UE receives downlink data sent by the network side device to the AIoT device, the UE forwards the data to the AIoT device. This helps reduce a delay of AIoT data transmission.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 2 may be represented as: AIoT device (PHY/MAC/NAS)+UE (L1/L2/L3/NAS)+gNB (L1/L2/L3)+CN.

In this example, the control plane protocol stack is shown in FIG. 7B. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, and an AIoT NAS. The base station may include an AIoT PHY, AIoT MAC, an AIoT RLC, an AIoT PDCP, and an AIoT RRC. The core network device may include an AIoT NAS.

In this example, data transmission of the AIoT device may include at least one of the following:
AIoT service-related data is transmitted by using the AIoT NAS; or
AIoT NAS data is transmitted by using the AIoT MAC, including sending and receiving.

In this example, the UE assists in Ambient IoT data transmission, which includes at least one of the following:
after receiving NAS data sent by the network side device to the AIoT device, the UE sends the NAS data to the AIoT device by using the AIoT MAC protocol layer; or
after receiving the NAS data of the AIoT device at the AIoT MAC protocol layer, the UE sends the NAS data to the network side device by using the AIoT NAS layer, where there are a plurality of methods:

Method 1: After receiving uplink data of the AIoT device, the UE may forward the uplink data to the gNB by using the AIoT MAC protocol layer, or by using sublayers such as the AIoT RLC, the AIoT PDCP, the AIoT SDAP, or the AIoT RRC.

Method 2: The UE performs buffer processing, segmentation and reassembly, retransmission, and other processing by using the AIoT MAC, the AIoT RLC, the AIoT PDCP, the AIoT SDAP, and/or the AIoT RRC, and sends processed uplink data to the gNB by using a control plane or a user plane.

After receiving the uplink data of the AIoT device, the UE performs buffer processing, segmentation and reassembly, retransmission, and/or other processing by using the AIoT MAC, the AIoT RLC, the AIoT PDCP, the AIoT SDAP, and/or the AIoT RRC, and sends processed uplink data to the gNB by using a control plane or a user plane. In this way, an error rate of data transmission can be reduced, and robustness can be improved.

### Example 3

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 3 may be represented as: AIoT device (PHY/MAC/NAS)+UE (PHY/MAC/NAS)+gNB (PHY/MAC)+CN.

In this example, the control plane protocol stack is shown in FIG. 7C. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include an AIoT NAS.

In this example, sublayers (the AIoT PHY and the MAC) of the base station, the UE, and the AIoT device are peer layers, and AIoT NAS sublayers of the core network device, the AIoT device, and the UE are peer layers.

In this example, Ambient IoT data transmission of the AIoT device may include the following:
NAS data of the AIoT device is transmitted by using the AIoT MAC, including sending and receiving.

In this example, the UE assists in AIoT data transmission, which includes at least one of the following:
after receiving NAS data of the AIoT device at the AIoT MAC protocol layer, the UE sends the NAS data to the core network device by using the AIoT NAS layer; or
after receiving the NAS data sent by the base station or the core network device to the AIoT device, the UE sends the NAS data to the AIoT device by using the AIoT MAC protocol layer.

In this example, Ambient IoT data transmission of the base station includes the following:
After receiving, at the AIoT MAC, the AIoT data sent by the UE at the AIoT MAC, the gNB sends the AIoT data to the AMF of the core network device.

### Example II

In this example, the AIoT device includes a NAS layer, the UE does not include a NAS layer, and the UE assists in transmission at an L1/L2/L3.

The following uses three examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 7D. For example, the UE may include an AIoT PHY, an AIoT MAC, an AIoT RLC, an AIoT PDCP, and an AIoT RRC. Optionally, the UE may include an AIoT SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, and an AIoT RRC.

In this example, data transmission between the UE and the gNB is performed by using the PHY, the MAC, the RLC, the PDCP, the RRC, or the NAS, and optionally, may be performed by using the SDAP.

In this example, data transmission of the AIoT device may include at least one of the following:
AIoT service-related data is transmitted by using the AIoT NAS and/or the AIoT SDAP; or
AIoT NAS data is transmitted by using a control plane (such as the AIoT RRC), including sending and receiving.

In this example, the UE assists in Ambient IoT data transmission, which includes at least one of the following:
after the UE receives, at the AIoT RRC, NAS data sent by a network to the AIoT device, the UE sends the NAS data to the AIoT device by using the AIoT RRC protocol layer; or
after the UE receives, at the AIoT RRC, an RRC message that is sent by the AIoT device and that includes NAS data, the UE sends the RRC message to the network side device by using the AIoT RRC protocol layer, where there are a plurality of methods:

Method 1: After receiving uplink data of the AIoT device, the UE may forward the uplink data to the gNB by using sublayers such as the AIoT MAC protocol layer, the AIoT RLC, the AIoT PDCP, the AIoT SDAP, and/or the AIoT RRC.

Method 2: The UE performs buffer processing, segmentation and reassembly, and/or retransmission by using the AIoT MAC, the AIoT RLC, the AIoT PDCP, the AIoT SDAP, and/or the AIoT RRC, and then sends processed uplink data to the gNB.

In this example, Ambient IoT data transmission of the base station includes the following:
After receiving, at the RRC, the Ambient IoT data sent by the UE at the RRC, the gNB sends the Ambient IoT data to the AMF of the core network device.

In a case that the UE receives the uplink data of the AIoT device, the UE forwards the uplink data to the network side device. Alternatively, once the UE receives downlink data sent by the network side device to the AIoT device, the UE forwards the downlink data to the AIoT device. This helps reduce a delay of Ambient IoT data transmission.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC/NAS)+UE (L1/L2/L3)+gNB (L1/L2/L3)+CN.

In this example, the control plane protocol stack is shown in FIG. 7E. For example, the UE may include an AIoT PHY, an AIoT MAC, an AIoT RLC, an AIoT PDCP, and an AIoT RRC. Optionally, the UE may include an AIoT SDAP. The AIoT device may include an AIoT PHY, an AIoT MAC, and an AIoT NAS. The base station may include an AIoT PHY, an AIoT MAC, an AIoT RLC, an AIoT PDCP, and an AIoT RRC.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

In this example, data transmission of the AIoT device includes at least one of the following:
AIoT service-related data of the AIoT device is transmitted by using the AIoT NAS; or
AIoT NAS data of the AIoT device is transmitted by using the AIoT MAC, including sending and receiving.

In this example, the UE assists in Ambient IoT data transmission, which includes at least one of the following:
After receiving NAS data sent by the network side device to the AIoT device by using the RRC protocol layer or the SDAP layer, the UE sends the NAS data to the AIoT device by using the AIoT MAC protocol layer; or
after the UE receives AIoT NAS data of the AIoT device at the AIoT MAC, the UE sends the AIoT NAS data to the network side device by using the AIoT RRC protocol layer, where there are a plurality of methods:

Method 1: After receiving uplink data of the AIoT device, the UE may forward the uplink data to the gNB by using the AIoT RRC protocol layer, that is, send the uplink data by using a control plane.

Method 2: After receiving uplink data of the AIoT device, the UE forwards the uplink data to the gNB by using sublayers such as the AIoT RLC, the AIoT PDCP, and the AIoT SDAP, that is, sends the uplink data by using a user plane.

Method 3: After receiving uplink data of the AIoT device, the UE performs buffer processing, segmentation and reassembly, retransmission, and/or another processing action by using the AIoT MAC, the AIoT RLC, the AIoT PDCP, the AIoT SDAP, and/or the AIoT RRC.

After receiving the uplink data of the AIoT device, the UE performs buffer processing, segmentation and reassembly, and/or retransmission by using the AIoT MAC, the AIoT RLC, the AIoT PDCP, the AIoT SDAP, and/or the AIoT RRC, and then sends processed uplink data to the gNB by using a control plane or a user plane. In this way, an error rate of data transmission can be reduced, and robustness can be improved.

### Example 3

In this example, the UE and the AIoT device perform Ambient IoT data transmission by using a PHY/MAC/NAS protocol layer, the UE and the base station perform Ambient IoT data transmission by using the PHY/MAC protocol layer, and the UE and the core network perform data transmission by using the NAS layer.

It should be noted that a protocol stack architecture applied to Example 3 may be represented as: AIoT device (PHY/MAC/NAS)+UE (PHY/MAC)+gNB (PHY/MAC)+CN.

In this example, the control plane protocol stack is shown in FIG. 7F. For example, the UE may include an AIoT PHY and an AIoT MAC. Optionally, the UE may include an AIoT SDAP. The AIoT device may include an AIoT PHY, an AIoT MAC, and an AIoT NAS. The base station may include an AIoT PHY and an AIoT MAC.

In this example, sublayers (such as the AIoT PHY and the MAC) of the UE and the AIoT device are peer layers, and NAS sublayers of the core network device, the AIoT device, and the UE are peer layers.

In this example, Ambient IoT data transmission of the AIoT device includes the following:
AIoT NAS data of the AIoT device is transmitted by using the AIoT MAC, including sending and receiving.

In this example, the UE assists in Ambient IoT data transmission, which includes at least one of the following:
after the UE receives AIoT NAS data of the AIoT device at the MAC, the UE sends the AIoT NAS data to the network side device by using the AIoT MAC protocol layer; or
after receiving, at the MAC, NAS data sent by the network side device to the AIoT device, the UE sends the NAS data to the AIoT device by using the AIoT MAC protocol layer.

In this example, Ambient IoT data of the base station includes the following:
After receiving, at the AIoT MAC, the Ambient IoT data sent by the UE at the AIoT MAC, the gNB sends the Ambient IoT data to the AMF of the core network device.

### Example III

In this example, the AIoT device does not include a NAS layer, the UE includes a NAS layer, and the UE assists in transmission at an L1/L2/L3/NAS.

The following uses three examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and the core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in FIG. 7G. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, an AIoT RLC, an AIoT PDCP, and an AIoT RRC. The base station may include an AIoT PHY, an AIoT MAC, an AIoT RLC, an AIoT PDCP, and an AIoT RRC.

In this example, sublayers (the AIoT PHY, the MAC, the RLC, the PDCP, the RRC, and/or the SDAP) of the UE and the AIoT device are peer layers.

In this example, NAS sublayers of the core network device and the UE are peer layers.

In this example, Ambient IoT data transmission of the AIoT device includes the following:
Service-related data of the AIoT device is transmitted by using the AIoT RRC and/or the SDAP, including sending and receiving.

In this example, the UE assists in Ambient IoT data transmission, which includes at least one of the following:
After receiving, at the AIoT NAS, data sent by the network side device to the AIoT device, the UE sends the data to the AIoT device by using the AIoT RRC protocol layer.

After receiving, at the AIoT RRC, an AIoT RRC message that is sent by the AIoT device and that includes the AIoT data, the UE sends the AIoT RRC message to the network side device by using the AIoT NAS layer, where there are a plurality of methods:

Method 1: After receiving uplink data of the AIoT device, the UE may forward the uplink data to the gNB by using sublayers such as the AIoT MAC protocol layer, the AIoT RLC, the AIoT PDCP, the AIoT SDAP, and/or the AIoT RRC.

Method 2: The UE performs buffer processing, segmentation and reassembly, and/or retransmission by using the AIoT MAC, the AIoT RLC, the AIoT PDCP, the AIoT SDAP, and/or the AIoT RRC, and then sends processed uplink data to the gNB.

In this example, Ambient IoT data transmission of the base station includes at least one of the following:
After receiving, at the AIoT RRC, a NAS message that is sent by the UE at the AIoT RRC and that includes the Ambient IoT data, the gNB sends the NAS message to the AMF of the core network device.

After receiving, at the AIoT RRC, the Ambient IoT data sent by the UE at the AIoT RRC, the gNB sends the Ambient IoT data to the AMF of the core network device.

In a case that the UE receives uplink data of the AIoT device, the network side device of the UE forwards the data. Alternatively, in a case that the UE receives downlink data sent by the network side device to the AIoT device, the UE forwards the downlink data to the AIoT device. This helps reduce a delay of Ambient IoT data transmission.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in in FIG. 7H. For example, the UE may include an AIoT PHY, an AIoT MAC, an AIoT RLC, an AIoT PDCP, an AIoT RRC, and an AIoT NAS. Optionally, the UE may include an AIoT SDAP and an SDAP. The AIoT device may include an AIoT PHY and an AIoT MAC. The base station may include a PHY, a MAC, an RLC, a PDCP, and an RRC.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

In this example, data transmission of the AIoT device includes the following:
AIoT data is transmitted by using the AIoT MAC, including sending and receiving.

In this example, the UE assists in Ambient IoT data transmission, which includes at least one of the following:
After receiving NAS data sent by the network side device to the AIoT device by using the RRC protocol layer or the SDAP layer, the UE sends the NAS data to the AIoT device by using the AIoT MAC protocol layer.

After receiving data of the AIoT device at the AIoT MAC, the UE sends the data to the network side device by using the AIoT RRC protocol layer. There are a plurality of sending methods:

Method 1: After receiving uplink data of the AIoT device, the UE may forward the uplink data to the gNB by using the AIoT RRC protocol layer, that is, send the uplink data by using a control plane.

Method 2: After receiving uplink data of the AIoT device, the UE forwards the uplink data to the gNB by using sublayers such as the AIoT RLC, the AIoT PDCP, and the AIoT SDAP, that is, sends the uplink data by using a user plane.

Method 3: After receiving uplink data of the AIoT device, the UE performs buffer processing, segmentation and reassembly, and/or retransmission processing by using the AIoT MAC, the AIoT RLC, the AIoT PDCP, the AIoT SDAP, and/or the AIoT RRC, and then sends processed uplink data to the gNB.

After receiving the uplink data of the AIoT device, the UE performs buffer processing, segmentation and reassembly, and/or retransmission by using the AIoT MAC, the AIoT RLC, the AIoT PDCP, the SDAP, and/or the AIoT RRC, and then sends processed uplink data to the gNB by using a control plane or a user plane. In this way, an error rate of data transmission can be reduced, and robustness can be improved.

### Example 3

In this example, the UE and the AIoT device perform Ambient IoT data transmission by using a PHY/MAC protocol layer, the UE and the base station perform Ambient IoT data transmission by using the PHY/MAC protocol layer, and the UE and the core network perform data transmission by using a NAS layer.

It should be noted that a protocol stack architecture applied to Example 3 may be represented as: AIoT device (PHY/MAC)+UE (PHY/MAC/NAS)+gNB (PHY/MAC)+CN.

In this example, the control plane protocol stack is shown in FIG. 7I. For example, the UE may include an AIoT PHY, an AIoT MAC, and an AIoT NAS. Optionally, the UE may include an AIoT SDAP. The AIoT device may include an AIoT PHY and an AIoT MAC. The base station may include an AIoT PHY and AIoT MAC.

In this example, sublayers (such as the AIoT PHY and the MAC) of the UE and the AIoT device are peer layers, and NAS sublayers of the core network device, the AIoT device, and the UE are peer layers.

In this example, Ambient IoT data transmission of the AIoT device includes the following:
NAS data of the AIoT device is transmitted by using the AIoT MAC, including sending and receiving.

In this example, the UE assists in Ambient IoT data transmission, which includes at least one of the following:
After the UE receives the AIoT NAS data of the AIoT device at the MAC, the UE sends the AIoT NAS data to the network side device by using the AIoT NAS layer.

After receiving, at the MAC, NAS data sent by the network side device to the AIoT device, the UE sends the NAS data to the AIoT device by using the AIoT MAC protocol layer.

In this example, Ambient IoT data of the base station includes the following:
After receiving, at the AIoT MAC, the Ambient IoT data sent by the UE at the AIoT MAC, the gNB sends the Ambient IoT data to the AMF of the core network device.

### Embodiment 3

In this embodiment, UE assists in uplink transmission of AIoT data, where the AIoT data is transmitted between the UE and a base station over a 3GPP air interface, and the data is transmitted between the UE and an AIoT device over a second AIoT link.

The AIoT link can use a BSC access technology for communication.

In this embodiment, for a control plane protocol stack:

For a downlink direction of the AIoT data, the downlink direction is the base station→the AIoT device. In this case, the base station may send the AIoT data to the AIoT device over the AIoT link. For example, the UE and the AIoT device each may include an AIoT PHY protocol layer and a MAC protocol layer. Optionally, the UE and the AIoT device each may include at least one of an AIoT RLC protocol layer, a PDCP protocol layer, or an RRC protocol layer.

For an uplink direction of the AIoT data, the uplink direction is the Tag→the UE→the base station. In this case, the AIoT device may backscatter the AIoT data to the UE over a first AIoT link (which may be referred to as an AIoT link), and the UE may forward uplink data of the AIoT device to the base station over the second AIoT link. For example, the UE and the AIoT device each may include an AIoT PHY protocol layer and a MAC protocol layer. Optionally, the UE and the Tag each may include at least one of an AIoT RLC protocol layer, a PDCP protocol layer, an RRC protocol layer, or a NAS protocol layer.

In this embodiment, for a user plane protocol stack, based on the foregoing control plane protocol stack, the NAS is removed and the RRC is replaced with an SDAP.

The control plane protocol stack and/or the user plane protocol stack may include at least one of the following:
protocol layers of the UE and the AIoT device are peer layers;
3GPP air interface transmission is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

Optionally, in this embodiment, that the UE assists in uplink transmission of the Ambient IoT data may include at least one of the following:
the UE monitors, through the first AIoT link (for example, an AIoT uplink), data sent by the AIoT device, and then forwards the data to the gNB by using a 3GPP access technology (for example, NR); or
after receiving the uplink data of the AIoT device, the UE may directly forward the received data to the gNB, where there are a plurality of methods:

Method 1: Once a data packet reflected by the AIoT device is received, the data packet is sent.

Method 2: One or more data packets reflected by the AIoT device are sent to the gNB after undergoing operations such as buffering, segmentation, and reassembly, where the data packet may be MAC, RLC, a PDU or an SDU of a PDCP, an RRC message, a NAS message, Ambient IoT service data, or the like.

Optionally, in this embodiment, that the UE assists in transmission of the AIoT data includes at least one of the following:
acting as a proxy of an AIoT NAS function, where the AIoT NAS function may include registration, mobility management, positioning, a security function, authentication, authorization, integrity protection, encryption, decryption, and the like; or
transmitting AIoT service data, where for example, the AIoT service data is included in a NAS message, and is transmitted by using a control plane RRC protocol layer or a control plane MAC protocol layer.

The following uses three examples to provide an example description of the technical solution provided in Embodiment 3.

### Example I

In this example, both the UE and the AIoT device include a NAS layer, and the UE NAS assists the AIoT NAS in transmission with an AMF.

The following uses three examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and a core network perform data transmission by using the NAS layer.

It should be noted that a protocol stack architecture applied to Example 1 may be represented as: AIoT device (L1/L2/L3/NAS)+UE (L1/L2/L3/NAS)+gNB (L1/L2/L3)+CN.

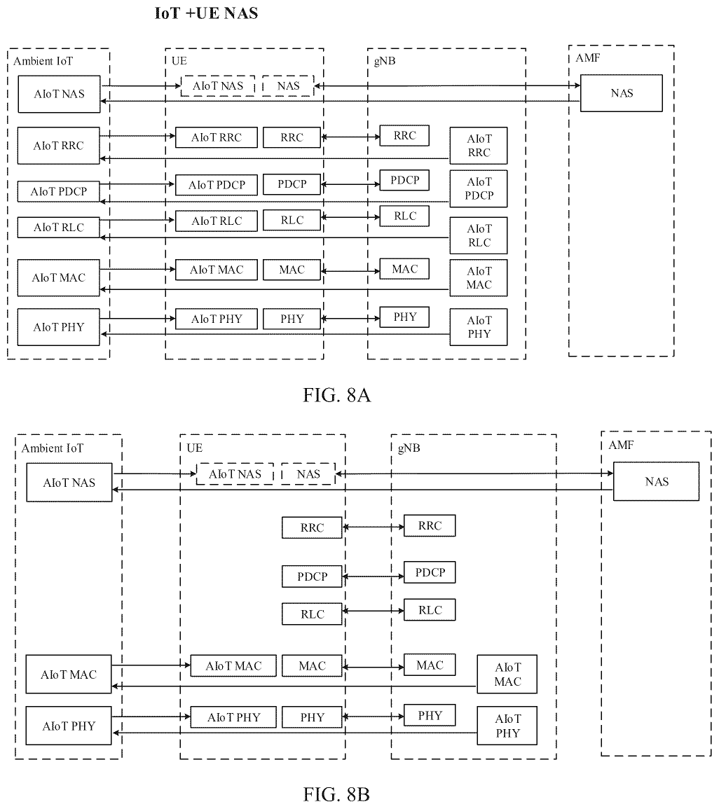

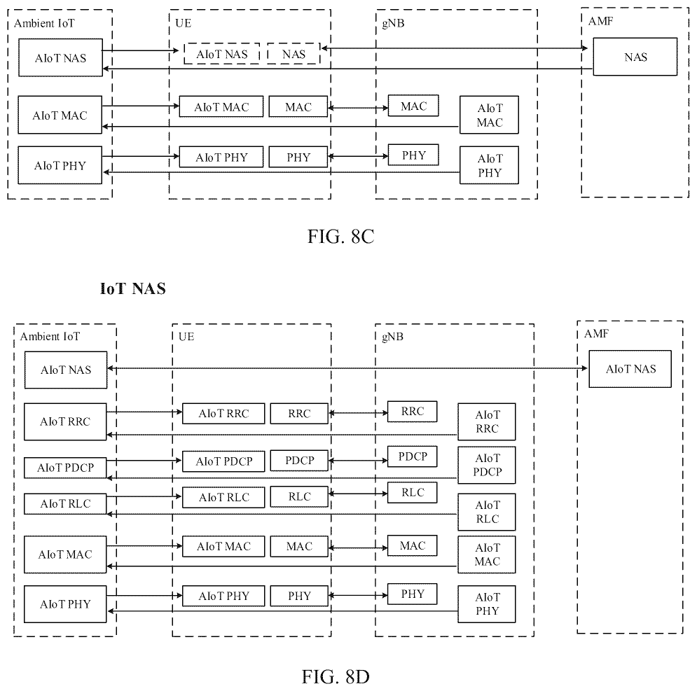

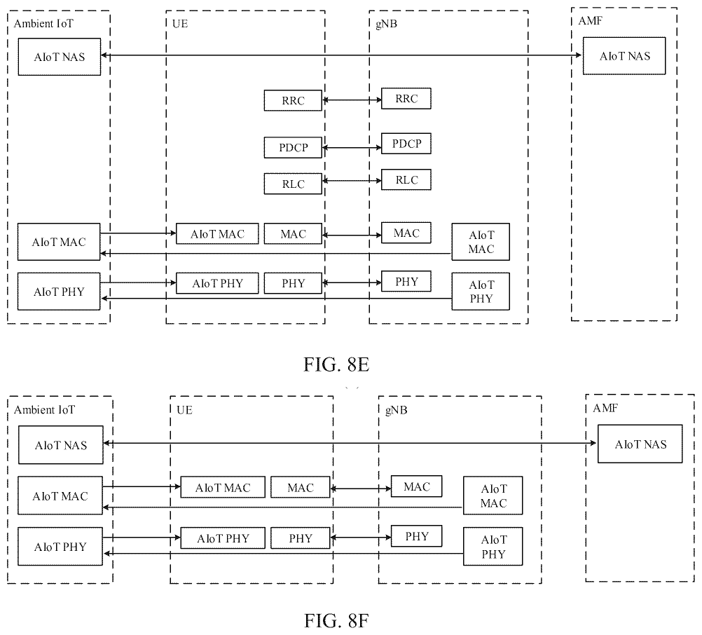

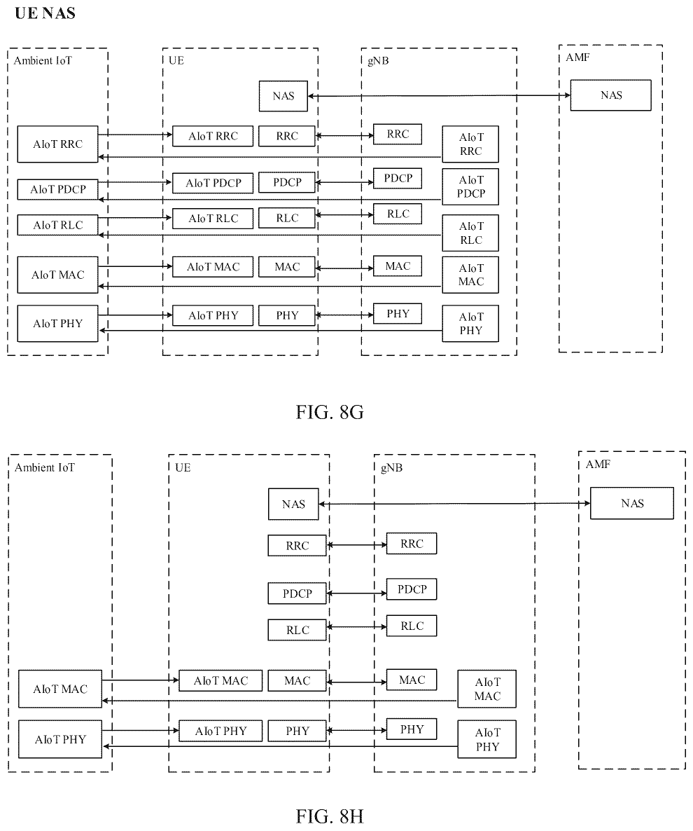

In this example, the control plane protocol stack is shown in FIG. 8A. For example, the UE may include an AIoT PHY, an AIoT MAC, an AIoT RLC, an AIoT PDCP, an AIoT RRC, an AIoT NAS, a PHY, a MAC, an RLC, a PDCP, an RRC, and a NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC. The core network device includes a NAS.

In this example, sublayers (the AIoT PHY, the AIoT MAC, the AIoT RLC, the AIoT PDCP, the AIoT RRC, and/or the AIoT SDAP) of the base station, the UE, and the AIoT device are peer layers, and AIoT NAS sublayers of the core network device, the AIoT device, and the UE are peer layers.

In this example, data transmission of the AIoT device is the same as that in Embodiment 1, and details are not described herein again.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and a core network perform data transmission by using the NAS layer.

It should be noted that a protocol stack architecture applied to Example 2 may be represented as: AIoT device (PHY/MAC/NAS)+UE (L1/L2/L3/NAS)+gNB (L1/L2/L3)+CN.

In this example, the control plane protocol stack is shown in FIG. 8B. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include a NAS.

In this example, for data transmission of the AIoT device, reference may be made to Embodiment 1. Details are not described herein again.

### Example 3

In this example, the UE and the AIoT device perform Ambient IoT data transmission by using a PHY/MAC/NAS protocol layer, the UE and the base station perform Ambient IoT data transmission by using an L1/L2/L3, and the UE and a core network perform data transmission by using the NAS layer.

It should be noted that a protocol stack architecture applied to Example 3 may be represented as: AIoT device (PHY/MAC/NAS)+UE (PHY/MAC/NAS)+gNB (PHY/MAC)+CN.

In this example, the control plane protocol stack is shown in FIG. 8C. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include an AIoT NAS.

In this example, sublayers (the AIoT PHY and the MAC) of the base station, the UE, and the AIoT device are peer layers, and AIoT NAS sublayers of the core network device, the AIoT device, and the UE are peer layers.

In this example, for Ambient IoT data transmission of the AIoT device, reference may be made to Embodiment 1. Details are not described herein again.

### Example II

In this example, the AIoT device includes a NAS layer, the UE does not include a NAS layer, and the UE assists in transmission at an L1/L2/L3.

The following uses three examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and a core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 8D. For example, the UE may include an AIoT PHY, an AIoT MAC, an AIoT RLC, an AIoT PDCP, an AIoT RRC, a PHY, a MAC, an RLC, and a PDCP. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC.

In this example, sublayers (the PHY, the MAC, the RLC, the PDCP, the RRC, and/or the SDAP) of the base station, the UE, and the AIoT device are peer layers. NAS sublayers of the core network and the AIoT device are peer layers.

For details of the UE assisting in uplink transmission of the Ambient IoT data, reference may be made to Embodiment 1. Details are not described herein again.

### Example 2

In this example, the UE and the AIoT device perform Ambient IoT data transmission by using a PHY/MAC protocol layer, the UE and the base station perform Ambient IoT data transmission by using an L1/L2/L3, and the UE and a core network perform data transmission by using a NAS layer.

It should be noted that a protocol stack architecture applied to Example 2 may be represented as: AIoT device (PHY/MAC/NAS)+UE (L1/L2/L3)+gNB (L1/L2/L3)+CN.

In this example, the control plane protocol stack is shown in FIG. 8E. For example, the UE may include an AIoT PHY and an AIoT MAC. Optionally, the UE may include an RLC, a PDCP, an RRC, and an SDAP. The AIoT device may include an AIoT PHY, an AIoT MAC, and an AIoT NAS. The base station may include an AIoT PHY and an AIoT MAC. Optionally, the base station may include an RLC, a PDCP, an RRC, and an SDAP.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

### Example 3

In this example, the UE and the AIoT device perform Ambient IoT data transmission by using a PHY/MAC/NAS protocol layer, the UE and the base station perform Ambient IoT data transmission by using the PHY/MAC protocol layer, and the UE and a core network perform data transmission by using the NAS layer.

It should be noted that a protocol stack architecture applied to Example 3 may be represented as: AIoT device (PHY/MAC/NAS)+UE (PHY/MAC)+gNB (PHY/MAC)+CN.

In this example, the control plane protocol stack is shown in FIG. 8F. For example, the UE may include an AIoT PHY, an AIoT MAC, a PHY, and a MAC. The AIoT device may include an AIoT PHY, an AIoT MAC, and an AIoT NAS. The base station may include a PHY and a MAC.

In this example, sublayers (the AIoT PHY and the MAC) of the UE and the AIoT device are peer layers, and NAS sublayers of the core network device, the AIoT device, and the UE are peer layers.

In this example, for uplink transmission of the Ambient IoT data, reference may be made to Embodiment 1. Details are not described herein again.

### Example III

In this example, the AIoT device does not include a NAS layer, the UE includes a NAS layer, and the UE assists in transmission at an L1/L2/L3/NAS.

The following uses three examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and a core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in FIG. 8G. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, an AIoT RLC, an AIoT PDCP, and an AIoT RRC. Optionally, the AIoT device may include an AIoT SDAP. The base station may include an AIoT PHY, an AIoT MAC, an AIoT RLC, an AIoT PDCP, and an AIoT RRC.

In this example, sublayers (the AIoT PHY, the MAC, the RLC, the PDCP, the RRC, and/or the SDAP) of the UE and the AIoT device are peer layers, and NAS sublayers of the core network device and the UE are peer layers.

### Example 2

In this example, the UE and the AIoT device perform Ambient IoT data transmission by using a PHY/MAC protocol layer, the UE and the base station perform Ambient IoT data transmission by using an L1/L2/L3, and the UE and a core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in in FIG. 8H. For example, the UE may include a PHY, a MAC, an RLC, a PDCP, an RRC, and a NAS. Optionally, the UE may include an SDAP. The AIoT device may include an AIoT PHY and an AIoT MAC. The base station may include a PHY, a MAC, an RLC, a PDCP, and an RRC.

In this example, sublayers (such as the PHY and the MAC) of the UE and the AIoT device are peer layers; RLCs, PDCPs, RRCs, and/or SDAPs of the base station and the UE are peer layer; and NAS sublayers of the core network device and the AIoT device are peer layers.

In this example, after receiving uplink data of the AIoT device, the UE performs buffer processing, segmentation and reassembly, and/or retransmission by using the MAC, the RLC, the PDCP, the SDAP, and/or the RRC, and then sends processed uplink data to the gNB by using a control plane or a user plane. This method reduces an error rate of data transmission and improves robustness.

### Example 3

In this example, the UE and the AIoT device perform Ambient IoT data transmission by using a PHY/MAC protocol layer, the UE and the base station perform Ambient IoT data transmission by using the PHY/MAC protocol layer, and the UE and a core network perform data transmission by using a NAS layer.

It should be noted that a protocol stack architecture applied to Example 3 may be represented as: AIoT device (PHY/MAC)+UE (PHY/MAC/NAS)+gNB (PHY/MAC)+CN.

In this example, the control plane protocol stack is shown in FIG. 8I. For example, the protocol stack is the same as the protocol stack in Example 3 in Example III in Embodiment 1, and details are not described herein again.

In this example, for an uplink data transmission method, reference may be made to the method in Example 3 in Example III in Embodiment 1. Details are not described herein again.

### Embodiment 4

In this embodiment, UE assists in uplink transmission of AIoT data, a core network device participates in the uplink transmission, and a relay manner of the UE is an AIoT relay (which may be a BSC relay). The UE performs AIoT data transmission with a base station over a first AIoT link, and the UE performs data transmission with an AIoT device over a second AIoT link.

The AIoT link can use a BSC access technology for communication.

In this embodiment, the foregoing AIoT data transmission may include at least one of the following:
the gNB sends data to the AIoT device over a BSC forward link; and the AIoT device sends a response through backscattering;
the UE monitors response data sent by the AIoT device; or
the UE sends, to the base station through backscattering, the received response data sent by the AIoT device. For example, the UE serves as a relay, a forwarder (repeater), or another auxiliary device (helper) to transmit data by reflecting a signal sent by a gNB.

In this embodiment, for a control plane protocol stack:

For a downlink direction of the AIoT data, the downlink direction is the base station→the AIoT device. In this case, the base station may send the AIoT data to the AIoT device over the AIoT link. For example, the base station and the AIoT device each may include a PHY protocol layer and a MAC protocol layer. Optionally, the base station and the AIoT device each may include at least one of an AIoT RLC protocol layer, a PDCP protocol layer, an RRC protocol layer, or a NAS protocol layer.

For an uplink direction of the AIoT data, the uplink direction is the AIoT device→the UE→the base station. In this case, the AIoT device may backscatter the AIoT data to the UE over the first AIoT link (which may be referred to as an AIoT link), and the UE may forward uplink data of the AIoT device to the base station over the second AIoT link. For example, the UE and the AIoT device each may include an AIoT PHY protocol layer and a MAC protocol layer. Optionally, the UE and the AIoT device each may include at least one of an AIoT RLC protocol layer, a PDCP protocol layer, an RRC protocol layer, or a NAS protocol layer.

In this embodiment, for a user plane protocol stack, based on the foregoing control plane protocol stack, the NAS is removed and the RRC is replaced with an SDAP.

The control plane protocol stack and/or the user plane protocol stack may include at least one of the following:
protocol layers of the UE and the AIoT device are peer layers;
backscatter communication is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

Optionally, in this embodiment, that the UE assists in uplink transmission of the Ambient IoT data may include at least one of the following:
the UE monitors, through the first AIoT link (for example, an AIoT uplink), data sent by the AIoT device, and then forwards the data to the gNB by using a 3GPP access technology (for example, NR); or
after receiving the uplink data of the AIoT device, the UE may directly forward the received data to the gNB, where there are a plurality of methods:

Method 1: Once a data packet reflected by the AIoT device is received, the data packet is sent.

Method 2: One or more data packets reflected by the AIoT device are sent to the gNB after undergoing operations such as buffering, segmentation, and reassembly, where the data packet may be MAC, RLC, a PDU or an SDU of a PDCP, an RRC message, a NAS message, Ambient IoT service data, or the like.

The following uses three examples to provide an example description of the technical solution provided in Embodiment 4.

### Example I

In this example, both the UE and the AIoT device include a NAS layer, and the UE NAS assists the AIoT NAS in transmission with an AMF.

The following uses two examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3/NAS)+gNB (L1/L2/L3)+CN.

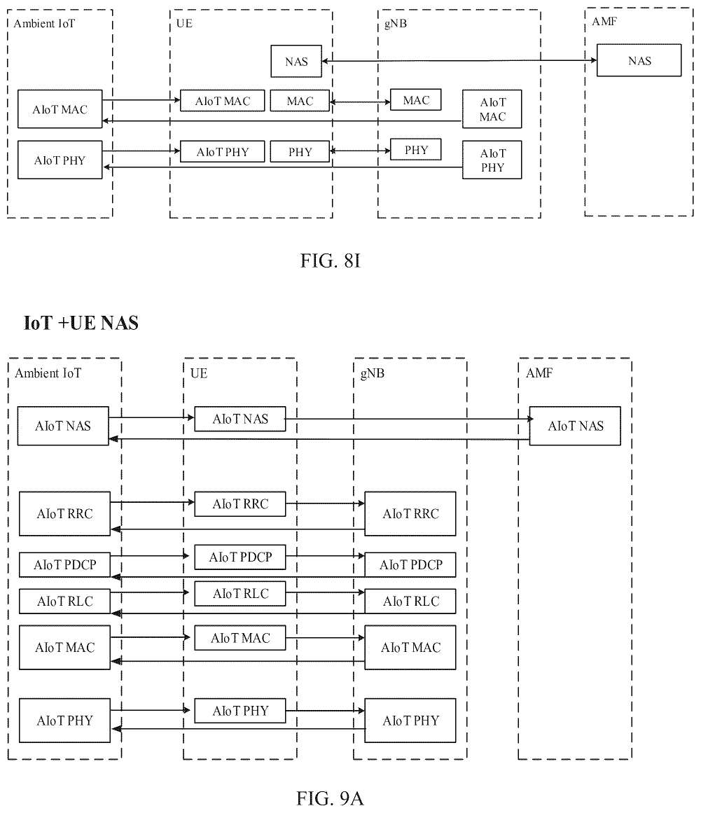

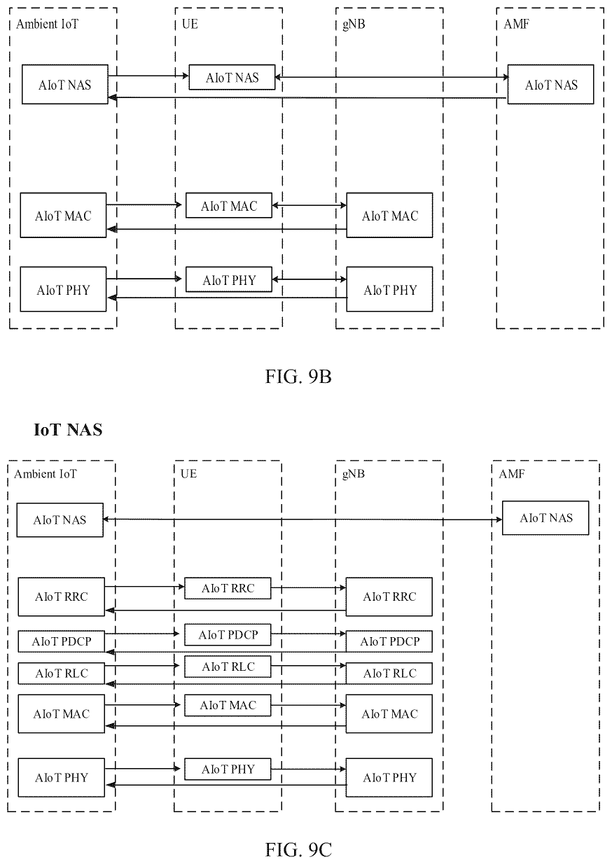

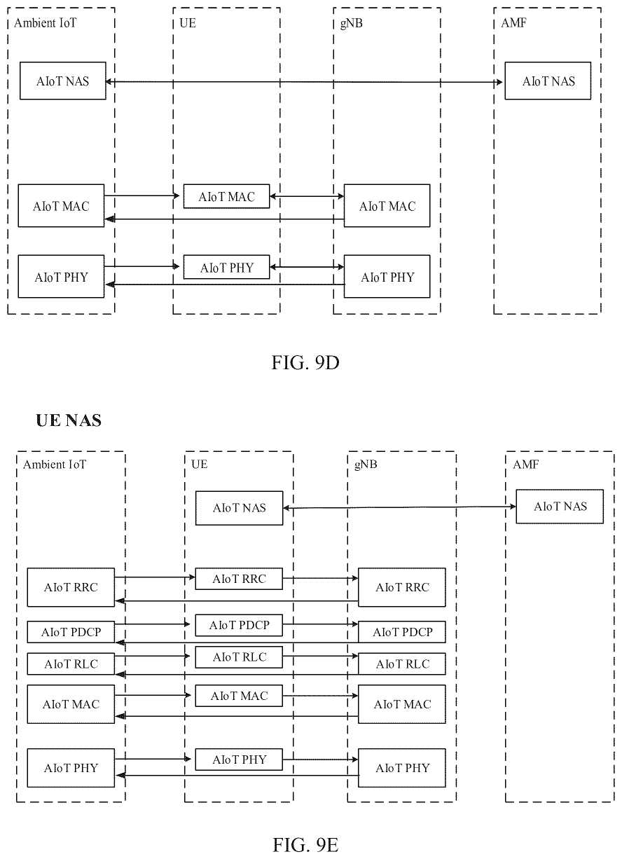

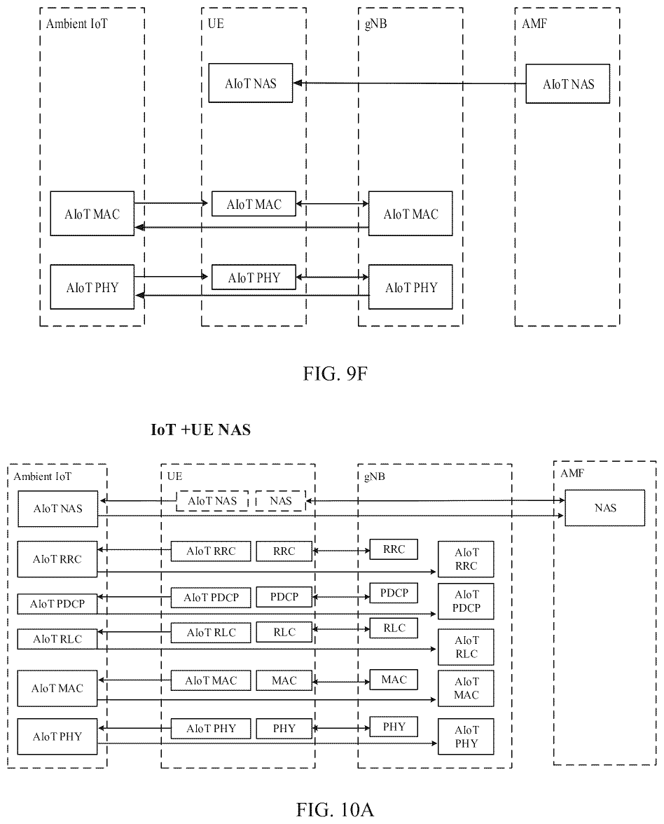

In this example, the control plane protocol stack is shown in FIG. 9A. For example, the UE may include an AIoT PHY, an AIoT MAC, an AIoT RLC, an AIoT PDCP, an AIoT RRC, and an AIoT NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, and an AIoT RRC.

In this example, sublayers (the AIoT PHY, the AIoT MAC, the AIoT RLC, the AIoT PDCP, the AIoT RRC, and/or the AIoT SDAP) of the base station, the UE, and the AIoT device are peer layers.

In this example, AIoT NAS sublayers of the core network, the AIoT device, and the UE are layers.

In this example, for data transmission of the AIoT device, reference may be made to Example 1 in Example I in Embodiment 2. Details are not described herein again.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 2 may be represented as: AIoT device (PHY/MAC/NAS)+UE (PHY/MAC/NAS)+gNB (PHY/MAC)+CN.

In this example, the control plane protocol stack is shown in FIG. 9B. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include an AIoT NAS.

In this example, sublayers (the AIoT PHY and the MAC) of the base station, the UE, and the AIoT device are peer layers, and AIoT NAS sublayers of the core network device, the AIoT device, and the UE are peer layers.

In this example, for Ambient IoT data transmission of the AIoT device, reference may be made to Embodiment 1. Details are not described herein again.

### Example II

In this example, the AIoT device includes a NAS layer, the UE does not include a NAS layer, and the UE assists in transmission at an L1/L2/L3.

The following uses two examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 9C. For example, the UE may include an AIoT PHY, an AIoT MAC, an AIoT RLC, an AIoT PDCP, and an AIoT RRC. Optionally, the UE may include an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC.

In this example, sublayers (the PHY, the MAC, the RLC, the PDCP, the RRC, and/or the SDAP) of the base station, the UE, and the AIoT device are peer layers. NAS sublayers of the core network and the AIoT device are peer layers.

For details of the UE assisting in uplink transmission of the Ambient IoT data, reference may be made to Example II in Embodiment 2. Details are not described herein again.

### Example 2

In this example, the UE and the AIoT device perform Ambient IoT data transmission by using a PHY/MAC/NAS protocol layer, the UE and the base station perform Ambient IoT data transmission by using the PHY/MAC protocol layer, and the UE and the core network perform data transmission by using the NAS layer.

It should be noted that a protocol stack architecture applied to Example 2 may be represented as: AIoT device (PHY/MAC/NAS)+UE (PHY/MAC)+gNB (PHY/MAC)+CN.

In this example, the control plane protocol stack is shown in FIG. 9D. For example, the UE may include an AIoT PHY, an AIoT MAC, a PHY, and a MAC. The AIoT device may include an AIoT PHY, an AIoT MAC, and an AIoT NAS. The base station may include an AIoT PHY and an AIoT MAC.

In this example, sublayers (the AIoT PHY and the MAC) of the UE and the AIoT device are peer layers, and NAS sublayers of the core network device, the AIoT device, and the UE are peer layers.

In this example, for uplink transmission of the Ambient IoT data, reference may be made to Example II in Embodiment 2. Details are not described herein again.

### Example III

In this example, the AIoT device does not include a NAS layer, the UE includes a NAS layer, and the UE assists in transmission at an L1/L2/L3/NAS.

The following uses two examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and the core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in FIG. 9E. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, an AIoT RLC, an AIoT PDCP, and an AIoT RRC. Optionally, the AIoT device may include an AIoT SDAP. The base station may include an AIoT PHY, an AIoT MAC, an AIoT RLC, an AIoT PDCP, and an AIoT RRC.

In this example, sublayers (the AIoT PHY, the MAC, the RLC, the PDCP, the RRC, and/or the SDAP) of the UE and the AIoT device are peer layers, and NAS sublayers of the core network device and the UE are peer layers.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in FIG. 9F. For example, the UE may include an AIoT PHY, an AIoT MAC, and an AIoT NAS. Optionally, the UE may include an AIoT SDAP. The AIoT device may include an AIoT PHY and an AIoT MAC. The base station may include an AIoT PHY and AIoT MAC.

It should be noted that, for an uplink data transmission method, reference may be made to the method in Example III IN Embodiment 2. Details are not described herein again.

### Embodiment 5

In this embodiment, UE assists in downlink transmission of AIoT data, a core network device participates in the downlink transmission, and a relay manner of the UE is a uu relay. The UE performs AIoT data transmission with a base station over 3GPP air interface, and the UE performs data transmission with an AIoT device over a second AIoT link.

The AIoT link can use a BSC access technology for communication.

In this embodiment, for a control plane protocol stack:

For a downlink direction of the AIoT data, the downlink direction is the base station→the UE→the AIoT device. In this case, the base station may send the AIoT data to the UE over the 3GPP air interface, and the UE sends the AIoT data to the AIoT device over the second AIoT link. For example, the UE and the AIoT device each may include an AIoT PHY protocol layer and a MAC protocol layer. Optionally, the UE and the AIoT device each may include at least one of an AIoT RLC protocol layer, a PDCP protocol layer, or an RRC protocol layer.

For an uplink direction of the AIoT data, the uplink direction is the AIoT device→the base station. In this case, the AIoT device may backscatter the AIoT data to the base station over a first AIoT link (which may be referred to as an AIoT link). For example, the base station and the AIoT device each may include an AIoT PHY protocol layer and a MAC protocol layer. Optionally, the base station and the AIoT device each may include at least one of an AIoT RLC protocol layer, a PDCP protocol layer, an RRC protocol layer, or a NAS protocol layer.

In this embodiment, for a user plane protocol stack, based on the foregoing control plane protocol stack, the NAS is removed and the RRC is replaced with an SDAP.

The control plane protocol stack and/or the user plane protocol stack may include at least one of the following:
protocol layers of the UE and the AIoT device are peer layers;
3GPP air interface transmission is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

Optionally, in this embodiment, for that the UE assists in downlink transmission of the Ambient IoT data, reference may be made to Embodiment 1. Details are not described herein again.

The following uses three examples to provide an example description of the technical solution provided in Embodiment 5.

### Example I

In this example, both the UE and the AIoT device include a NAS layer, and the UE NAS assists the AIoT NAS in transmission with an AMF.

The following uses three examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

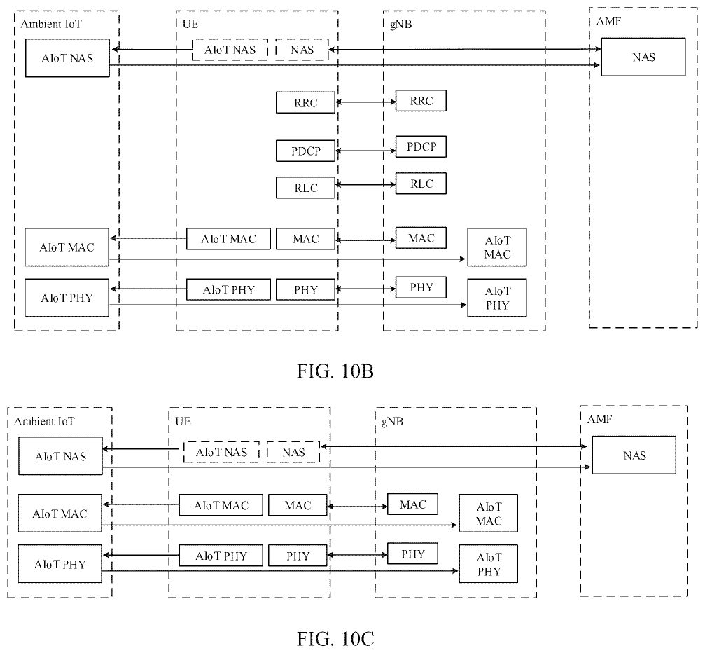

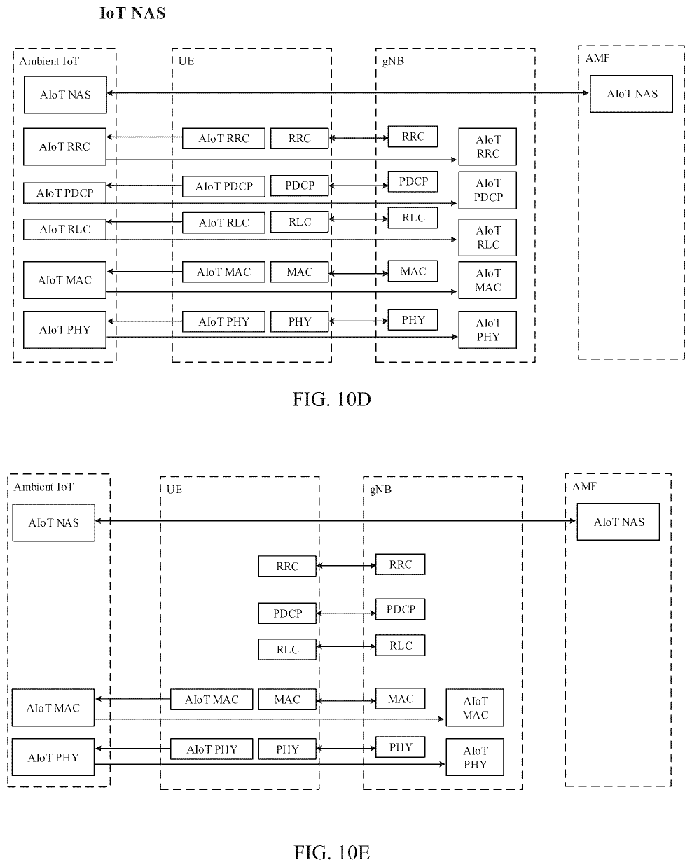

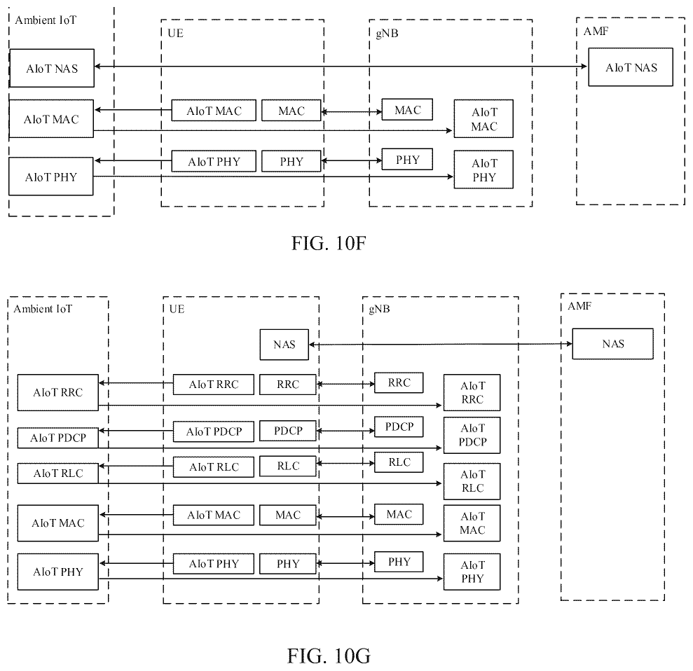

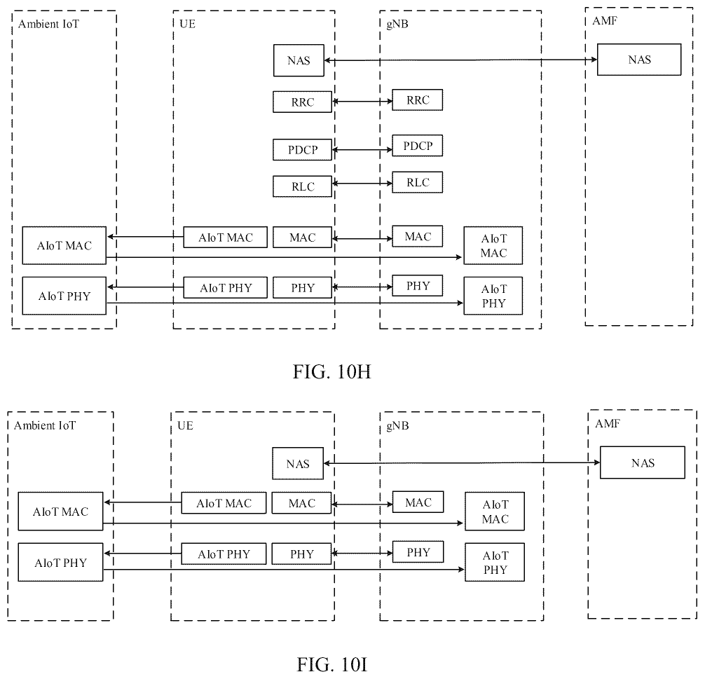

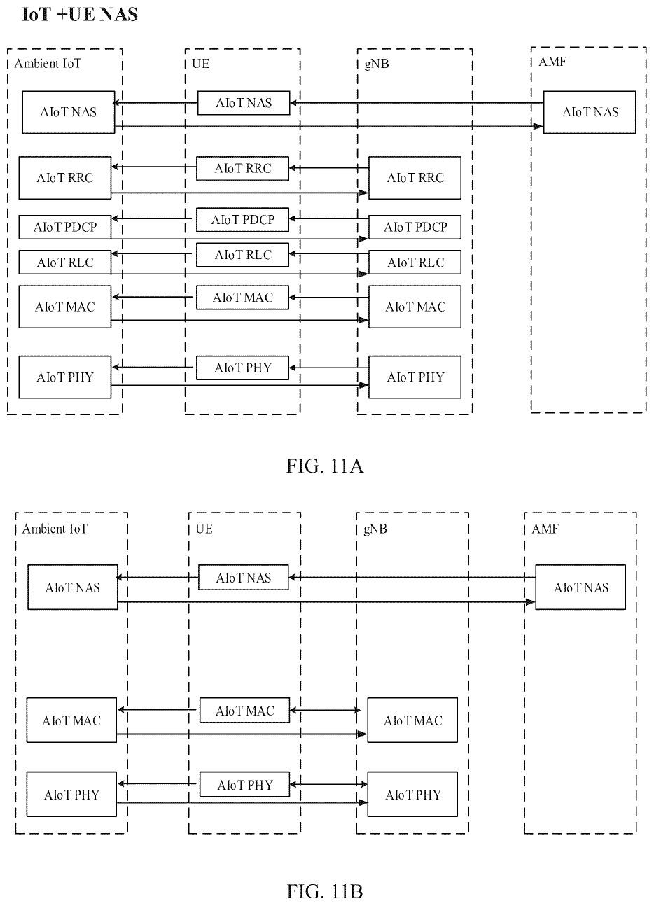

It should be noted that a protocol stack architecture applied to Example 1 may be represented as: AIoT device (L1/L2/L3/NAS)+UE (L1/L2/L3/NAS)+gNB (L1/L2/L3)+CN. In this example, the control plane protocol stack is shown in FIG. 10A. For example, the UE may include an AIoT PHY, an AIoT MAC, an AIoT NAS, a PHY, a MAC, an RLC, a PDCP, an RRC, and a NAS. Optionally, the UE may include an AIoT RLC, an AIoT PDCP, an AIoT RRC, an AIoT SDAP, and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC. The core network device includes a NAS.

In this example, sublayers (the AIoT PHY, the AIoT MAC, the AIoT RLC, the AIoT PDCP, the AIoT RRC, and/or the AIoT SDAP) of the base station, the UE, and the AIoT device are peer layers, and AIoT NAS sublayers of the core network device, the AIoT device, and the UE are peer layers.

In this example, data transmission of the AIoT device is the same as that in Example I in Embodiment 1, and details are not described herein again.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 2 may be represented as: AIoT device (PHY/MAC/NAS)+UE (L1/L2/L3/NAS)+gNB (L1/L2/L3)+CN.

In this example, the control plane protocol stack is shown in in FIG. 10B. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include a NAS.

In this example, for data transmission of the AIoT device, reference may be made to Example I in Embodiment 1. Details are not described herein again.

### Example 3

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 3 may be represented as: AIoT device (PHY/MAC/NAS)+UE (PHY/MAC/NAS)+gNB (PHY/MAC)+CN.

In this example, the control plane protocol stack is shown in FIG. 10C. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include an AIoT NAS.

In this example, sublayers (the AIoT PHY and the MAC) of the base station, the UE, and the AIoT device are peer layers, and AIoT NAS sublayers of the core network device, the AIoT device, and the UE are peer layers.

In this example, for Ambient IoT data transmission of the AIoT device, reference may be made to Example I in Embodiment 1. Details are not described herein again.

### Example II

In this example, the AIoT device includes a NAS layer, the UE does not include a NAS layer, and the UE assists in transmission at an L1/L2/L3.

The following uses three examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 10D. For example, the UE may include an AIoT PHY, an AIoT MAC, an AIoT RLC, an AIoT PDCP, an AIoT RRC, a PHY, a MAC, an RLC, and a PDCP. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC.

In this example, sublayers (the PHY, the MAC, the RLC, the PDCP, the RRC, and/or the SDAP) of the base station, the UE, and the AIoT device are peer layers. NAS sublayers of the core network and the AIoT device are peer layers.

For details of the UE assisting in uplink transmission of the Ambient IoT data, reference may be made to Embodiment 1. Details are not described herein again.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC/NAS)+UE (L1/L2/L3)+gNB (L1/L2/L3)+CN.

In this example, the control plane protocol stack is shown in FIG. 10E. For example, the UE may include an AIoT PHY and an AIoT MAC. Optionally, the UE may include an RLC, a PDCP, an RRC, and an SDAP. The AIoT device may include an AIoT PHY, an AIoT MAC, and an AIoT NAS. The base station may include an AIoT PHY and an AIoT MAC. Optionally, the base station may include an RLC, a PDCP, an RRC, and an SDAP.

In this example, sublayers (such as the AIoT PHY and the MAC) of the UE and the AIoT device are peer layers; RLCs, PDCPs, RRCs, and/or SDAPs of the base station and the UE are peer layers; and NAS sublayers of the core network device and the AIoT device are peer layers.

### Example 3

In this example, the UE and the AIoT device perform Ambient IoT data transmission by using a PHY/MAC/NAS protocol layer, the UE and the base station perform Ambient IoT data transmission by using the PHY/MAC protocol layer, and the UE and the core network perform data transmission by using the NAS layer.

It should be noted that a protocol stack architecture applied to Example 3 may be represented as: AIoT device (PHY/MAC/NAS)+UE (PHY/MAC)+gNB (PHY/MAC)+CN.

In this example, the control plane protocol stack is shown in FIG. 10F. For example, the UE may include an AIoT PHY, an AIoT MAC, a PHY, and a MAC. The AIoT device may include an AIoT PHY, an AIoT MAC, and an AIoT NAS. The base station may include a PHY and a MAC.

In this example, sublayers (the AIoT PHY and the MAC) of the UE and the AIoT device are peer layers, and NAS sublayers of the core network device, the AIoT device, and the UE are peer layers.

In this example, for uplink transmission of the Ambient IoT data, reference may be made to Embodiment 1. Details are not described herein again.

### Example III

In this example, the AIoT device does not include a NAS layer, the UE includes a NAS layer, and the UE assists in transmission at an L1/L2/L3/NAS.

The following uses three examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and the core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in FIG. 10G. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, an AIoT RLC, an AIoT PDCP, and an AIoT RRC. Optionally, the AIoT device may include an AIoT SDAP. The base station may include an AIoT PHY, an AIoT MAC, an AIoT RLC, an AIoT PDCP, and an AIoT RRC.

In this example, sublayers (the AIoT PHY, the MAC, the RLC, the PDCP, the RRC, and/or the SDAP) of the UE and the AIoT device are peer layers, and NAS sublayers of the core network device and the UE are peer layers.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in FIG. 10H. For example, the UE may include a PHY, a MAC, an RLC, a PDCP, an RRC, and a NAS. Optionally, the UE may include an SDAP. The AIoT device may include an AIoT PHY and an AIoT MAC. The base station may include a PHY, a MAC, an RLC, a PDCP, and an RRC.

In this example, sublayers (such as the PHY and the MAC) of the UE and the AIoT device are peer layers; RLCs, PDCPs, RRCs, and/or SDAPs of the base station and the UE are peer layer; and NAS sublayers of the core network device and the AIoT device are peer layers.

In this example, after receiving uplink data of the AIoT device, the UE performs buffer processing, segmentation and reassembly, and/or retransmission by using the MAC, the RLC, the PDCP, the SDAP, and/or the RRC, and then sends processed uplink data to the gNB by using a control plane or a user plane. This method reduces an error rate of data transmission and improves robustness.

### Example 3

In this example, the UE and the AIoT device perform Ambient IoT data transmission by using a PHY/MAC protocol layer, the UE and the base station perform Ambient IoT data transmission by using the PHY/MAC protocol layer, and the UE and a core network perform data transmission by using a NAS layer.

It should be noted that a protocol stack architecture applied to Example 3 may be represented as: AIoT device (PHY/MAC)+UE (PHY/MAC/NAS)+gNB (PHY/MAC)+CN.

In this example, the control plane protocol stack is shown in FIG. 10I. For example, the protocol stack is the same as the protocol stack in Example 3 in Example III in Embodiment 1, and details are not described herein again.

In this example, for an uplink data transmission method, reference may be made to the method in Example 3 in Example III in Embodiment 1. Details are not described herein again.

### Embodiment 6

In this embodiment, the UE assists in downlink transmission of AIoT data, a core network device participates in the downlink transmission, and a relay manner of the UE is a BSC relay. The UE performs AIoT data transmission with a base station over a first AIoT link, and the UE performs data transmission with an AIoT device over a second AIoT link.

The AIoT link can use a BSC access technology for communication.

In this embodiment, the foregoing AIoT data transmission may include at least one of the following:
the gNB sends data to the AIoT device over a BSC forward link; and the AIoT device sends a response through backscattering;
the UE monitors response data sent by the AIoT device; or
the UE sends, to the base station through backscattering, the received response data sent by the AIoT device. For example, the UE serves as a relay, a forwarder (repeater), or another auxiliary device (helper) to transmit data by reflecting a signal sent by a gNB.

In this embodiment, for a control plane protocol stack:

For a downlink direction of the AIoT data, the downlink direction is the base station→the UE→the AIoT device. In this case, the base station may send the AIoT data UE over the first AIoT link, and the UE sends the AIoT data to the AIoT device over the second AIoT link. For example, the UE and the AIoT device each may include a PHY protocol layer and a MAC protocol layer. Optionally, the UE and the AIoT device each may include at least one of an AIoT RLC protocol layer, a PDCP protocol layer, an RRC protocol layer, or a NAS protocol layer.

For an uplink direction of the AIoT data, the uplink direction is the AIoT device→the base station. In this case, the AIoT device may backscatter the AIoT data to the base station over the AIoT link. For example, the base station and the AIoT device each may include an AIoT PHY protocol layer and a MAC protocol layer. Optionally, the base station and the AIoT device each may include at least one of an AIoT RLC protocol layer, a PDCP protocol layer, an RRC protocol layer, or a NAS protocol layer.

In this embodiment, for a user plane protocol stack, based on the foregoing control plane protocol stack, the NAS is removed and the RRC is replaced with an SDAP.

The control plane protocol stack and/or the user plane protocol stack may include at least one of the following:
protocol layers of the UE and the AIoT device are peer layers;
backscatter communication is performed between the UE and the base station; or
backscatter communication is performed between the UE and the AIoT device.

For example, the UE may serve as a Reader to send data to the AIoT device by transmitting a radio wave, and the AIoT device sends the data to the UE through backscattering.

In this way, the UE may forward uplink and downlink data of the AIoT device to the base station, so that a coverage area of the AIoT device can be enlarged, and interference to an AIoT link system can be reduced.

The following uses three examples to provide an example description of the technical solution provided in Embodiment 6.

### Example I

In this example, both the UE and the AIoT device include a NAS layer, and the UE NAS assists the AIoT NAS in transmission with an AMF.

The following uses two examples to provide an example description of the technical solution provided in Example I.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3/NAS)+gNB (L1/L2/L3)+CN.

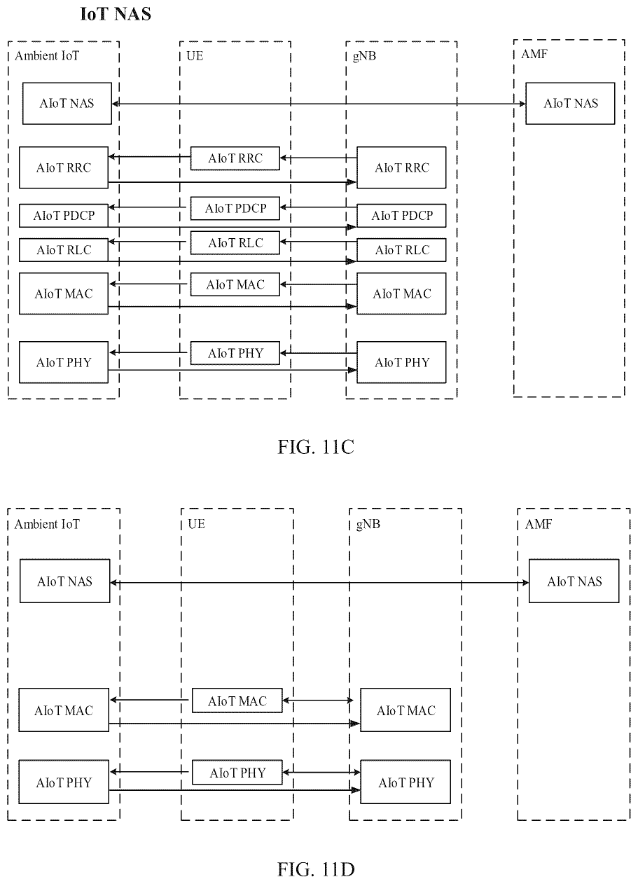

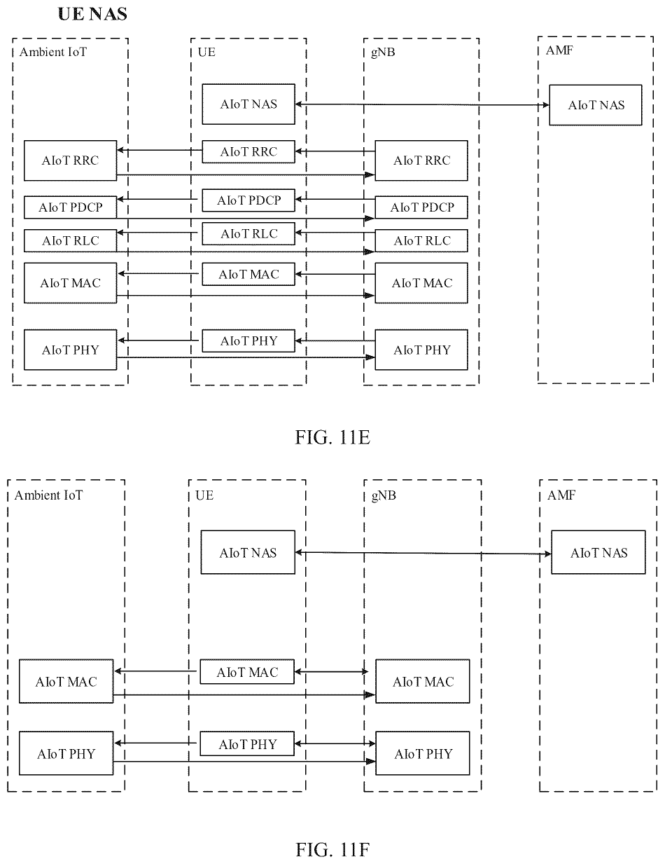

In this example, the control plane protocol stack is shown in FIG. 11A. For example, the UE may include an AIoT PHY, an AIoT MAC, an AIoT RLC, an AIoT PDCP, an AIoT RRC, and an AIoT NAS. Optionally, the UE may include an AIoT SDAP and an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, and an AIoT RRC.

In this example, sublayers (the AIoT PHY, the AIoT MAC, the AIoT RLC, the AIoT PDCP, the AIoT RRC, and/or the AIoT SDAP) of the base station, the UE, and the AIoT device are peer layers.

In this example, AIoT NAS sublayers of the core network, the AIoT device, and the UE are layers.

In this example, for data transmission of the AIoT device, reference may be made to Example 1 in Example I in Embodiment 2. Details are not described herein again.

### Example 2

In this example, the UE and the AIoT device perform Ambient IoT data transmission by using a PHY/MAC/NAS protocol layer, the UE and the base station perform Ambient IoT data transmission by using an L1/L2/L3, and the UE and the core network perform data transmission by using the NAS layer.

It should be noted that a protocol stack architecture applied to Example 2 may be represented as: AIoT device (PHY/MAC/NAS)+UE (PHY/MAC/NAS)+gNB (PHY/MAC)+CN.

In this example, the control plane protocol stack is shown in FIG. 11B. For example, the UE may include an AIoT PHY, an AIoT MAC, and an AIoT NAS. Optionally, the UE may include an AIoT SDAP. The AIoT device may include an AIoT PHY, an AIoT MAC, and an AIoT NAS. The base station may include an AIoT PHY and an AIoT MAC. The core network device may include an AIoT NAS.

In this example, sublayers (the AIoT PHY and the MAC) of the base station, the UE, and the AIoT device are peer layers, and AIoT NAS sublayers of the core network device, the AIoT device, and the UE are peer layers.

In this example, for Ambient IoT data transmission of the AIoT device, reference may be made to Embodiment 1. Details are not described herein again.

### Example II

In this example, the AIoT device includes a NAS layer, the UE does not include a NAS layer, and the UE assists in transmission at an L1/L2/L3.

The following uses two examples to provide an example description of the technical solution provided in Example II.

### Example 1

In this example, the UE and the AIoT device perform Ambient IoT data transmission by using an L1/L2/L3/NAS protocol layer, the UE and the base station perform Ambient IoT data transmission by using the L1/L2/L3, and the UE and the core network perform data transmission by using the NAS layer.

It should be noted that a protocol stack architecture applied to Example 1 may be represented as: AIoT device (L1/L2/L3/NAS)+UE (L1/L2/L3)+gNB (L1/L2/L3)+CN.

In this example, the control plane protocol stack is shown in FIG. 11C. For example, the UE may include an AIoT PHY, an AIoT MAC, an AIoT RLC, an AIoT PDCP, and an AIoT RRC. Optionally, the UE may include an SDAP. The AIoT device may include an AIoT PHY, an AIoT MAC, an AIoT RLC, an AIoT PDCP, an AIoT RRC, and an AIoT NAS. The base station may include an AIoT PHY, an AIoT MAC, an AIoT RLC, an AIoT PDCP, an AIoT RRC, a PHY, a MAC, an RLC, a PDCP, and an RRC.

In this example, sublayers (the PHY, the MAC, the RLC, the PDCP, the RRC, and/or the SDAP) of the base station, the UE, and the AIoT device are peer layers. NAS sublayers of the core network and the AIoT device are peer layers.

For details of the UE assisting in uplink transmission of the Ambient IoT data, reference may be made to Example II in Embodiment 2. Details are not described herein again.

### Example 2

In this example, the UE and the AIoT device perform Ambient IoT data transmission by using a PHY/MAC/NAS protocol layer, the UE and the base station perform Ambient IoT data transmission by using the PHY/MAC protocol layer, and the UE and the core network perform data transmission by using the NAS layer.

It should be noted that a protocol stack architecture applied to Example 2 may be represented as: AIoT device (PHY/MAC/NAS)+UE (PHY/MAC)+gNB (PHY/MAC)+CN.

In this example, the control plane protocol stack is shown in FIG. 11D. For example, the UE may include an AIoT PHY, an AIoT MAC, a PHY, and a MAC. The AIoT device may include an AIoT PHY, an AIoT MAC, and an AIoT NAS. The base station may include an AIoT PHY and an AIoT MAC.

In this example, sublayers (the AIoT PHY and the MAC) of the UE and the AIoT device are peer layers, and NAS sublayers of the core network device, the AIoT device, and the UE are peer layers.

In this example, for uplink transmission of the Ambient IoT data, reference may be made to Example II in Embodiment 2. Details are not described herein again.

### Example III

In this example, the AIoT device does not include a NAS layer, the UE includes a NAS layer, and the UE assists in transmission at an L1/L2/L3/NAS.

The following uses two examples to provide an example description of the technical solution provided in Example III.

### Example 1

In this example, the UE and the AIoT device perform Ambient IoT data transmission by using an L1/L2/L3 protocol layer, the UE and the base station perform Ambient IoT data transmission by using the L1/L2/L3, and the UE and the core network perform data transmission by using a NAS layer.

It should be noted that a protocol stack architecture applied to Example 1 may be represented as: AIoT device (L1/L2/L3)+UE (L1/L2/L3/NAS)+gNB (L1/L2/L3)+CN.

In this example, the control plane protocol stack is shown in FIG. 11E. For example, the UE may include an AIoT PHY, an AIoT MAC, an AIoT RLC, an AIoT PDCP, an AIoT RRC, and an AIoT NAS. Optionally, the UE may include an AIoT SDAP. The AIoT device may include an AIoT PHY, an AIoT MAC, an AIoT RLC, an AIoT PDCP, and an AIoT RRC. Optionally, the AIoT device may include an AIoT SDAP. The base station may include an AIoT PHY, an AIoT MAC, an AIoT RLC, an AIoT PDCP, and an AIoT RRC.

In this example, sublayers (the AIoT PHY, the MAC, the RLC, the PDCP, the RRC, and/or the SDAP) of the UE and the AIoT device are peer layers, and NAS sublayers of the core network device and the UE are peer layers.

### Example 2

In this example, the UE and the AIoT device perform Ambient IoT data transmission by using a PHY/MAC protocol layer, the UE and the base station perform Ambient IoT data transmission by using an L1/L2/L3, and the UE and the core network perform data transmission by using a NAS layer.

It should be noted that a protocol stack architecture applied to Example 2 may be represented as: AIoT device (PHY/MAC)+UE (L1/L2/L3/NAS)+gNB (L1/L2/L3)+CN.

In this example, the control plane protocol stack is shown in FIG. 11F. For example, the UE may include an AIoT PHY, an AIoT MAC, and an AIoT NAS. Optionally, the UE may include an AIoT SDAP. The AIoT device may include an AIoT PHY and an AIoT MAC. The base station may include an AIoT PHY and AIoT MAC.

It should be noted that, for an uplink data transmission method, reference may be made to the method in Example III IN Embodiment 2. Details are not described herein again.

It should be noted that, in the foregoing embodiments of this application, the AIoT PHY may be a BSC PHY, the AIoT MAC may be a BSC PHY, the AIoT RLC may be a BSC RLC, the AIoT PDCP may be a BSC PDCP, the AIoT RRC may be a BSC RRC, the AIoT NAS may be a BSC NAS, and the AIoT SDAP may be a BSC SDAP.

With reference to the foregoing embodiments, an embodiment of this application provides a user plane protocol stack.

In some possible embodiments, the user plane protocol stack includes a PHY and a MAC. Optionally, the user plane protocol stack may include sublayers such as an SDAP, a PDCP, and an RLC.

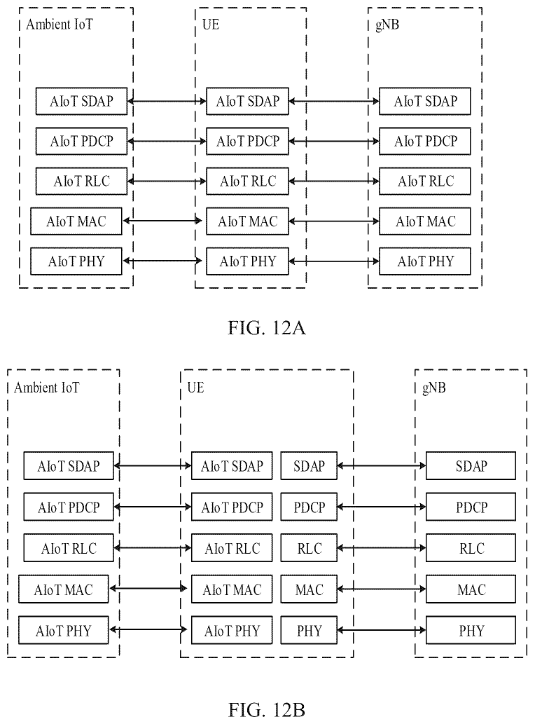

In some examples, the user plane protocol stack is shown in FIG. 12A. For example, the UE may include an AIoT PHY, an AIoT MAC, an AIoT RLC, an AIoT PDCP, and an AIoT SDAP. The AIoT device may include an AIoT PHY, an AIoT MAC, an AIoT RLC, an AIoT PDCP, and an AIoT SDAP. The base station may include a PHY, a MAC, an RLC, a PDCP, and an SDAP.

In some examples, the user plane protocol stack is shown in FIG. 12B. For example, the UE may include an AIoT PHY, an AIoT MAC, an AIoT RLC, an AIoT PDCP, an AIoT SDAP, a PHY, a MAC, an RLC, a PDCP, and an SDAP. The AIoT device may include an AIoT PHY, an AIoT MAC, an AIoT RLC, an AIoT PDCP, and an AIoT SDAP. The base station may include a PHY, a MAC, an RLC, a PDCP, and an SDAP.

In this embodiment of this application, the protocol stack in the protocol stack architecture mentioned above may include a plurality of protocol layers and function division, which may include at least one of the following:
In a possible embodiment, the protocol stack includes an AIoT PHY protocol layer, an AIoT MAC protocol layer, an AIoT RLC protocol layer, an AIoT PDCP protocol layer, an AIoT RRC protocol layer, and/or an AIoT SDAP protocol layer.

The AIoT PHY may configured to perform a first function.

The AIoT MAC may be configured to perform a second function.

The AIoT RLC may be configured to perform a third function.

The AIoT PDCP may be configured to perform a fourth function.

The AIoT RRC may be configured to perform a fifth function and/or a sixth function.

The AIoT SDAP may be configured to perform a seventh function.

In a possible embodiment, the protocol stack includes an AIoT PHY and an AIoT MAC. The plurality of sublayers and function division are as follows:

The AIoT PHY may configured to perform a first function.

The AIoT MAC may be configured to perform at least one of the following:
a second function;
a third function;
a fourth function;
a fifth function;
a sixth function; or
a seventh function.

In this way, the AIoT MAC protocol layer implements a process related to an Ambient IoT, without a complex access layer process, so that costs of an AIoT device are reduced.

Optionally, in this embodiment of this application, the first function includes at least one of the following:
(1) determining a waveform of a backscatter communication-based on AIoT;
(2) performing AIoT numerology, for example, an AIoT frequency and a bandwidth; and defining a frequency domain resource for AIoT communication;
(3) determining an AIoT frame structure, for example, a system frame, a subframe, and a timeslot; and defining a time domain resource for AIoT communication;
(4) determining an AIoT downlink transmission scheme, where for example, a Reader sends a preamble, data, a synchronization signal, and/or the like;
(5) determining an uplink reflection scheme (Uplink transmission scheme) for a backscatter communication-based AIoT, where for example, an interval between uplink reflection and downlink transmission meets a predefined link timing relationship, which helps maintain an AIoT link;
(6) determining an intermittent communication scheme, where different from a conventional continuous communication scheme, the intermittent communication scheme provides energy harvesting time of an AIoT device, so that the AIoT device supports communication for a period of time after storing sufficient energy;
(7) determining an energy harvesting scheme, where for example, energy is harvested from a radio wave transmitted by a Reader, or a radio wave transmitted by a device controlled by the Reader, or another energy source; and if energy harvesting is performed based on the radio wave transmitted by the Reader, the Reader needs to control, during AIoT data transmission, radio wave transmission used for energy harvesting;
(8) performing first random access based on intermittent communication, energy harvesting, or an AIoT, where for example, if an AIoT device does not support a conventional continuous communication operation, the first random access process supports intermittent communication; and, in a first random access process, a type or a capability of the AIoT device is identified in advance, which helps use the first random process;
(9) determining one or more physical channels of an AIoT, including at least one of a control channel, a shared channel, or a synchronization channel;
(10) determining first Synchronization signals, which may be used for one or more AIoT synchronization signals or for synchronization with a network before an AIoT device actively initiates uplink transmission;
(11) performing a physical layer process (Physical layer procedures):
(a) measuring, by an AIoT device, a downlink AIoT signal, including an AIoT control channel signal used to transmit a command and a synchronization signal;
(b) measuring, by a Reader, an AIoT reflected signal of the AIoT device;
(c) performing AIoT link adaptation (Link adaptation), including: returning, by the AIoT device, an estimated channel state to the Reader; and selecting, by the Reader, an appropriate AIoT modulation scheme and/or channel code from a plurality of AIoT modulation schemes and/or AIoT channel codes; and
(d) performing first power control, including: controlling, by a network, transmit power of a downlink AIoT signal, and controlling power of an AIoT reflected signal;
(12) determining a downlink AIoT transmission channel, where different downlink AIoT transmission is distinguished, for example, an AIoT broadcast channel is used to transmit AIoT system information, a downlink AIoT shared channel is used to transmit AIoT downlink data, and a downlink AIoT control channel is used to transmit an AIoT command; or
(13) determining an uplink AIoT transmission channel, where different uplink AIoT transmission is distinguished, for example, an AIoT random access channel is used by an AIoT terminal to perform random access, an uplink AIoT shared channel is used to transmit AIoT uplink data, and an uplink AIoT control channel is used to transmit a response of an AIoT command.

Optionally, in this embodiment of this application, the second function includes at least one of the following:
(1) transmitting Ambient IoT service data, where an Ambient IoT service data packet is transmitted by using a MAC SDU or a MAC command, the Ambient IoT service data packet includes the Ambient IoT service data, such as an AIoT device identifier and application data;
(2) managing an IoT status, including at least one of the following:
   an energy storage state, where in this state, an AIoT device performs energy harvesting, and may communicate with a network, or may communicate with a network after energy storage reaches a specific threshold;
   an idle state;
   an inventory process state, such as Ready, Arbitrate, Reply, Acknowledged, Open, Secured, or Killed; or
   an activated state and a deactivated state, where a network may control an AIoT device to transit from the active state to the deactivated state, or vice versa; when the AIoT device is in the activated state, the AIoT device participates in an inventory process, a read/write access process, and the like; and when the AIoT device is in the deactivated state, the AIoT device does not participate in an inventory process, a read/write access process, and the like;
(3) mapping an AIoT logical channel and an AIoT transmission channel, where
the AIoT logical channel includes an AIoT common control channel, an AIoT broadcast control channel, an AIoT dedicated control channel, and/or the like;
   the AIoT broadcast control channel is used to broadcast AIoT system information, for example, second information used for an Ambient IoT to help an AIoT device to select a network and/or access a network, where the second information includes at least one of the following:
network identification information (a Cell ID or a PLMN ID);
network capability information (whether one or more Ambient IoT services can be supported);
AIoT cell selection information;
AIoT frequency information;
AIoT measurement control information; or
AIoT random access information;
the AIoT common control channel is used to send control information between an IoT and a network, for example, control information used in a service process such as asset identification and inventory;
the AIoT dedicated control channel is used to send point-to-point dedicated control information between an IoT and a network, for example, a control command and a response in a read/write access process of the IoT;
the AIoT dedicated transmission channel is used to transmit Ambient IoT user information or service information; and
optionally, the mapping between the AIoT logical channel and the AIoT transmission channel includes at least one of the following:
mapping the AIoT broadcast control channel to an AIoT broadcast channel or a downlink AIoT shared channel;
mapping the AIoT common control channel to a downlink AIoT shared channel, which is applicable to uplink and downlink; or
mapping the AIoT dedicated control channel to a downlink AIoT shared channel, which is applicable to uplink and downlink;
(4) processing an AIoT transport block obtained from a physical layer AIoT transport channel, and demultiplexing (demultiplex) the AIoT transport block to different AIoT logical channels;
(5) processing SDUs of different AIoT logical channels, and multiplexing the SDUs to an AIoT transport block, and submitting the SDUs to a physical layer AIoT transport channel;
(6) reporting scheduling information, where for example, an AIoT uplink message includes the scheduling information, and the scheduling information includes an AIoT scheduling request, an AIoT acknowledgment, and the like, for example, the AIoT scheduling request includes uplink access initiated by an AIoT device;
(7) performing MAC Reset or reconstruction, for example, initializing or reconfiguring or releasing a MAC entity, and performing MAC reconstruction after occurrence of a MAC error;
(8) processing a MAC error of an AIoT transmission protocol.

Optionally, in this embodiment of this application, the third function includes at least one of the following:
(1) transmitting higher-layer Ambient IoT service data, where an Ambient IoT service data packet is transmitted by using RLC, the Ambient IoT service data packet includes the Ambient IoT service data, such as an AIoT device identifier and application data;
(2) determining a sequence number of a data packet, where optionally, the sequence number of the data packet is independent of a PDCP sequence number;
(3) determining an AIoT transmission mode, including at least one of the following:
   an acknowledged mode (AM), where for example, after sending a data packet, an AIoT device monitors acknowledgement information returned by a bottom layer, including an acknowledgement ack or a negative acknowledgement nack; and in an implementation method, the AIoT device determines, based on the acknowledgement information, whether to resend a data packet, such as a network request or UE being allowed to send a data packet, and the UE sends a data packet 1 in an AIoT response message; the UE receives an acknowledgement 1 sent by the network, and the UE continues to send a next data packet 2 in a response message; and if an acknowledgement message sent by the network and received by the UE is a NACK, the UE resends the data packet 1 in a response message;
   an unacknowledged mode (UM), where for example, after sending a data packet, an AIoT device does not need to monitor acknowledgement information sent by a network; or
   a transparent transmission mode (TM)
(4) performing error correction, for example, performing error correction through retransmission;
(5) performing RLC SDU segmentation and reassembly, where for example, in an IoT data packet, an AIoT device ID is usually a small data packet, and does not needs to be segmented and reassembled; and for IoT service data, such as sensing data, a data packet of an appropriated size may be constructed through segmentation and reassembly, thereby improving transmission efficiency;
(6) performing RLC re-establishment; or
(7) processing an RLC error of an AIoT transmission protocol.

Optionally, in this embodiment of this application, the fourth function includes at least one of the following:
(1) performing AIoT user plane data transmission;
(2) maintaining a sequence number of an Ambient IoT service data packet;
(3) generating and decoding an AIoT data packet header;
(4) performing AIoT encryption and decryption, for example, used for IoT security communication;
(5) performing integrity protection and integrity verification;
(6) performing reordering and in-order delivery of an AIoT data packet; or
(7) performing out-of-order delivery.

Optionally, in this embodiment of this application, the fifth function includes at least one of the following:
(1) transmitting higher-layer Ambient IoT service data, where an Ambient IoT service data packet is transmitted by using an RRC, the Ambient IoT service data packet includes the Ambient IoT service data, such as an AIoT device identifier and application data;
(2) managing an IoT status;
(3) broadcasting an AIoT system message broadcast, where for example, after an IoT receives broadcast of the AIoT system message, if the cell allows the IoT to access and a cell selection condition such as an S criterion (S>0) is met, or measurement of a serving cell is higher than a specific threshold, the IoT camps on the cell;
(4) performing an IoT asset identification or inventory process initiated by a network;
(5) performing an access process initiated by an IoT, where for example, when a reporting requirement is triggered, an AIoT device that has a capability of initiating uplink access may initiate a random access process to report service data triggered by an event;
(6) establishing an RRC connection or secure communication between an AIoT and a Reader;
(7) performing security functions such as key management and password management;
(8) performing mobility management, including handover, context transmission, and IoT cell selection and reselection;
(9) performing IoT measurement configuration and measurement reporting; or
(10) failing in execution of an IoT wireless link.

Optionally, in this embodiment of this application, the sixth function includes at least one of the following:
(1) transmitting higher-layer Ambient IoT service data, where an Ambient IoT service data packet is transmitted by using a NAS, the Ambient IoT service data packet includes the Ambient IoT service data, such as an AIoT device identifier and application data;
(2) performing IoT registration and registration update, which means that an AIoT device registers with an AMF, so that the AMF indicates a gNB to perform an inventory processing, a read/write access process, or another process for the AIoT device;
(3) managing a location, that is, an AIoT device periodically reports a location of the AIoT device to a network, or reports a location to the network after the location changes; or the location of the AIoT device may be obtained through network trigger; or
(4) managing an IoT status, for example, activation or deactivation of an Ambient IoT service, where an AMF controls an activated state or a deactivated state of an AIoT device; the AIoT device participates in an inventory process, a read/write access process, or another process in the activated state; and the AIoT device does not participate in an inventory process, a read/write access process, or another process in the deactivated state, so that whether the AIoT device participates in an inventory process, a read/write access process, or another process can be controlled, to manage a quantity of AIoT devices in an Ambient IoT service process.

Optionally, in this embodiment of this application, the seventh function includes at least one of the following:
(1) Mapping an IoT QoS flow and an AIoT data radio bearer; or
(2) determining QoS flow identifiers of uplink and downlink AIoT data packets.

The data transmission method provided in the embodiments of this application may be performed by a data transmission apparatus. In the embodiments of this application, the data transmission apparatus provided in the embodiments of this application is described by using an example in which the data transmission apparatus performs the data transmission method.

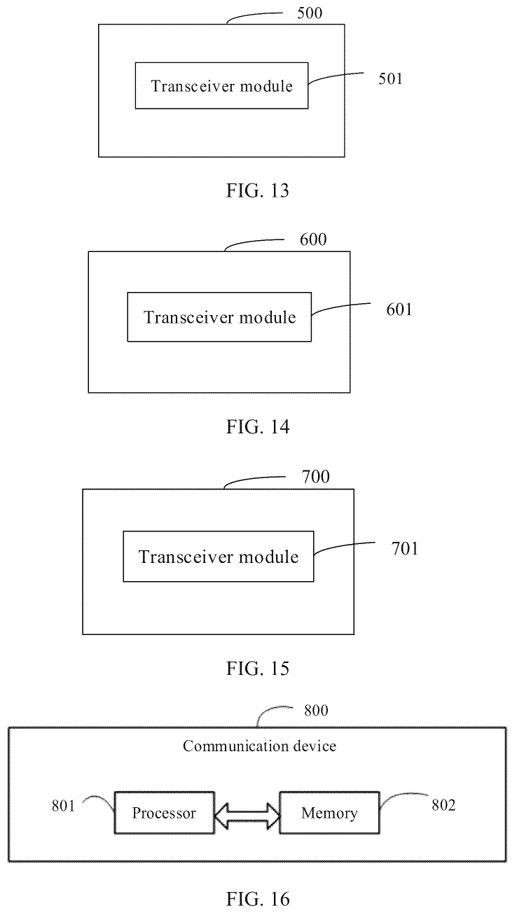

FIG. 13 is a schematic diagram of a data transmission apparatus according to an embodiment of this application, and the data transmission apparatus may be applied to UE. As shown in FIG. 13, the apparatus includes a transceiver module 501.

The transceiver module 501 is configured to perform at least one of the following in an ambient Internet of Things AIoT protocol stack architecture:
receiving, over a 3GPP air interface or a first AIoT link, AIoT data sent by a network side device;
sending the AIoT data to the network side device over the 3GPP air interface or the first AIoT link;
sending the AIoT data to an AIoT device over a second AIoT link; or
receiving, over the second AIoT link, the AIoT data sent by the AIoT device.

The network side device includes a base station and a core network device, and the AIoT data includes AIoT signaling and service-related data.

Optionally, in this embodiment of this application, the AIoT protocol stack architecture includes a control plane protocol stack, or includes the control plane protocol stack and a user plane protocol stack.

The UE includes a PHY protocol layer and a MAC protocol layer; the PHY protocol layer, the MAC protocol layer, and a NAS protocol layer; an AIoT PHY protocol layer and an AIoT MAC protocol layer; the AIoT PHY protocol layer, the AIoT MAC protocol layer, and an AIoT NAS protocol layer; or the PHY protocol layer, the MAC protocol layer, the NAS protocol layer, the AIoT PHY protocol layer, the AIoT MAC protocol layer, and the AIoT NAS protocol layer.

Optionally, in this embodiment of this application, a protocol stack of the UE further includes at least one of an RLC protocol layer, a PDCP protocol layer, an RRC protocol layer, or an SDAP protocol layer; or at least one of an AIoT RLC protocol layer, an AIoT PDCP protocol layer, an AIoT RRC protocol layer, or an AIoT SDAP protocol layer.

Optionally, in this embodiment of this application, the transceiver module is configured to send the AIoT data to the base station over the 3GPP air interface at the MAC protocol layer, the RLC protocol layer, the PDCP protocol layer, the RRC protocol layer, or the SDAP protocol layer.

The transceiver module is configured to receive, over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

Optionally, in this embodiment of this application, the transceiver module is configured to receive, over the 3GPP air interface at the MAC protocol layer, the RLC protocol layer, the PDCP protocol layer, the RRC protocol layer, or the SDAP protocol layer, the AIoT data sent by the base station.

The transceiver module is configured to send the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the transceiver module is configured to send the AIoT data to the base station over the first AIoT link at the AIoT RRC protocol layer, the AIoT SDAP protocol layer, the AIoT RLC protocol layer, the AIoT PDCP protocol layer, or the AIoT MAC protocol layer.

The transceiver module is configured to transmit the AIoT data with the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the transceiver module is configured to receive, over the first AIoT link at the AIoT RRC protocol layer, the AIoT SDAP protocol layer, the AIoT RLC protocol layer, the AIoT PDCP protocol layer, or the AIoT MAC protocol layer, the AIoT data sent by the base station.

The transceiver module is configured to send the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the transceiver module is configured to send the AIoT data to the core network device over the 3GPP air interface at the NAS protocol layer.

The receiving, over the second AIoT link, the AIoT data sent by the AIoT device includes:
receiving, over the second AIoT NAS link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

Optionally, in this embodiment of this application, the transceiver module is configured to send the AIoT data to the network side device over the first AIoT link at the AIoT NAS layer.

The transceiver module is configured to receive, over the second AIoT link at the AIoT MAC protocol layer, the AIoT RLC protocol layer, the AIoT PDCP protocol layer, the AIoT SDAP protocol layer, or the AIoT RRC protocol layer, the AIoT data sent by the AIoT device.

Optionally, in this embodiment of this application, the AIoT PHY is configured to perform a first function.

The AIoT MAC is configured to perform at least one of a second function, a third function, a fourth function, a fifth function, a sixth function, or a seventh function.

The AIoT RLC is configured to perform the third function.

The AIoT PDCP is configured to perform the fourth function.

The AIoT RRC is configured to perform at least one of the fifth function or the sixth function.

The AIoT SDAP is configured to perform the seventh function.

The AIoT NAS is configured to perform the sixth function.

The first function includes at least one of the following: determining a time domain resource or a frequency domain resource for AIoT communication, performing uplink AIoT transmission, or performing downlink AIoT transmission.

The second function includes at least one of the following: transmitting AIoT service data, managing an AIoT status, or mapping an AIoT transmission channel.

The third function includes at least one of the following: transmitting higher-layer AIoT service data, assigning a sequence number to a data packet, or defining an AIoT transmission mode.

The fourth function includes at least one of the following: transmitting AIoT control plane data, transmitting AIoT user plane data, or maintaining a sequence number of an AIoT service data packet.

The fifth function includes at least one of the following: transmitting higher-layer AIoT service data, managing an AIoT status, or broadcasting an AIoT system message.

The sixth function includes at least one of the following: transmitting higher-layer AIoT service data, performing AIoT registration and registration update, managing a location, or managing an AIoT status.

The seventh function includes at least one of the following: performing mapping between an AIoT QoS flow and an AIoT data radio bearer, or assigning QoS flow identifiers to uplink and downlink AIoT data packets.

According to the data transmission apparatus provided in this embodiment of this application, the data transmission apparatus performs at least one of the following in the ambient Internet of Things AIoT protocol stack architecture: receiving, over the 3GPP air interface or the first AIoT link, the AIoT data sent by the network side device; sending the AIoT data to the network side device over the 3GPP air interface or the first AIoT link; sending the AIoT data to the AIoT device over the second AIoT link; or receiving, over the second AIoT link, the AIoT data sent by the AIoT device. According to the method, the UE may assist in transmission of AIoT signaling and service-related data to implement a necessary AIoT data transmission function, thereby enlarge a coverage area of the AIoT architecture, and supporting large-scale cellular network deployment, a large quantity of AIoT devices, and seamless coverage.

FIG. 14 is a schematic diagram of a data transmission apparatus according to an embodiment of this application. As shown in FIG. 14, the data transmission apparatus may be applied to a network side device, and the apparatus includes a transceiver module 601. The transceiver module 601 is configured to perform at least one of the following in an ambient Internet of Things AIoT protocol stack architecture:
receiving, over a 3GPP air interface or a first AIoT link, AIoT data sent by UE;
sending the AIoT data to the UE over the 3GPP air interface or the first AIoT link;
sending the AIoT data to the AIoT device over a third AIoT link; or
receiving, over the third AIoT link, the AIoT data sent by the AIoT device.

The network side device may include a base station and a core network device, and the AIoT data includes AIoT signaling and service-related data.

Optionally, in this embodiment of this application, the AIoT protocol stack architecture includes a control plane protocol stack, or includes the control plane protocol stack and a user plane protocol stack.

The base station includes a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer.

The core network device includes a NAS protocol layer; an AIoT NAS protocol layer; or the NAS protocol layer and the AIoT NAS protocol layer.

Optionally, in this embodiment of this application, the base station further includes at least one of an RLC protocol layer, a PDCP protocol layer, an SDAP protocol layer, or an RRC protocol layer; or at least one of an AIoT RLC protocol layer, an AIoT PDCP protocol layer, an AIoT SDAP protocol layer, or an AIoT RRC protocol layer.

Optionally, in this embodiment of this application, the transceiver module is configured to send the AIoT data to the UE over the 3GPP air interface at the MAC protocol layer, the RLC protocol layer, the PDCP protocol layer, the RRC protocol layer, or the SDAP protocol layer.

Optionally, in this embodiment of this application, the transceiver module is configured to send the AIoT data to the UE over the first AIoT link at the AIoT RRC protocol layer, the AIoT SDAP protocol layer, the AIoT MAC protocol layer, the AIoT RLC protocol layer, or the AIoT PDCP protocol layer.

Optionally, in this embodiment of this application, the transceiver module is configured to receive, over the 3GPP air interface at the MAC protocol layer, the RLC protocol layer, the PDCP protocol layer, the RRC protocol layer, or the SDAP protocol layer, the AIoT data sent by the UE.

Optionally, in this embodiment of this application, the transceiver module is configured to receive, over the first AIoT link at the AIoT RRC protocol layer, the AIoT SDAP protocol layer, the AIoT MAC protocol layer, the AIoT RLC protocol layer, or the AIoT PDCP protocol layer, the AIoT data sent by the UE.

Optionally, in this embodiment of this application, the transceiver module is configured to send the AIoT data to the UE over the 3GPP air interface at the NAS protocol layer.

Optionally, in this embodiment of this application, the transceiver module is configured to send the AIoT data to the UE over the first AIoT link at the AIoT NAS layer.

Optionally, in this embodiment of this application, the transceiver module is configured to receive, over the 3GPP air interface at the MAC protocol layer, the RRC protocol layer, the RLC protocol layer, the PDCP protocol layer, or the SDAP protocol layer, the AIoT data sent by the UE.

The transceiver module is configured to send the AIoT data to the core network device.

Optionally, in this embodiment of this application, the transceiver module is configured to send the AIoT data to the AIoT device over the third AIoT link at the AIoT MAC protocol layer, the AIoT RRC protocol layer, the AIoT RLC protocol layer, the AIoT PDCP protocol layer, or the AIoT SDAP protocol layer.

Optionally, in this embodiment of this application, the transceiver module is configured to receive, over the third AIoT link at the AIoT MAC protocol layer, the AIoT RRC protocol layer, the AIoT RLC protocol layer, the AIoT PDCP protocol layer, or the AIoT SDAP protocol layer, the AIoT data sent by the AIoT device.

According to the data transmission apparatus provided in this embodiment of this application, the data transmission apparatus receives, over the 3GPP air interface or the first AIoT link, the AIoT data sent by the UE, and/or sends the AIoT data to the UE over the 3GPP air interface or the first AIoT link. According to the method, because the AIoT device and the network side device may be assisted by the UE to transmit AIoT signaling and service-related data, a coverage area of the AIoT device can be enlarged, and interference to an AIoT link system can be reduced, so that a 3GPP AIoT can provide large-scale cellular network deployment and seamless coverage to meet expected performance indicators such as power consumption, complexity, a coverage rate, a data rate, and positioning precision.

FIG. 15 is a schematic diagram of a data transmission apparatus according to an embodiment of this application. As shown in FIG. 15, the data transmission apparatus may be applied to an AIoT. The apparatus includes a transceiver module 701.

The transceiver module 701 is configured to perform at least one of the following in an ambient Internet of Things AIoT protocol stack architecture:
receiving, over a second AIoT link, AIoT data sent by user equipment UE;
sending the AIoT data to the user equipment UE over the second AIoT link;
sending the AIoT data to the network side device over a third AIoT link; or
receiving, over the third AIoT link, the AIoT data sent by the network side device.

The network side device includes a base station and a core network device, and the AIoT data includes AIoT signaling and service-related data.

Optionally, in this embodiment of this application, the AIoT protocol stack architecture includes a control plane protocol stack, or includes the control plane protocol stack and a user plane protocol stack.

The AIoT device includes a PHY protocol layer and a MAC protocol layer; an AIoT PHY protocol layer and an AIoT MAC protocol layer; or the AIoT PHY protocol layer, the AIoT MAC protocol layer, and an AIoT NAS protocol layer.

Optionally, in this embodiment of this application, a protocol stack of the AIoT device further includes at least one of an AIoT RLC protocol layer, an AIoT PDCP protocol layer, an AIoT RRC protocol layer, or an AIoT SDAP protocol layer.

Optionally, in this embodiment of this application, the transceiver module is configured to receive, over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the UE.

Optionally, in this embodiment of this application, the transceiver module is configured to send the AIoT data to the UE over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the transceiver module is configured to send the AIoT data to the network side device over the third AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the transceiver module is configured to receive, over the third AIoT link at the AIoT MAC protocol layer, the AIoT RLC protocol layer, the AIoT PDCP protocol layer, the AIoT RRC protocol layer, or the AIoT SDAP protocol layer, the AIoT data sent by the network side device.

According to the data transmission apparatus provided in this embodiment of this application, the data transmission apparatus receives, over the second AIoT link, the AIoT data sent by the UE, or sends the AIoT data to the UE over the second AIoT link. According to the method, because the AIoT device and the network side device may be assisted by the UE to transmit AIoT signaling and service-related data, a coverage area of the AIoT device can be enlarged, and interference to an AIoT link system can be reduced, so that a 3GPP AIoT can provide large-scale cellular network deployment and seamless coverage to meet expected performance indicators such as power consumption, complexity, a coverage rate, a data rate, and positioning precision.

The data transmission apparatus in the embodiments of this application may be an electronic device, for example, an electronic device with an operating system; or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not limited in this embodiment of this application.

The data transmission apparatus provided in this embodiment of this application can implement various processes implemented in the method embodiments of FIG. 1 to FIG. 12B, and achieve the same technical effects. To avoid repetition, details are not described herein again.

Optionally, as shown in FIG. 16, an embodiment of this application further provides a communication device 800, including a processor 801 and a memory 802. The memory 802 stores a program or instructions exectable on the processor 801. For example, when the communication device 800 is a terminal, and when the program or the instructions are executed by the processor 801, the steps in the foregoing embodiment of the data transmission method are implemented, and the same technical effects can be achieved. When the communication device 800 is a network side device, and when the program or the instructions are executed by the processor 801, the steps in the foregoing embodiment of the data transmission method are implemented, and the same technical effects can be achieved. To avoid repetition, details are not described herein again.

An embodiment of this application further provides a terminal, including a processor and a communication interface. The communication interface is configured to perform at least one of the following in an ambient Internet of Things AIoT protocol stack architecture: receiving, over a 3GPP air interface or a first AIoT link, AIoT data sent by a network side device; sending the AIoT data to the network side device over the 3GPP air interface or the first AIoT link; sending the AIoT data to an AIoT device over a second AIoT link; or receiving, by the UE over the second AIoT link, the AIoT data sent by the AIoT device. The network side device includes a base station and a core network device, and the AIoT data includes AIoT signaling and service-related data.

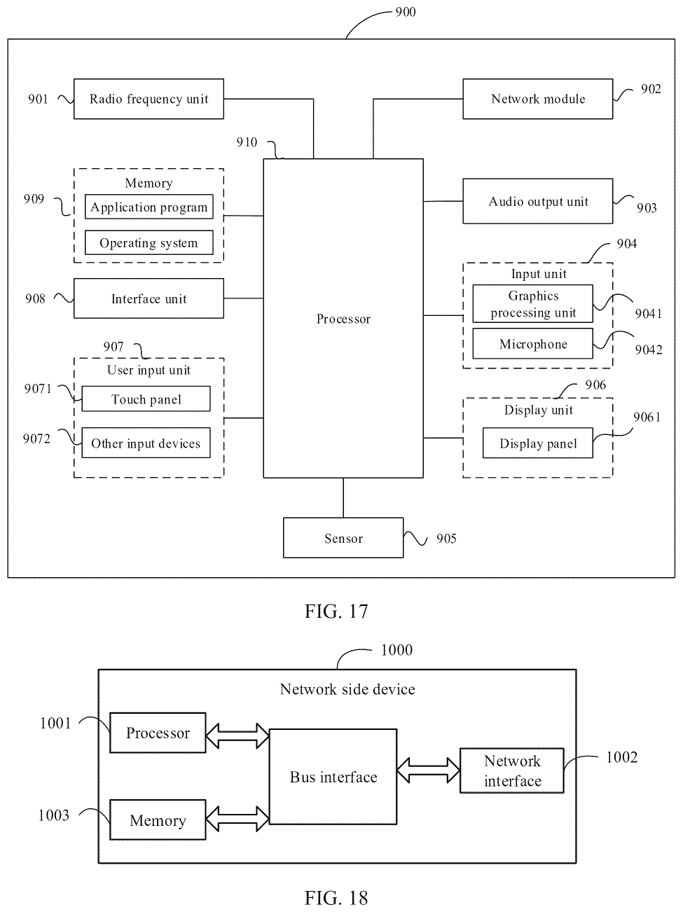

The terminal embodiment corresponds to the foregoing method embodiment on the terminal side. Each implementation process and implementation of the foregoing method embodiment may be applied to the terminal embodiment, and the same technical effects can be achieved. Optionally, FIG. 17 is a schematic diagram of a hardware structure of a terminal for implementing an embodiment of this application.

The terminal 900 includes but is not limited to at least some components of a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that, the terminal 900 may further include a power supply (for example, a battery) that supplies power to each component. The power supply may be logically connected to the processor 910 by using a power management system, to implement functions such as charging management, discharging management, and power consumption management by using the power management system. The structure of the terminal shown in FIG. 17 does not constitute a limitation on the terminal. The terminal may include more or fewer components than those shown in the figure, or combine some components, or have different component arrangements. Details are not described herein again.

It should be understood that, in this embodiment of this application, the input unit 904 may include a graphics processing unit (GPU) 9041 and a microphone 9042. The graphics processing unit 9041 processes image data of a still picture or a video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or an on/off key), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to a network side device. Generally, the radio frequency unit 901 includes but is not limited to an antenna, an amplifier, a transceiver, a coupler, a low-noise amplifier, a duplexer, and the like.

The memory 909 may be configured to store a software program or instructions and various types of data. The memory 909 may mainly include a first storage area for storing a program or instructions and a second storage area for storing data. The first storage area may store an operating system, an application program or instructions required by at least one function (for example, a sound play function or an image play function), and the like. In addition, the memory 909 may include a volatile memory or a non-volatile memory, or the memory 909 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any other suitable type of memory.

The processor 910 may include one or more processing units. Optionally, the processor 910 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 910.

The radio frequency unit 901 is configured to perform at least one of the following in an ambient Internet of Things AIoT protocol stack architecture:
receiving, over a 3GPP air interface or a first AIoT link, AIoT data sent by a network side device;
sending the AIoT data to the network side device over the 3GPP air interface or the first AIoT link;
sending the AIoT data to an AIoT device over a second AIoT link; or
receiving, over the second AIoT link, the AIoT data sent by the AIoT device.

The network side device includes a base station and a core network device, and the AIoT data includes AIoT signaling and service-related data.

Optionally, in this embodiment of this application, the AIoT protocol stack architecture includes a control plane protocol stack, or includes the control plane protocol stack and a user plane protocol stack.

The UE includes a PHY protocol layer and a MAC protocol layer; the PHY protocol layer, the MAC protocol layer, and a NAS protocol layer; an AIoT PHY protocol layer and an AIoT MAC protocol layer; the AIoT PHY protocol layer, the AIoT MAC protocol layer, and an AIoT NAS protocol layer; or the PHY protocol layer, the MAC protocol layer, the NAS protocol layer, the AIoT PHY protocol layer, the AIoT MAC protocol layer, and the AIoT NAS protocol layer.

Optionally, in this embodiment of this application, a protocol stack of the UE further includes at least one of an RLC protocol layer, a PDCP protocol layer, an RRC protocol layer, or an SDAP protocol layer; or at least one of an AIoT RLC protocol layer, an AIoT PDCP protocol layer, an AIoT RRC protocol layer, or an AIoT SDAP protocol layer.

Optionally, in this embodiment of this application, the radio frequency unit is configured to send the AIoT data to the base station over the 3GPP air interface at the MAC protocol layer, the RLC protocol layer, the PDCP protocol layer, the RRC protocol layer, or the SDAP protocol layer.

The radio frequency unit is configured to receive, over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

Optionally, in this embodiment of this application, the radio frequency unit is configured to receive over the 3GPP air interface at the MAC protocol layer, the RLC protocol layer, the PDCP protocol layer, the RRC protocol layer, or the SDAP protocol layer, the AIoT data sent by the base station.

The radio frequency unit is configured to send the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the radio frequency unit is configured to send the AIoT data to the base station over the first AIoT link at the AIoT RRC protocol layer, the AIoT SDAP protocol layer, the AIoT RLC protocol layer, the AIoT PDCP protocol layer, or the AIoT MAC protocol layer.

The radio frequency unit is configured to transmit the AIoT data with the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the radio frequency unit is configured to receive, over the first AIoT link at the AIoT RRC protocol layer, the AIoT SDAP protocol layer, the AIoT RLC protocol layer, the AIoT PDCP protocol layer, or the AIoT MAC protocol layer, the AIoT data sent by the base station.

The radio frequency unit is configured to send the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer.

Optionally, in this embodiment of this application, the radio frequency unit is configured to send the AIoT data to the core network device over the 3GPP air interface at the NAS protocol layer.

The radio frequency unit is configured to receive, over the second AIoT NAS link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

Optionally, in this embodiment of this application, the radio frequency unit is configured to send the AIoT data to the network side device over the first AIoT link at the AIoT NAS layer.

The radio frequency unit is configured to receive, over the second AIoT link at the AIoT MAC protocol layer, the AIoT RLC protocol layer, the AIoT PDCP protocol layer, the AIoT SDAP protocol layer, or the AIoT RRC protocol layer, the AIoT data sent by the AIoT device.

Optionally, in this embodiment of this application, the AIoT PHY is configured to perform a first function.

The AIoT MAC is configured to perform at least one of a second function, a third function, a fourth function, a fifth function, a sixth function, or a seventh function.

The AIoT RLC is configured to perform the third function.

The AIoT PDCP is configured to perform the fourth function.

The AIoT RRC is configured to perform at least one of the fifth function or the sixth function.

The AIoT SDAP is configured to perform the seventh function.

The AIoT NAS is configured to perform the sixth function.

The first function includes at least one of the following: determining a time domain resource or a frequency domain resource for AIoT communication, performing uplink AIoT transmission, or performing downlink AIoT transmission.

The second function includes at least one of the following: transmitting AIoT service data, managing an AIoT status, or mapping an AIoT transmission channel.

The third function includes at least one of the following: transmitting higher-layer AIoT service data, assigning a sequence number to a data packet, or defining an AIoT transmission mode.

The fourth function includes at least one of the following: transmitting AIoT control plane data, transmitting AIoT user plane data, or maintaining a sequence number of an AIoT service data packet.

The fifth function includes at least one of the following: transmitting higher-layer AIoT service data, managing an AIoT status, or broadcasting an AIoT system message.

The sixth function includes at least one of the following: transmitting higher-layer AIoT service data, performing AIoT registration and registration update, managing a location, or managing an AIoT status.

The seventh function includes at least one of the following: performing mapping between an AIoT QoS flow and an AIoT data radio bearer, or assigning QoS flow identifiers to uplink and downlink AIoT data packets.

According to the terminal provided in this embodiment of this application, the terminal performs at least one of the following in the ambient Internet of Things AIoT protocol stack architecture: receiving, over the 3GPP air interface or the first AIoT link, the AIoT data sent by the network side device; sending the AIoT data to the network side device over the 3GPP air interface or the first AIoT link; sending the AIoT data to the AIoT device over the second AIoT link; or receiving, over the second AIoT link, the AIoT data sent by the AIoT device. According to the method, the terminal may assist in transmission of AIoT signaling and service-related data to implement a necessary AIoT data transmission function, thereby enlarge a coverage area of the AIoT architecture, and supporting large-scale cellular network deployment, a large quantity of AIoT devices, and seamless coverage.

An embodiment of this application further provides a network side device, including a processor and a communication interface. The communication interface is configured to perform at least one of the following in an ambient Internet of Things AIoT protocol stack architecture: receiving, over a 3GPP air interface or a first AIoT link, AIoT data sent by UE; sending the AIoT data to the UE over the 3GPP air interface or the first AIoT link; sending the AIoT data to the AIoT device over a third AIoT link; or receiving, over the third AIoT link, the AIoT data sent by the AIoT device. The AIoT data includes AIoT signaling and service-related data. The network side device embodiment corresponds to the foregoing method embodiment for the network side device. Each implementation process and implementation of the foregoing method embodiment may be applied to the network side device embodiment, and the same technical effects can be achieved.

Optionally, an embodiment of this application further provides a network side device. As shown in FIG. 18, the network side device 1000 includes a processor 1001, a network interface 1002, and a memory 1003. The network interface 1002 is, for example, a common public radio interface (CPRI).

Optionally, the network side device 1000 in this embodiment of the present application further includes instructions or a program that is stored in the memory 1003 and that is exectable on the processor 1001. The processor 1001 invokes the instructions or the program in the memory 1003 to perform the method performed by the modules shown in FIG. 13, and the same technical effects are achieved. To avoid repetition, details are not described herein again.

An embodiment of this application further provides an AIoT device, including a processor and a communication interface. The communication interface is configured to perform at least one of the following in an ambient Internet of Things AIoT protocol stack architecture: receiving, over a second AIoT link, AIoT data sent by user equipment UE; sending the AIoT data to the user equipment UE over the second AIoT link; sending the AIoT data to the network side device over a third AIoT link; or receiving, over the third AIoT link, the AIoT data sent by the network side device. The network side device includes a base station and a core network device, and the AIoT data includes AIoT signaling and service-related data. Each implementation process and implementation of the foregoing method embodiment may be applicable to the embodiment for the AIoT device side, and the same technical effects can be achieved.

An embodiment of this application further provides a non-transitory readable storage medium. The non-transitory readable storage medium stores a program or instructions. When the program or the instructions are executed by a processor, processes in the foregoing embodiments of the data transmission method are implemented, and the same technical effects can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement processes in the foregoing embodiments of the data transmission method, and the same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a non-transitory storage medium. When the computer program/program product is executed by at least one processor, processes in the foregoing embodiments of the data transmission method are implemented, and the same technical effects can be achieved. To avoid repetition, details are not described herein again.

An embodiment of this application further provides a communication system, including a terminal, a network side device, and an AIoT device. The terminal may be configured to perform the steps of the foregoing data transmission method on the terminal side. The network side device may be configured to perform the steps of the foregoing data transmission method on the network side device side. The AIoT device may be configured to perform the steps of the foregoing data transmission method on the AIoT device side.

Optionally, in the communication system, the base station includes a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer.

The UE includes a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer.

The AIoT device includes an AIoT PHY protocol layer and an AIoT MAC protocol layer.

Optionally, the base station further includes at least one of an RLC protocol layer, a PDCP protocol layer, an RRC protocol layer, or an SDAP protocol layer; or at least one of an AIoT RLC protocol layer, an AIoT PDCP protocol layer, or and AIoT RRC protocol layer.

The UE further includes at least one of an RLC protocol layer, a PDCP protocol layer, or an RRC protocol layer; or at least one of an AIoT RLC protocol layer, an AIoT PDCP protocol layer, an AIoT RRC protocol layer, or an AIoT SDAP protocol layer.

The AIoT device further includes at least one of an AIoT RLC protocol layer, an AIoT PDCP protocol layer, an AIoT RRC protocol layer, or an AIoT SDAP protocol layer.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by software and a necessary general-purpose hardware platform, or certainly may be implemented by hardware. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A data transmission method, comprising:
performing, by user equipment (UE), at least one of the following in an ambient Internet of Things (AIoT) protocol stack architecture:
receiving, by the UE over a 3GPP air interface or a first AIoT link, AIoT data sent by a network side device;
sending, by the UE, the AIoT data to the network side device over the 3GPP air interface or the first AIoT link;
sending, by the UE, the AIoT data to an AIoT device over a second AIoT link; or
receiving, by the UE over the second AIoT link, the AIoT data sent by the AIoT device, wherein
the network side device comprises a base station and a core network device, and the AIoT data comprises AIoT signaling and service-related data.

2. The method according to claim 1, wherein the AIoT protocol stack architecture comprises a control plane protocol stack, or comprises the control plane protocol stack and a user plane protocol stack; and
the UE comprises a PHY protocol layer and a MAC protocol layer; the PHY protocol layer, the MAC protocol layer, and a NAS protocol layer; an AIoT PHY protocol layer and an AIoT MAC protocol layer; the AIoT PHY protocol layer, the AIoT MAC protocol layer, and an AIoT NAS protocol layer; or the PHY protocol layer, the MAC protocol layer, the NAS protocol layer, the AIoT PHY protocol layer, the AIoT MAC protocol layer, and the AIoT NAS protocol layer.

3. The method according to claim 2, wherein a protocol stack of the UE further comprises at least one of an RLC protocol layer, a PDCP protocol layer, an RRC protocol layer, or an SDAP protocol layer; or at least one of an AIoT RLC protocol layer, an AIoT PDCP protocol layer, an AIoT RRC protocol layer, or an AIoT SDAP protocol layer.

4. The method according to claim 3, wherein the sending, by the UE, the AIoT data to the network side device over the 3GPP air interface comprises:
sending, by the UE, the AIoT data to the base station over the 3GPP air interface at the MAC protocol layer, the RLC protocol layer, the PDCP protocol layer, the RRC protocol layer, or the SDAP protocol layer; and
the receiving, by the UE over the second AIoT link, the AIoT data sent by the AIoT device comprises:
receiving, by the UE over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device.

5. The method according to claim 2, wherein the receiving, by the UE over a 3GPP air interface, AIoT data sent by the network side device comprises:
receiving, by the UE over the 3GPP air interface at the MAC protocol layer, the RLC protocol layer, the PDCP protocol layer, the RRC protocol layer, or the SDAP protocol layer, the AIoT data sent by the base station; and
the sending, by the UE, the AIoT data to an AIoT device over a second AIoT link comprises:
sending, by the UE, the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer;
or,
the sending, by the UE, the AIoT data to the network side device over the first AIoT link comprises:
sending, by the UE, the AIoT data to the base station over the first AIoT link at the AIoT RRC protocol layer, the AIoT SDAP protocol layer, the AIoT RLC protocol layer, the AIoT PDCP protocol layer, or the AIoT MAC protocol layer; and
the receiving, by the UE over the second AIoT link, the AIoT data sent by the AIoT device comprises:
transmitting, by the UE, the AIoT data with the AIoT device over the second AIoT link at the AIoT MAC protocol layer, the AIoT RLC protocol layer, the AIoT PDCP protocol layer, the AIoT RRC protocol layer, or the AIoT SDAP protocol layer.

6. The method according to claim 2, wherein the receiving, by the UE over a first AIoT link, AIoT data sent by a network side device comprises:
receiving, by the UE over the first AIoT link at the AIoT RRC protocol layer, the AIoT SDAP protocol layer, the AIoT RLC protocol layer, the AIoT PDCP protocol layer, or the AIoT MAC protocol layer, the AIoT data sent by the base station; and
the sending, by the UE, the AIoT data to the AIoT device over a second AIoT link comprises:
sending, by the UE, the AIoT data to the AIoT device over the second AIoT link at the AIoT MAC protocol layer, the AIoT RLC protocol layer, the AIoT PDCP protocol layer, the AIoT RRC protocol layer, or the AIoT SDAP protocol layer;
or,
the sending, by the UE, the AIoT data to the network side device over the 3GPP air interface comprises:
sending, by the UE, the AIoT data to the core network device over the 3GPP air interface at the NAS protocol layer; and
the receiving, by the UE over the second AIoT link, the AIoT data sent by the AIoT device comprises:
receiving, by the UE over the second AIoT NAS link at the AIoT MAC protocol layer, the AIoT RLC protocol layer, the AIoT PDCP protocol layer, the AIoT RRC protocol layer, or the AIoT SDAP protocol layer, the AIoT data sent by the AIoT device;
or,
the sending the AIoT data to the network side device over the first AIoT link comprises:
sending, by the UE, the AIoT data to the network side device over the first AIoT link at the AIoT NAS layer; and
the receiving, by the UE over the second AIoT link, the AIoT data sent by the AIoT device comprises:
receiving, by the UE over the second AIoT link at the AIoT MAC protocol layer, the AIoT RLC protocol layer, the AIoT PDCP protocol layer, the AIoT SDAP protocol layer, or the AIoT RRC protocol layer, the AIoT data sent by the AIoT device.

7. The method according to claim 2, wherein the AIoT PHY is configured to perform a first function;
the AIoT MAC is configured to perform at least one of a second function, a third function, a fourth function, a fifth function, a sixth function, or a seventh function;
the AIoT RLC is configured to perform the third function;
the AIoT PDCP is configured to perform the fourth function;
the AIoT RRC is configured to perform at least one of the fifth function or the sixth function;
the AIoT SDAP is configured to perform the seventh function;
the AIoT NAS is configured to perform the sixth function;
the first function comprises at least one of the following: determining a time domain resource or a frequency domain resource for AIoT communication, performing uplink AIoT transmission, or performing downlink AIoT transmission;
the second function comprises at least one of the following: transmitting AIoT service data, managing an AIoT status, or mapping an AIoT transmission channel;
the third function comprises at least one of the following: transmitting higher-layer AIoT service data, assigning a sequence number to a data packet, or defining an AIoT transmission mode;
the fourth function comprises at least one of the following: transmitting AIoT control plane data, transmitting AIoT user plane data, or maintaining a sequence number of an AIoT service data packet;
the fifth function comprises at least one of the following: transmitting higher-layer AIoT service data, managing an AIoT status, or broadcasting an AIoT system message;
the sixth function comprises at least one of the following: transmitting higher-layer AIoT service data, performing AIoT registration and registration update, managing a location, or managing an AIoT status; and
the seventh function comprises at least one of the following: performing mapping between an AIoT QoS flow and an AIoT data radio bearer, or assigning QoS flow identifiers to uplink and downlink AIoT data packets.

8. A data transmission method, comprising:
performing, by a network side device, at least one of the following in an ambient Internet of Things (AIoT) protocol stack architecture:
receiving, by the network side device over a 3GPP air interface or a first AIoT link, AIoT data sent by user equipment (UE);
sending, by the network side device, the AIoT data to the UE over the 3GPP air interface or the first AIoT link;
sending, by the network side device, the AIoT data to an AIoT device over a third AIoT link; or
receiving, by the network side device over the third AIoT link, the AIoT data sent by the AIoT device, wherein
the network side device comprises a base station and a core network device, and the AIoT data comprises AIoT signaling and service-related data.

9. The method according to claim 8, wherein the AIoT protocol stack architecture comprises a control plane protocol stack, or comprises the control plane protocol stack and a user plane protocol stack; and
the base station comprises a PHY protocol layer and a MAC protocol layer; an AIoT PHY protocol layer and an AIoT MAC protocol layer; or the PHY protocol layer, the MAC protocol layer, the AIoT PHY protocol layer, and the AIoT MAC protocol layer; and
the core network device comprises a NAS protocol layer; an AIoT NAS protocol layer; or the NAS protocol layer and the AIoT NAS protocol layer;
or,
wherein the base station further comprises at least one of an RLC protocol layer, a PDCP protocol layer, an SDAP protocol layer, or an RRC protocol layer; or at least one of an AIoT RLC protocol layer, an AIoT PDCP protocol layer, an AIoT SDAP protocol layer, or an AIoT RRC protocol layer.

10. The method according to claim 9, wherein the sending, by the network side device, the AIoT data to the UE over the 3GPP air interface comprises:
sending, by the network side device, the AIoT data to the UE over the 3GPP air interface at the MAC protocol layer, the RLC protocol layer, the PDCP protocol layer, the RRC protocol layer, or the SDAP protocol layer;
or,
the sending, by the network side device, the AIoT data to the UE over the first AIoT link comprises:
sending, by the network side device, the AIoT data to the UE over the first AIoT link at the AIoT RRC protocol layer, the AIoT SDAP protocol layer, the AIoT MAC protocol layer, the AIoT RLC protocol layer, or the AIoT PDCP protocol layer.

11. The method according to claim 9, wherein the receiving, by the network side device over a 3GPP air interface, AIoT data sent by the UE comprises:
receiving, by the network side device over the 3GPP air interface at the MAC protocol layer, the RLC protocol layer, the PDCP protocol layer, the RRC protocol layer, or the SDAP protocol layer, the AIoT data sent by the UE;
or,
the receiving, by the network side device over a first AIoT link, AIoT data sent by the UE comprises:
receiving, by the network side device over the first AIoT link at the AIoT RRC protocol layer, the AIoT SDAP protocol layer, the AIoT MAC protocol layer, the AIoT RLC protocol layer, or the AIoT PDCP protocol layer, the AIoT data sent by the UE.

12. The method according to claim 9, wherein the sending, by the network side device, the AIoT data to the UE over the 3GPP air interface comprises:
sending, by the core network device, the AIoT data to the UE over the 3GPP air interface at the NAS protocol layer;
or,
the sending, by the network side device, the AIoT data to the UE over the first AIoT link comprises:
sending, by the core network device, the AIoT data to the UE over the first AIoT link at the AIoT NAS layer;
or,
the receiving, by the network side device over a 3GPP air interface, AIoT data sent by UE comprises:
receiving, by the base station over the 3GPP air interface at the MAC protocol layer, the RRC protocol layer, the RLC protocol layer, the PDCP protocol layer, or the SDAP protocol layer, the AIoT data sent by the UE; and
sending, by the base station, the AIoT data to the core network device.

13. The method according to claim 9, wherein the sending, by the network side device, the AIoT data to an AIoT device over a third AIoT link comprises:
sending, by the base station, the AIoT data to the AIoT device over the third AIoT link at the AIoT MAC protocol layer, the AIoT RRC protocol layer, the AIoT RLC protocol layer, the AIoT PDCP protocol layer, or the AIoT SDAP protocol layer;
or,
the receiving, by the network side device over the third AIoT link, the AIoT data sent by the AIoT device comprises:
receiving, by the base station over the third AIoT link at the AIoT MAC protocol layer, the AIoT RRC protocol layer, the AIoT RLC protocol layer, the AIoT PDCP protocol layer, or the AIoT SDAP protocol layer, the AIoT data sent by the AIoT device.

14. A data transmission method, wherein the method comprises:
performing, by an ambient Internet of Things (AIoT) device, at least one of the following in an AIoT protocol stack architecture:
receiving, by the AIoT device over a second AIoT link, AIoT data sent by user equipment (UE);
sending, by the AIoT device, the AIoT data to the user equipment UE over the second AIoT link;
sending, by the AIoT device, the AIoT data to a network side device over a third AIoT link; or
receiving, by the AIoT device over the third AIoT link, the AIoT data sent by the network side device, wherein
the network side device comprises a base station and a core network device, and the AIoT data comprises AIoT signaling and service-related data.

15. The method according to claim 14, wherein the AIoT protocol stack architecture comprises a control plane protocol stack, or comprises the control plane protocol stack and a user plane protocol stack; and
the AIoT device comprises a PHY protocol layer and a MAC protocol layer; an AIoT PHY protocol layer and an AIoT MAC protocol layer; or the AIoT PHY protocol layer, the AIoT MAC protocol layer, and an AIoT NAS protocol layer;
wherein the AIoT device further comprises at least one of an AIoT RLC protocol layer, an AIoT PDCP protocol layer, an AIoT RRC protocol layer, or an AIoT SDAP protocol layer.

16. The method according to claim 15, wherein the receiving, by the AIoT device over a second AIoT link, AIoT data sent by the UE comprises:
receiving, by the AIoT device over the second AIoT link at the AIoT MAC protocol layer, the AIoT RLC protocol layer, the AIoT PDCP protocol layer, the AIoT RRC protocol layer, or the AIoT SDAP protocol layer, the AIoT data sent by the UE;
or,
the sending, by the AIoT device, the AIoT data to the UE over the second AIoT link comprises:
sending, by the AIoT device, the AIoT data to the UE over the second AIoT link at the AIoT MAC protocol layer, the AIoT RLC protocol layer, the AIoT PDCP protocol layer, the AIoT RRC protocol layer, or the AIoT SDAP protocol layer.

17. The method according to claim 15, wherein the sending, by the AIoT device, the AIoT data to a network side device over a third AIoT link comprises:
sending, by the AIoT device, the AIoT data to the network side device over the third AIoT link at the AIoT MAC protocol layer, the AIoT RLC protocol layer, the AIoT PDCP protocol layer, the AIoT RRC protocol layer, or the AIoT SDAP protocol layer;
or,
the receiving, by the AIoT device over the third AIoT link, the AIoT data sent by the network side device comprises:
receiving, by the AIoT device over the third AIoT link at the AIoT MAC protocol layer, the AIoT RLC protocol layer, the AIoT PDCP protocol layer, the AIoT RRC protocol layer, or the AIoT SDAP protocol layer, the AIoT data sent by the network side device.

18. A terminal, comprising a processor and a memory, wherein the memory stores a program or instructions exectable on the processor, and when the program or the instructions are executed by the processor, the steps of the data transmission method according to claim 1 are implemented.

19. A network side device, comprising a processor and a memory, wherein the memory stores a program or instructions exectable on the processor, and when the program or the instructions are executed by the processor, the steps of the data transmission method according to claim 8 are implemented.

20. An ambient Internet of Things (AIoT) device, comprising a processor and a memory, wherein the memory stores a program or instructions exectable on the processor, and when the program or the instructions are executed by the processor, the steps of the data transmission method according to claim 14 are implemented.
